(19) United States
(12) Patent Application Publication
(10) Pub. No.: US 2025/0377855 A1
(43) Pub. Date: Dec. 11, 2025

(54) Devices, Methods, and Graphical User Interfaces for Adjusting Active Noise Management

(71) Applicant: Apple Inc., Cupertino, CA (US)

(72) Inventors: Taylor G. Carrigan, San Francisco, CA (US); Charles C. Hoyt, Pacifica, CA (US); Mitchell R. Lerner, San Francisco, CA (US); Hugo D. Verweij, Portola Valley, CA (US)

(21) Appl. No.: 19/095,372

(22) Filed: Mar. 31, 2025

Related U.S. Application Data
(60) Provisional application No. 63/657,907, filed on Jun. 9, 2024.

(51) Int. Cl. G06F 3/16; H04R 1/10

(52) U.S. Cl. CPC G06F 3/165; H04R 1/1083; H04R 2430/01; H04R 2460/01

(57) ABSTRACT

A computer system includes one or more input devices and one or more audio output components. An input is detected via the input device(s). In response to detecting the input and in accordance with a determination that the input is a first type of input and audio content of a respective type of audio content is being output by the audio output component(s), an output volume of the audio content is adjusted. In response to detecting the input and in accordance with a determination that the input is the first type of input and that one or more noise management criteria are met, one or more parameters of an active noise management function are adjusted, where the one or more noise management criteria include a criterion that is met when the respective type of audio content is not being output by the one or more audio output components.

### RELATED APPLICATIONS

This application claims priority to U.S. Provisional Patent Application No. 63/657,907, filed Jun. 9, 2024, which is incorporated by reference in its entirety.

### TECHNICAL FIELD

This relates generally to audio output devices and active noise management including but not limited to input sensors and controls for adjusting active noise management functions and audio routing.

### BACKGROUND

Electronic accessories, including wearable audio output devices such as headphones, earbuds, and earphones, as well as charging cases, watches, and styluses are widely used to receive inputs from and provide outputs to a user. But conventional methods of controlling and interacting with such devices are cumbersome, inefficient, and limited.

In some cases, limited control over audio outputs is given to inputs provided at the wearable audio output devices; for example, an input may be limited to having control over a single predefined feature of audio output, such as toggling power or a feature on or off. In some cases, limited control over audio outputs interferes with a user's ability to control the volume of audio content being played back by the wearable audio output devices and/or control the amount of sound that the user is able to hear from the surrounding physical environment while wearing the wearable audio output devices.

In some cases, user interfaces for controlling audio output settings provide too few controls, for example by providing audio playback controls without environmental noise management controls, thus requiring a user to provide numerous inputs and navigate through different menus or user interfaces to perform a particular operation. In addition, conventional methods take longer and require more user interaction than necessary to operate the electronic accessories, thereby wasting energy. This latter consideration is particularly important in battery-operated devices.

In some cases, the wearable audio output devices and companion devices do not automatically route audio in response to audio events, e.g., requiring the user to manually adjust incoming audio (e.g., from remote devices) and/or outgoing audio (e.g., from microphone(s) of the wearable audio output devices).

In addition, conventional methods take longer and require more user interaction than necessary to adjust audio input/outputs and/or connectivity of the audio output devices, thereby wasting energy and providing an inefficient human-machine interface. Conserving device energy is particularly important in battery-operated devices.

### SUMMARY

Accordingly, there is a need for audio output devices (e.g., wearable audio output devices) and associated electronic devices with improved methods and interfaces for controlling and interacting with, such as adjusting volume and environmental noise management, establishing and switching between audio routes, and providing feedback to aid a user in operating such devices. Such methods and interfaces optionally complement or replace conventional methods for controlling operation of audio output devices. Such methods and interfaces reduce the number, extent, and/or nature of the inputs from a user and produce a more efficient human-machine interface. For battery-operated systems and devices, such methods and interfaces conserve power and increase the time between battery charges.

The above deficiencies and other problems associated with user interfaces for electronic devices and accessories are reduced or eliminated by the disclosed computer systems and electronic accessories. In some embodiments, the computer system includes a desktop computer. In some embodiments, the computer system is portable (e.g., a notebook computer, tablet computer, or handheld device). In some embodiments, the computer system includes a personal electronic device (e.g., a wearable electronic device, such as a watch). In some embodiments, the computer system includes (and/or is in communication with) the wearable audio output devices (e.g., in-ear earphones, earbuds, over-ear headphones, etc.). In some embodiments, the computer system has (and/or is in communication with) a touch-sensitive surface (also known as a “touchpad”). In some embodiments, the computer system has (and/or is in communication with) a display device, which in some embodiments is a touch-sensitive display (also known as a “touch screen” or “touch-screen display”). In some embodiments, the computer system has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, audio output device pairing and calibration, digital music/audio playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system with one or more input devices and one or more output generation components and that is in communication with one or more wearable audio output devices. The method includes, while an ambient noise adjustment mode is in a first state, causing display, via the one or more output generation components, of a first user interface that includes concurrently displaying: a first control element indicating a volume of audio playback at the one or more wearable audio output devices and selectable to adjust the volume of the audio playback, and a second control element indicating a magnitude of an active noise management function. The method further includes detecting, via the one or more input devices, a first input for adjusting the ambient noise adjustment mode; and, in response to detecting the first input, setting the ambient noise adjustment mode to a second state and continuing to display the first user interface, including continuing to concurrently display the first control element and the second control element.

In accordance with some embodiments, a method is performed at a computer system with one or more input devices and one or more audio output components. The method includes detecting a first input via the one or more input devices. In response to detecting the first input and in accordance with a determination that the first input is a first type of input and audio content of a respective type of audio content is being output by the one or more audio output components, adjusting an output volume of the audio content being output via the one or more audio output components. In response to detecting the first input and in accordance with a determination that the first input is the first type of input and that one or more noise management criteria are met, adjusting one or more parameters of an active noise management function, where the one or more noise management criteria include a criterion that is met when the respective type of audio content is not being output by the one or more audio output components.

In accordance with some embodiments, a method is performed at a first computer system that includes, or is communicatively coupled with, one or more audio output devices, one or more output generation components, and one or more microphones. The method includes, while a first communication session is active between the first computer system and one or more other devices participating in the first communication session, causing first audio data provided by the one or more other devices participating in the first communication session to be output by the one or more other audio output devices, causing second audio data recorded by the one or more microphones to be made available to the one or more other devices participating in the first communication session, and causing visual data corresponding to the first communication session to be displayed via the one or more output generation components. The method further includes, while the first communication session is active between the first computer system, detecting an occurrence of an event corresponding to a request to establish a second communication session between the one or more audio output devices and a second computer system, different than the first computer system. The method also includes, in response to detecting the occurrence of the event, maintaining the first communication session, including: causing the visual data corresponding to the first communication session to continue to be displayed via the one or more output generation components, ceasing to cause the first audio data provided by the one or more other devices participating in the first communication session to be output by the one or more audio output devices, and ceasing to cause the second audio data recorded by the one or more microphones to be made available to the one or more other devices participating in the first communication session. The first computer system forgoes causing the first audio data provided by the one or more other devices participating in the first communication session to be output by the one or more audio output devices and forgoes causing the second audio data recorded by the one or more microphones to be made available to other devices participating in the first communication session while third audio data corresponding to the second communication session is being transferred between the second computer system and the one or more audio output devices.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for controlling operation of audio output devices, thereby increasing the effectiveness, efficiency, and user satisfaction with such devices. Such methods and interfaces optionally complement or replace conventional methods for controlling operation of audio output devices.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 3H illustrates physical features of an example wearable audio output device in accordance with some embodiments.

FIG. 3I is a block diagram of an example wearable audio output device in accordance with some embodiments.

FIG. 3J illustrates example audio control by a wearable audio output device in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5AB illustrate example user interfaces for controlling volume and noise levels in accordance with some embodiments.

FIGS. 6A-6Y illustrate example user interactions and user interfaces for controlling volume and noise management functions in accordance with some embodiments.

FIGS. 7A-7L illustrate example user interactions and user interfaces for controlling audio routing in accordance with some embodiments.

FIGS. 8A-8D are flow diagrams of an example process for controlling active noise management in accordance with some embodiments.

FIGS. 9A-9I are flow diagrams of an example process for adjusting volume and/or active noise management in accordance with some embodiments.

FIGS. 10A-10F are flow diagrams of an example process for adjusting output of audio data in accordance with some embodiments.

### DESCRIPTION OF EMBODIMENTS

As noted above, audio output devices, including wearable audio output devices such as headphones, earbuds, and earphones, are widely used to provide audio outputs to a user. Many computer systems that include or are in communication with audio output devices give a user only limited control over noise management, audio outputs, and audio routing, or provide user interfaces with too few or too many output controls. The methods, systems, and user interfaces/interactions described herein improve how audio is managed by the audio output devices in multiple ways. For example, embodiments disclosed herein describe improved ways to control audio outputs and noise management using inputs at the audio output devices and/or user interfaces provided at an associated electronic device. As another example, embodiments disclosed herein describe improved ways to route and output audio between audio output devices and remote systems and devices.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

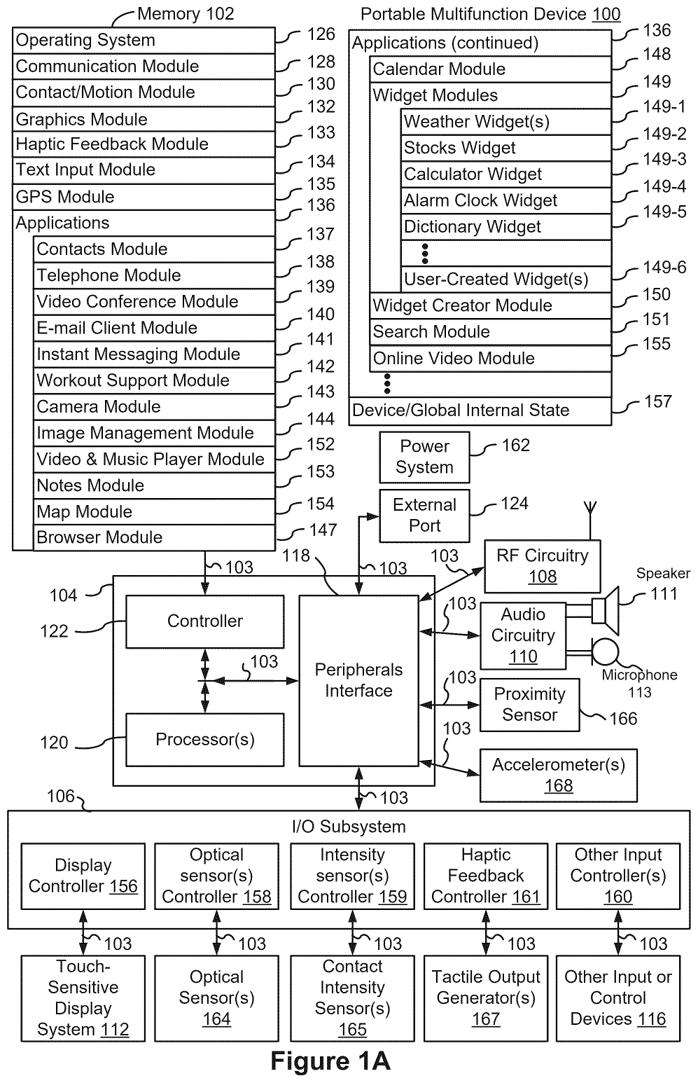

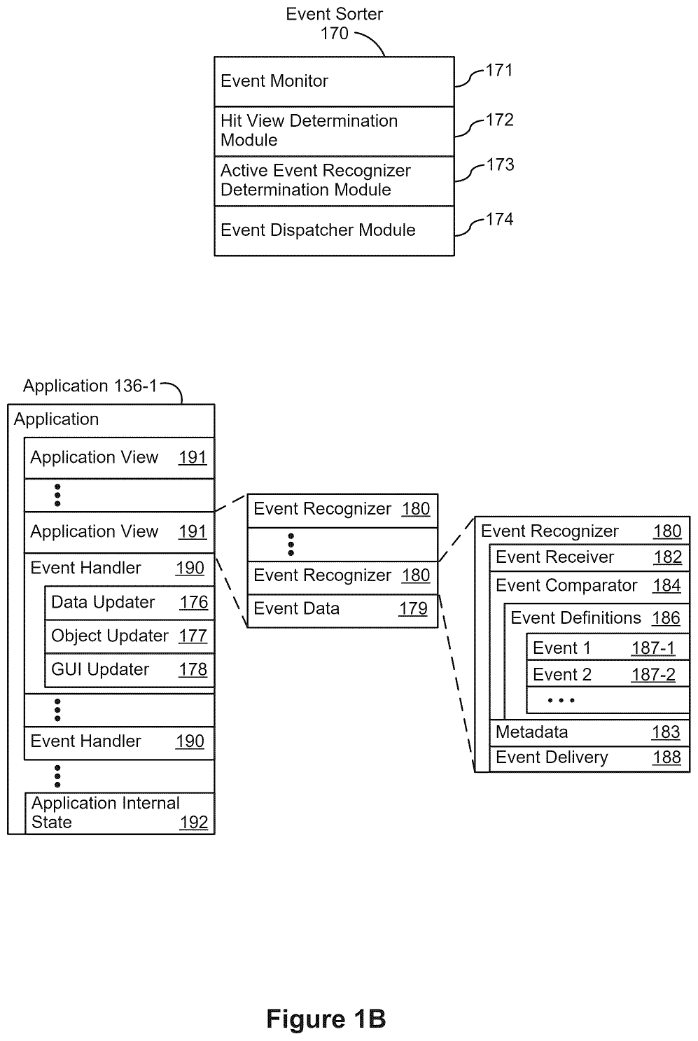

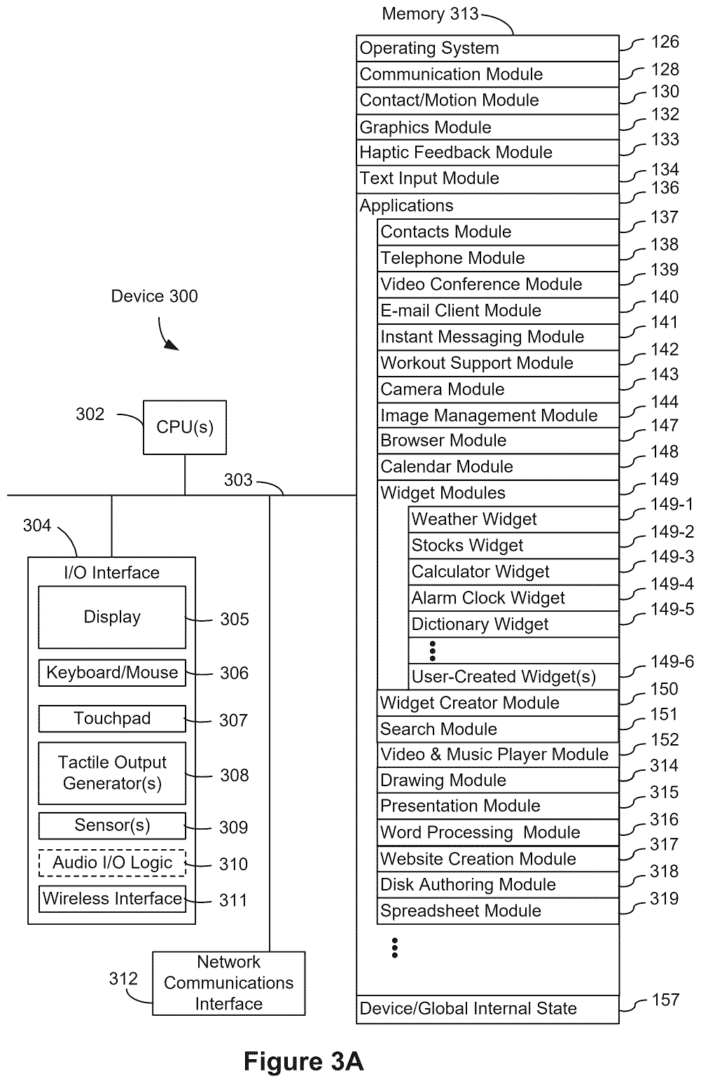

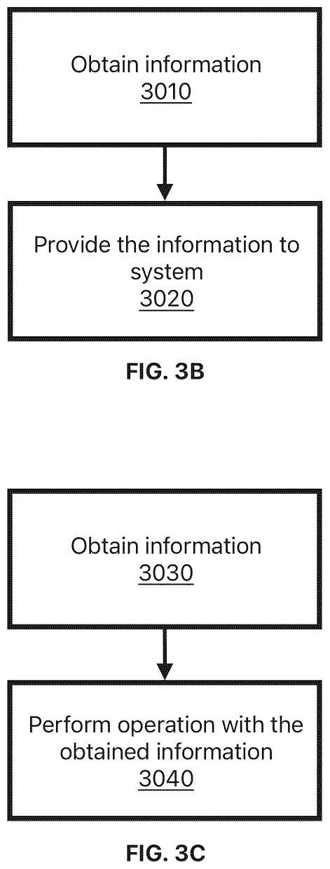

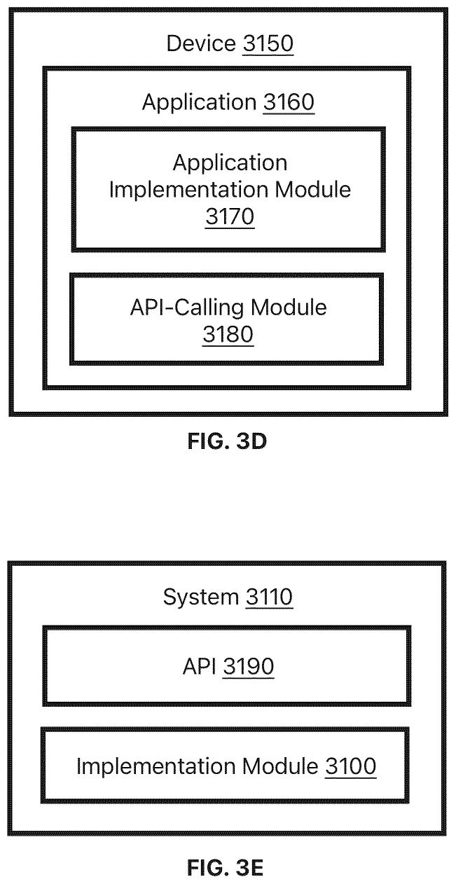

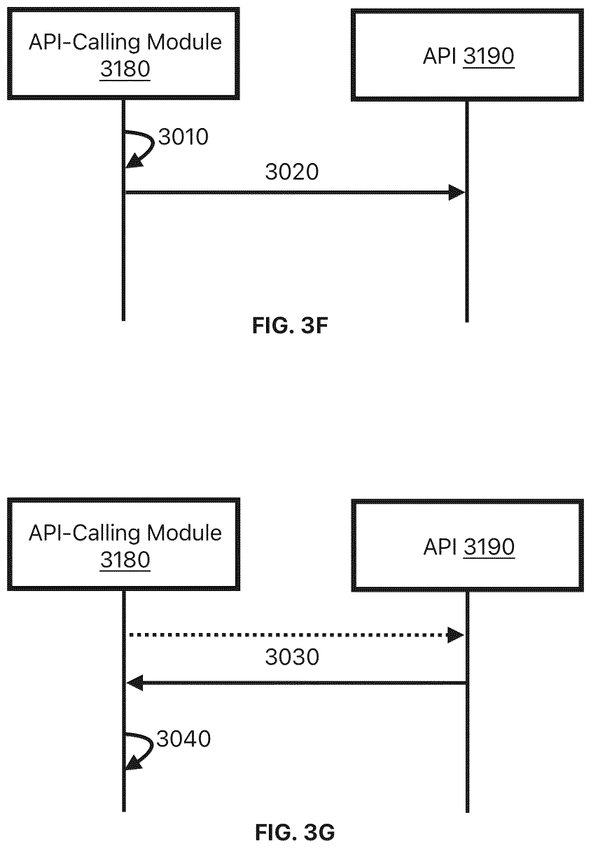

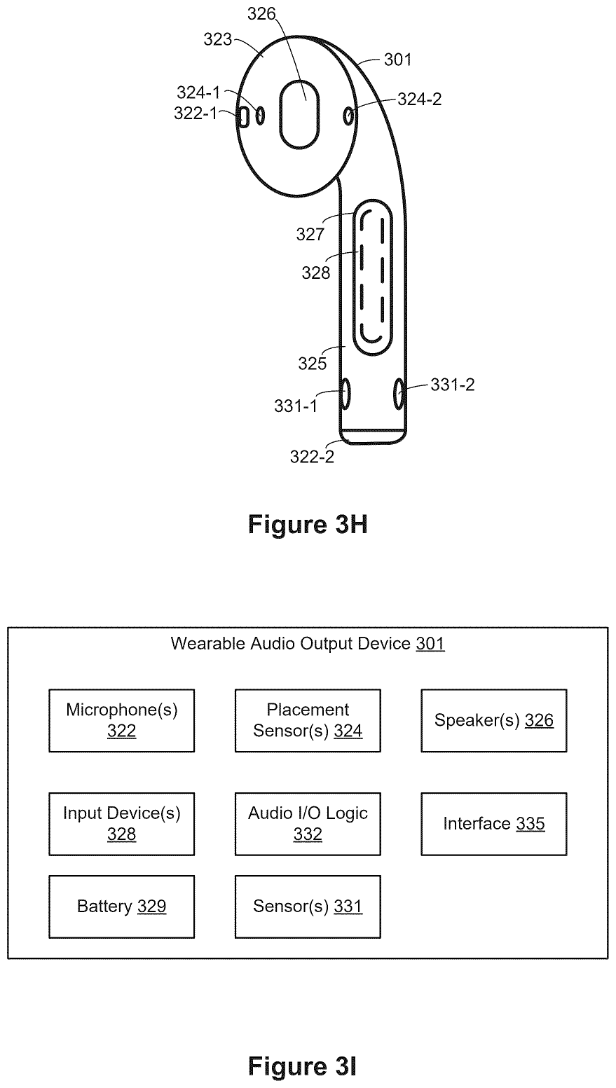

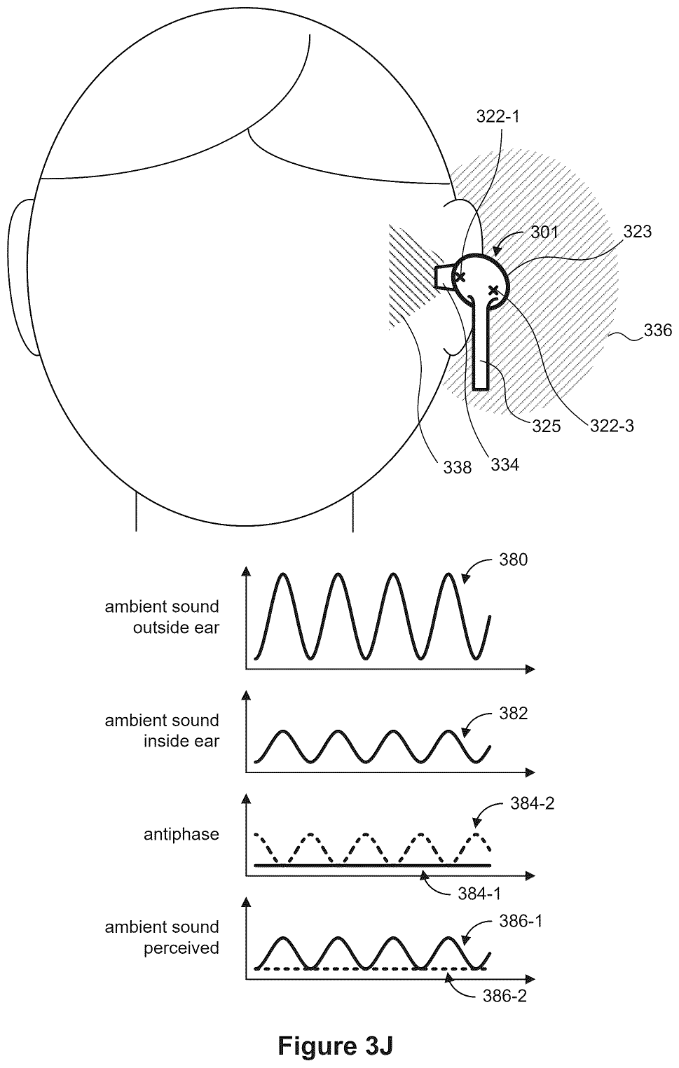

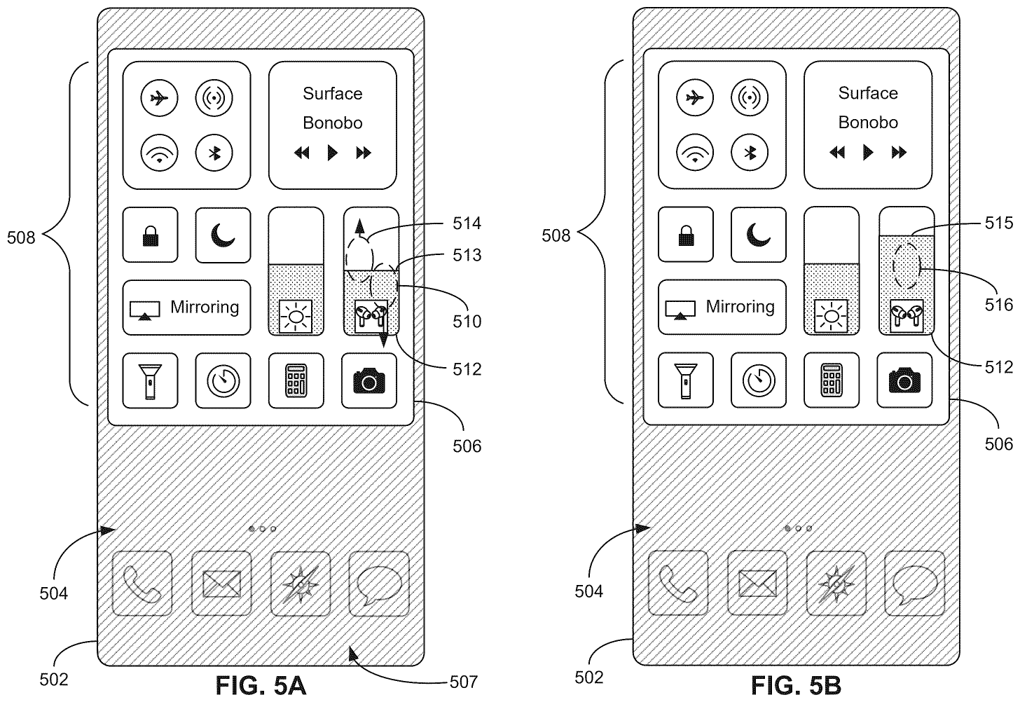

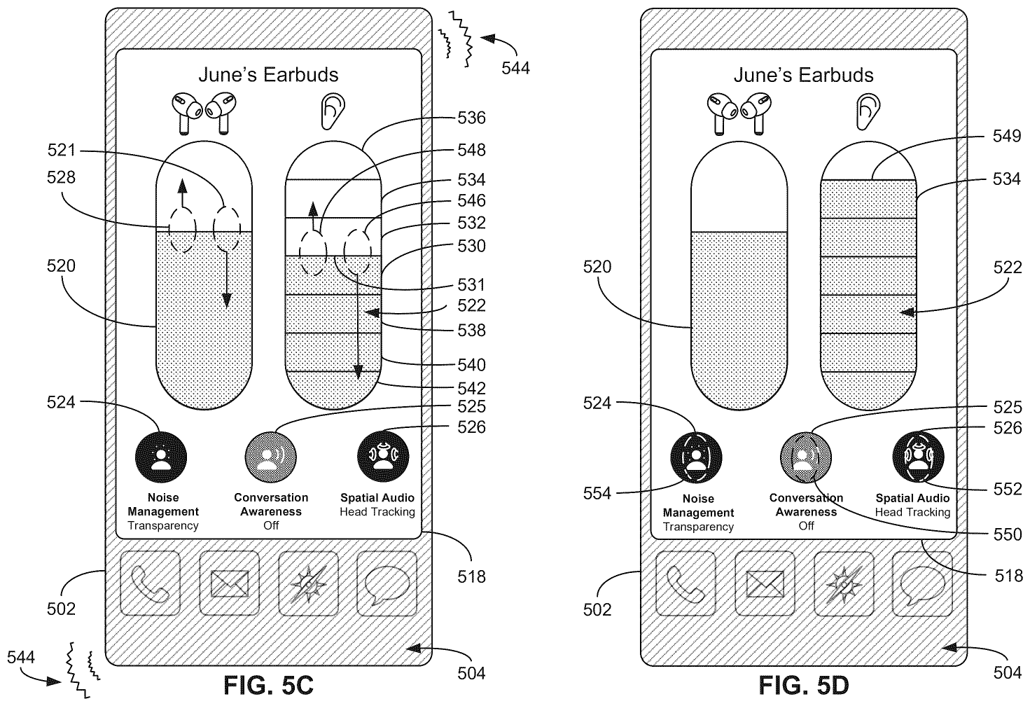

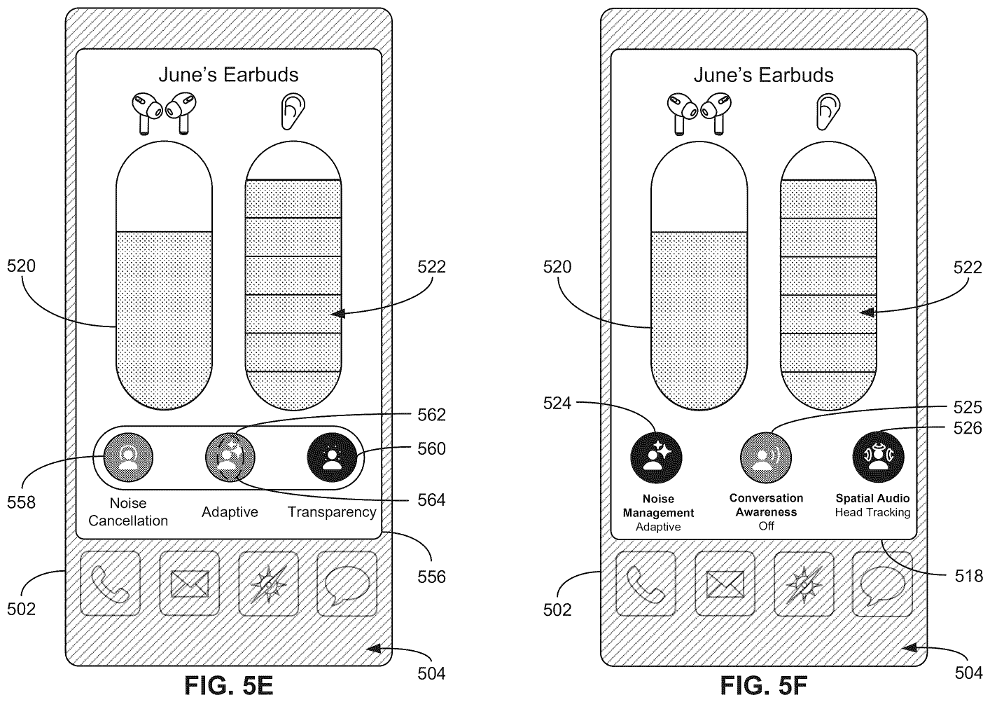

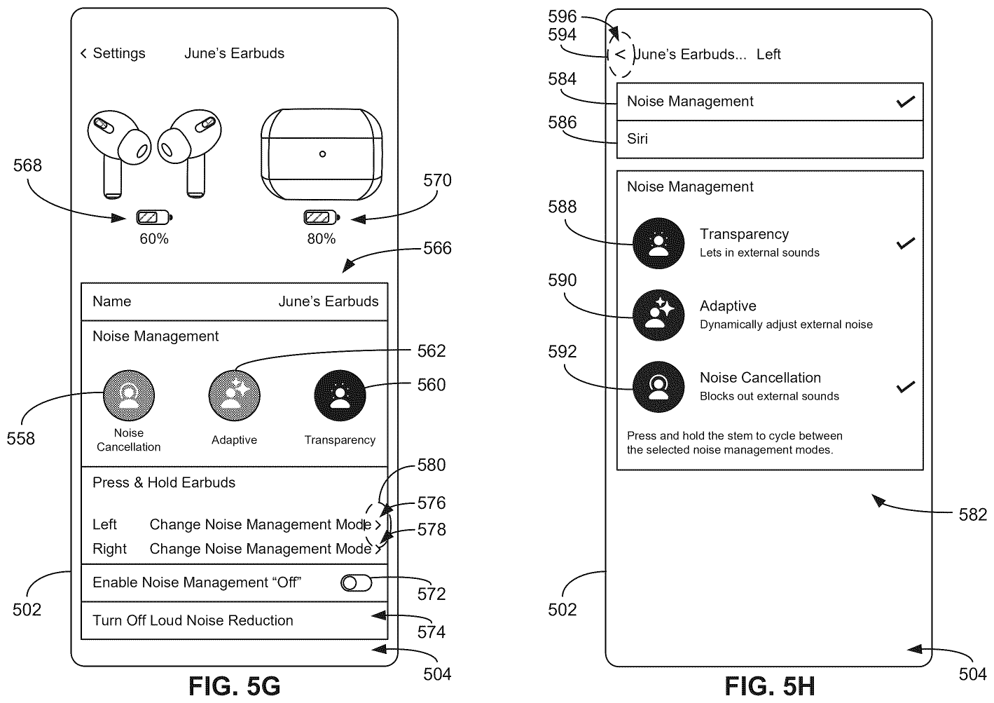

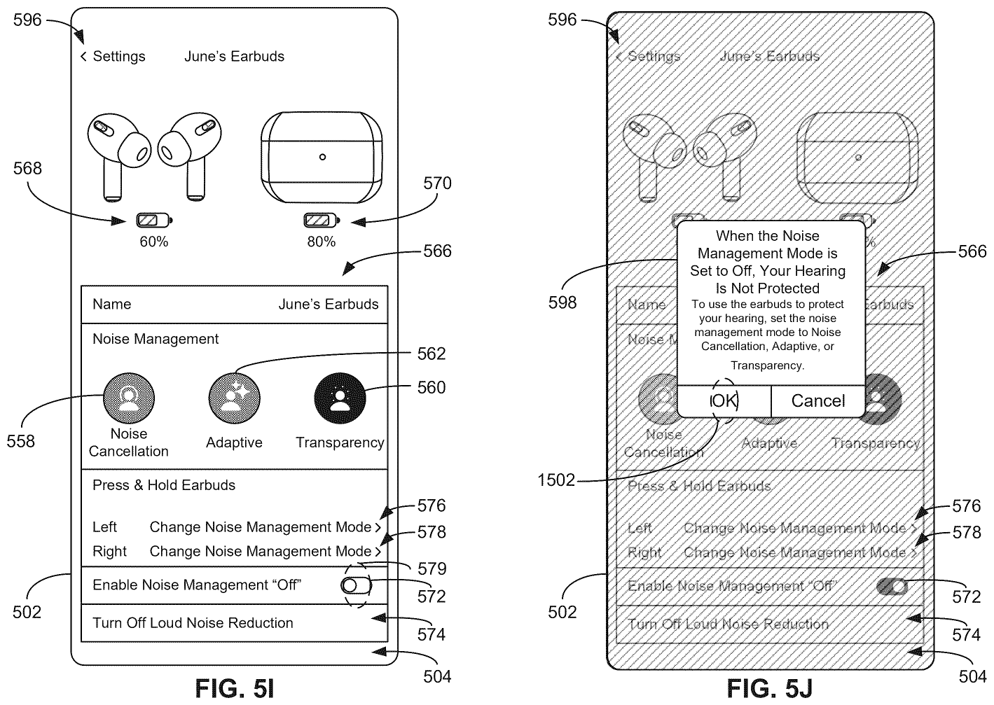

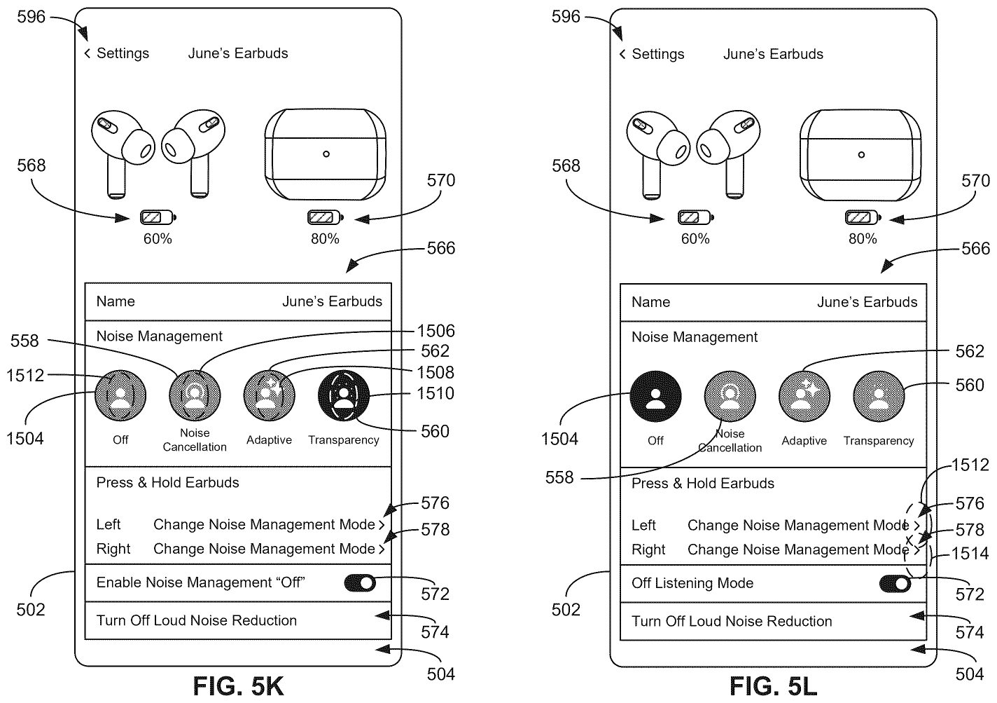

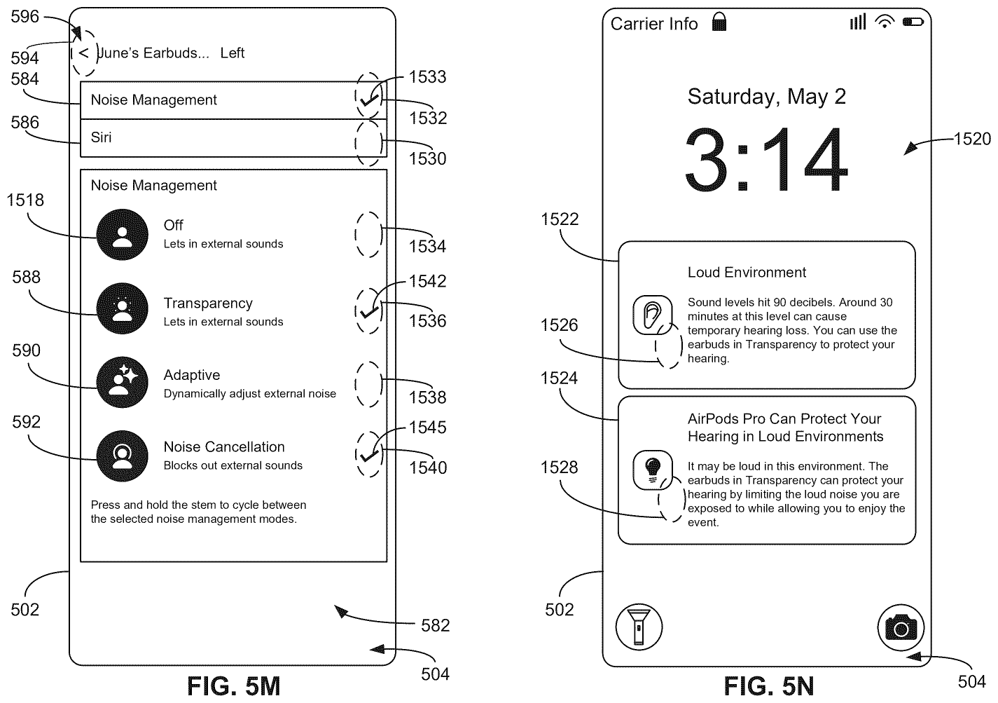

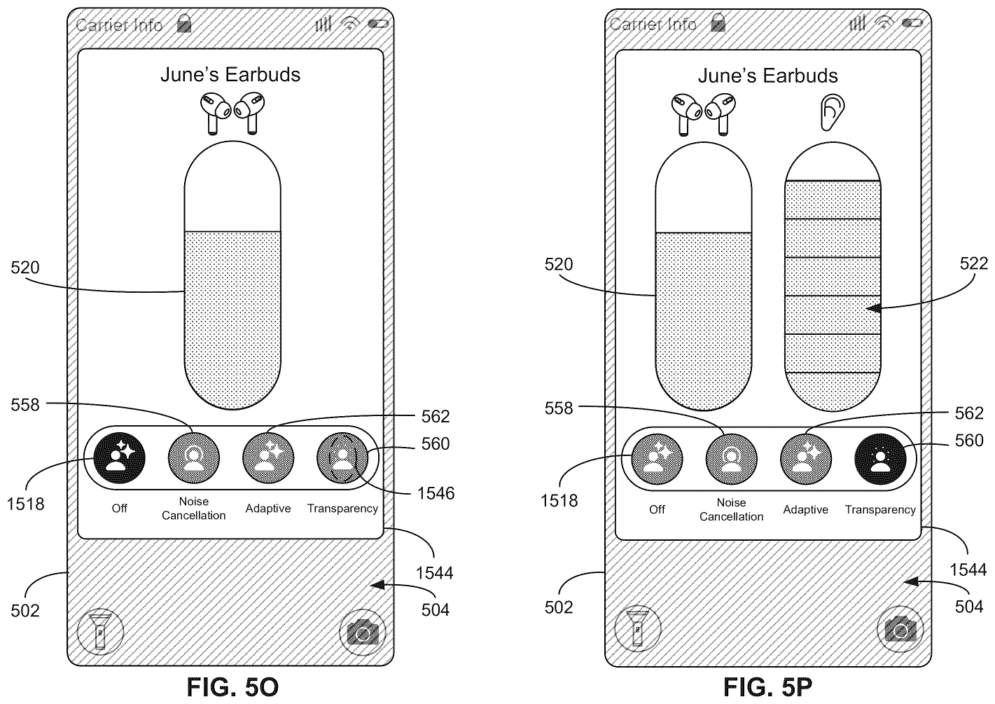

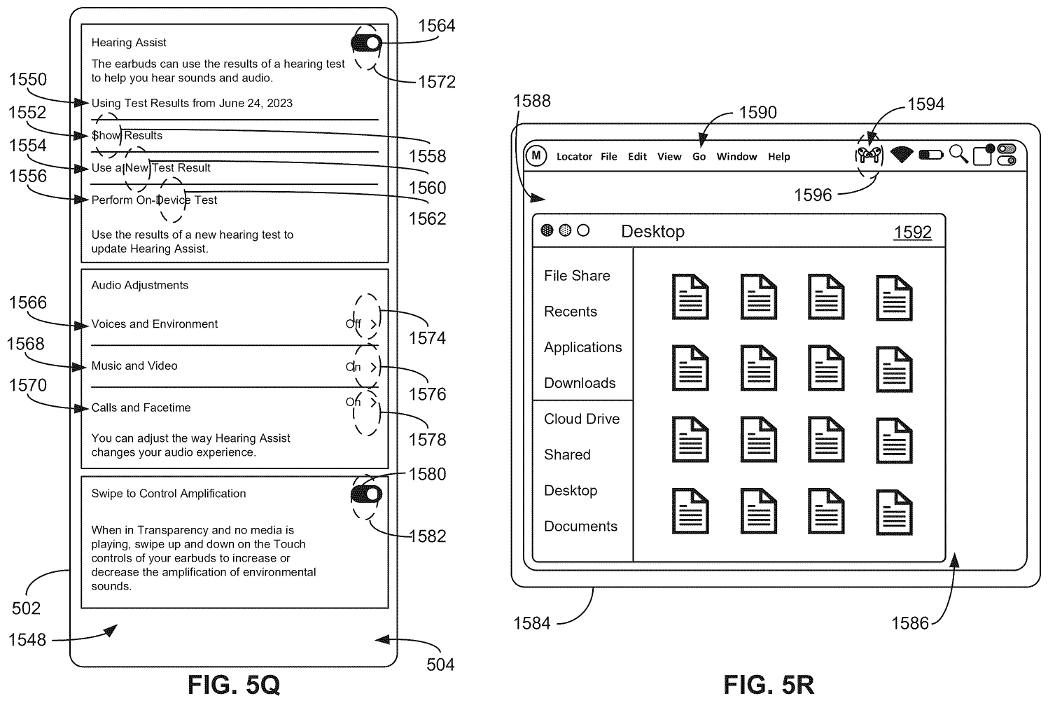

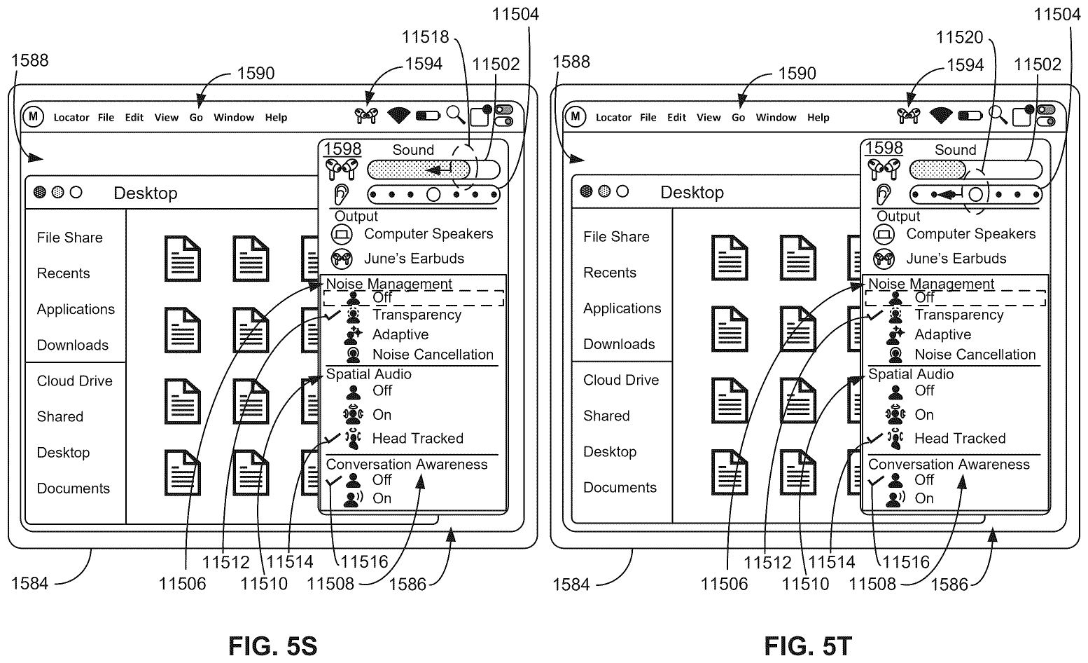

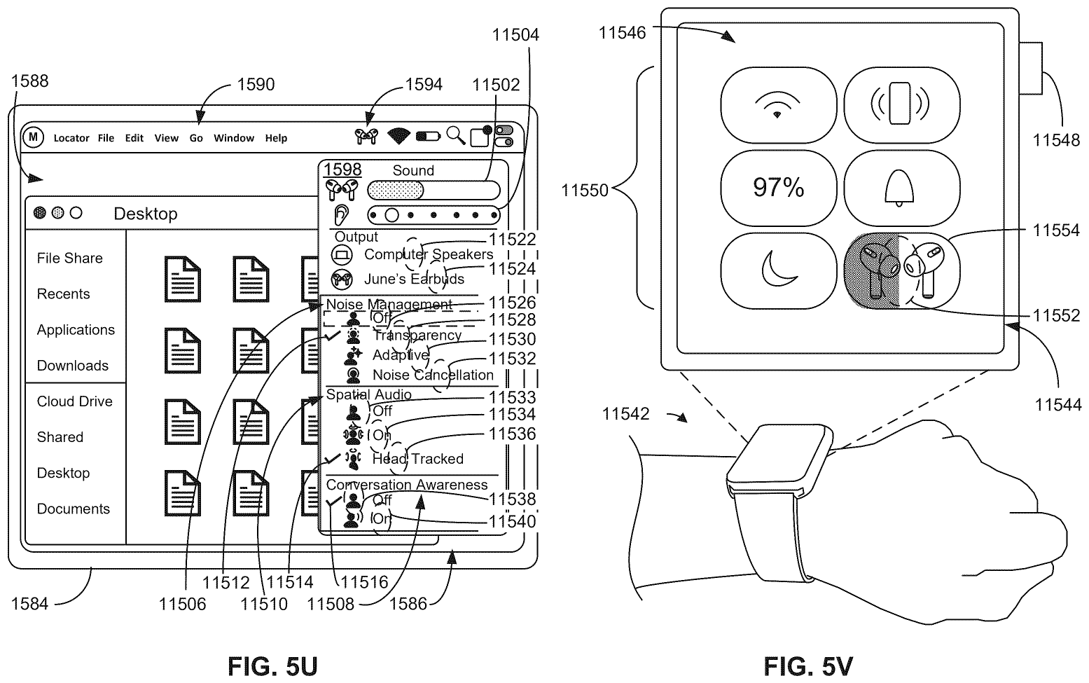

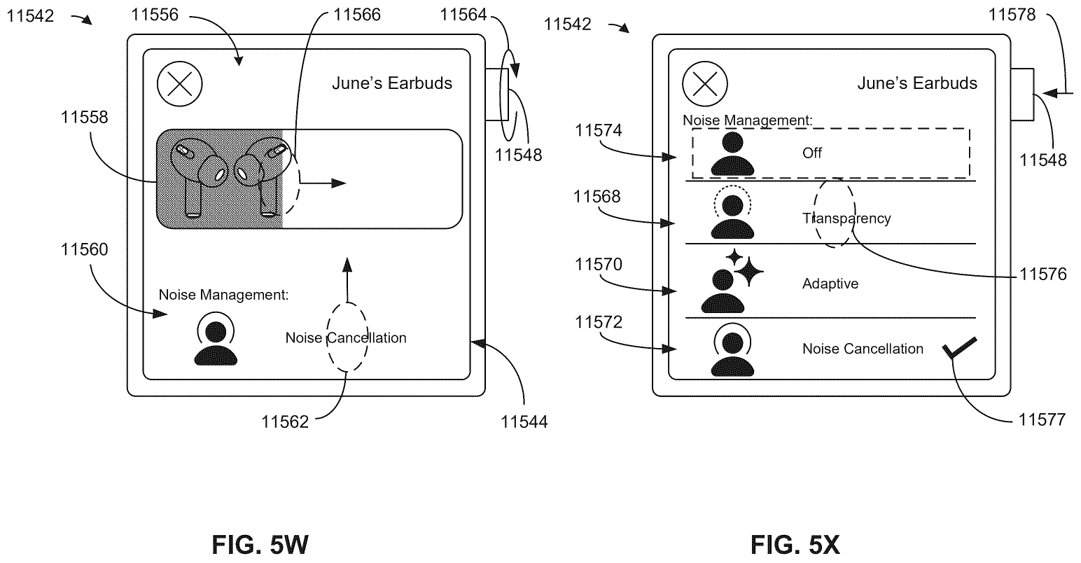

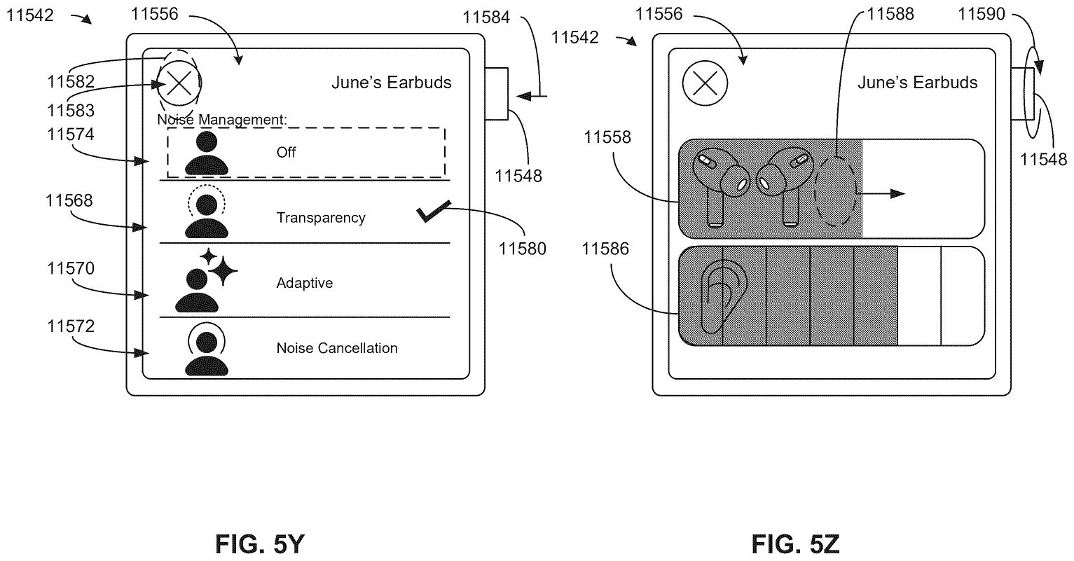

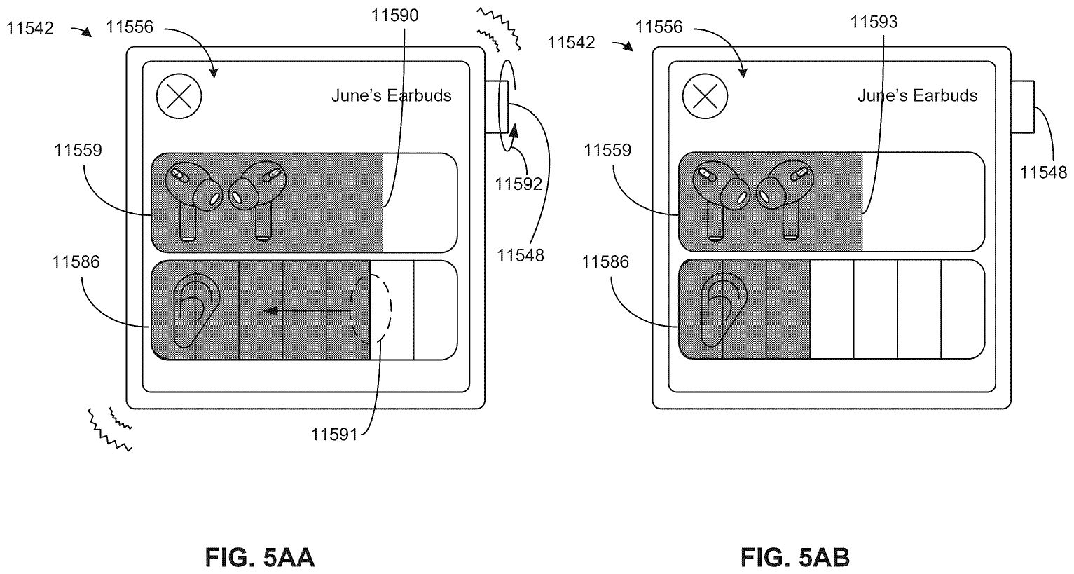

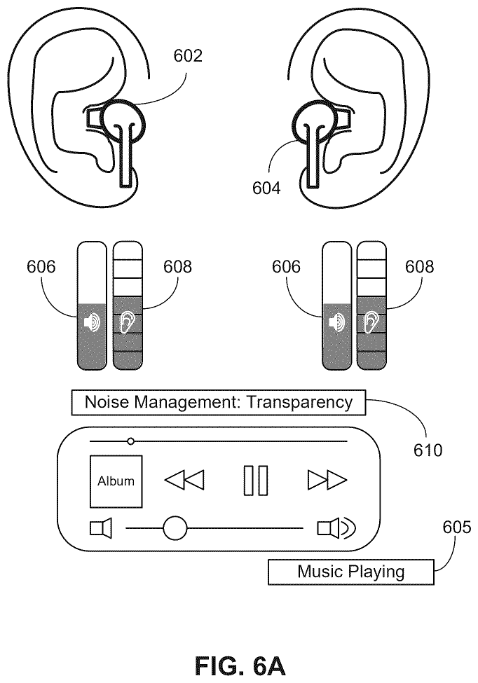

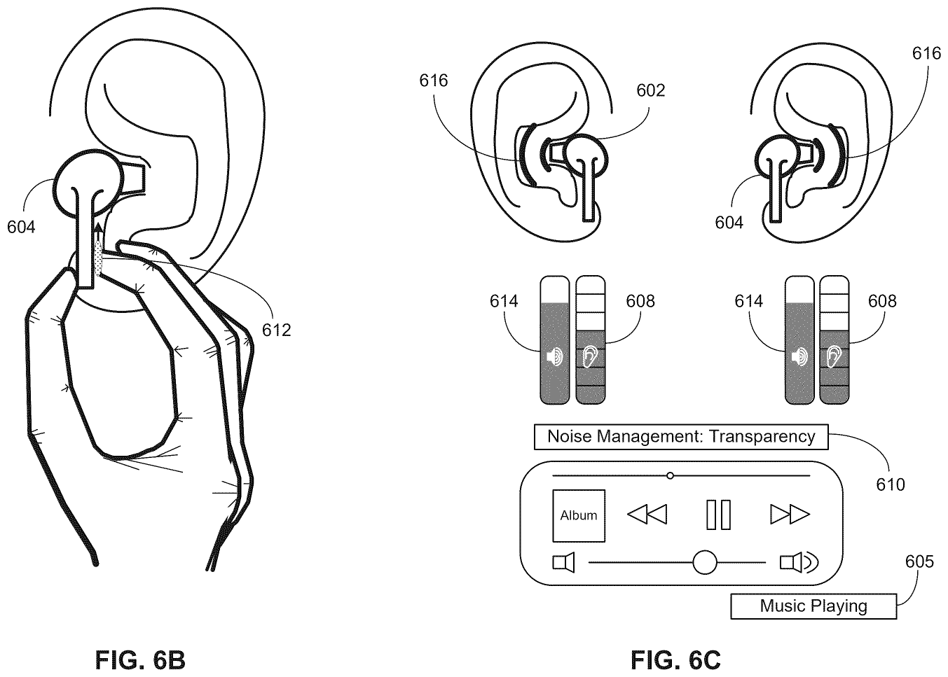

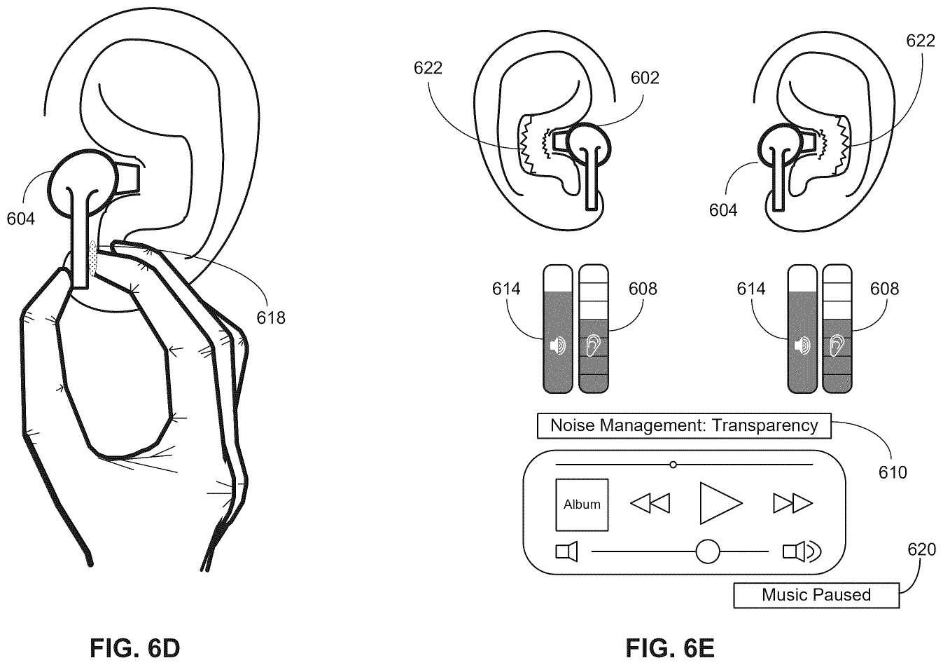

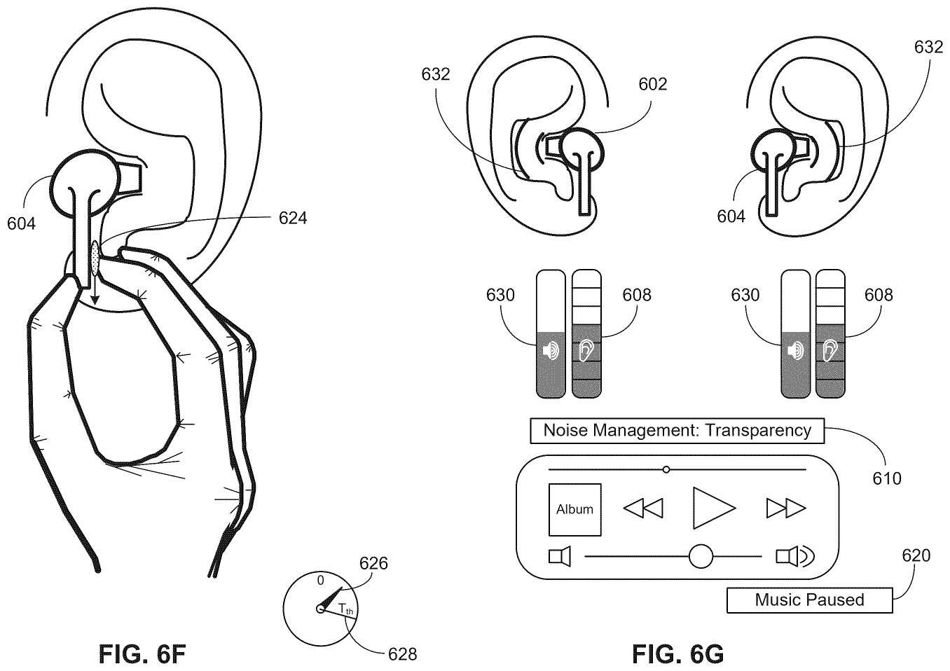

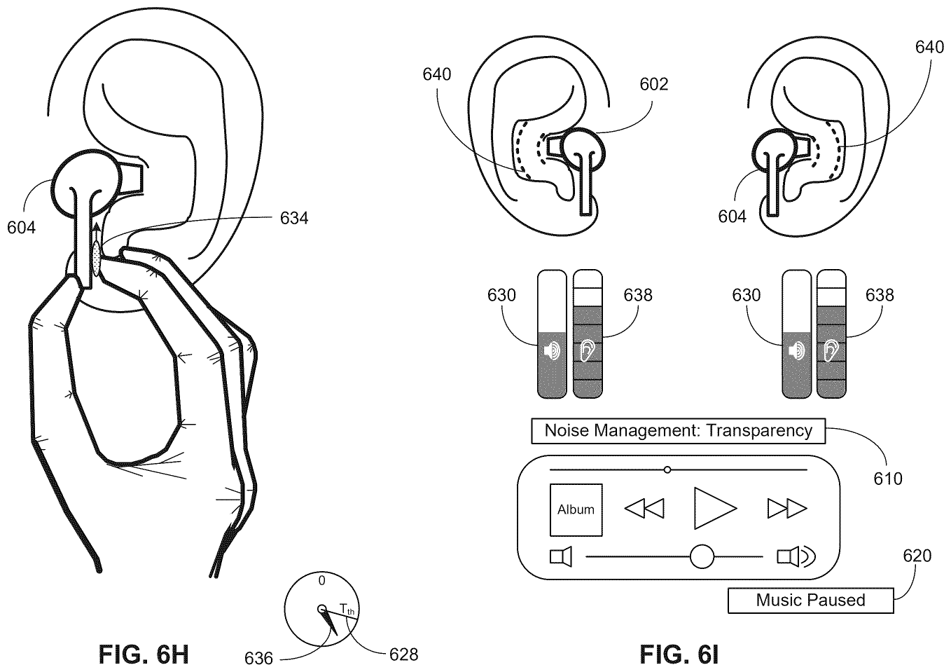

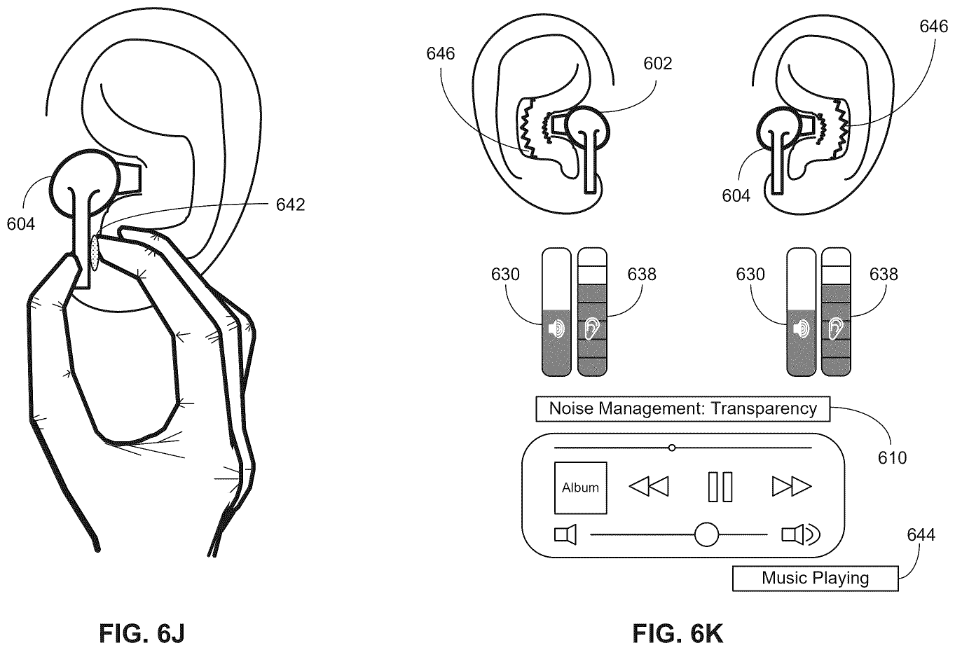

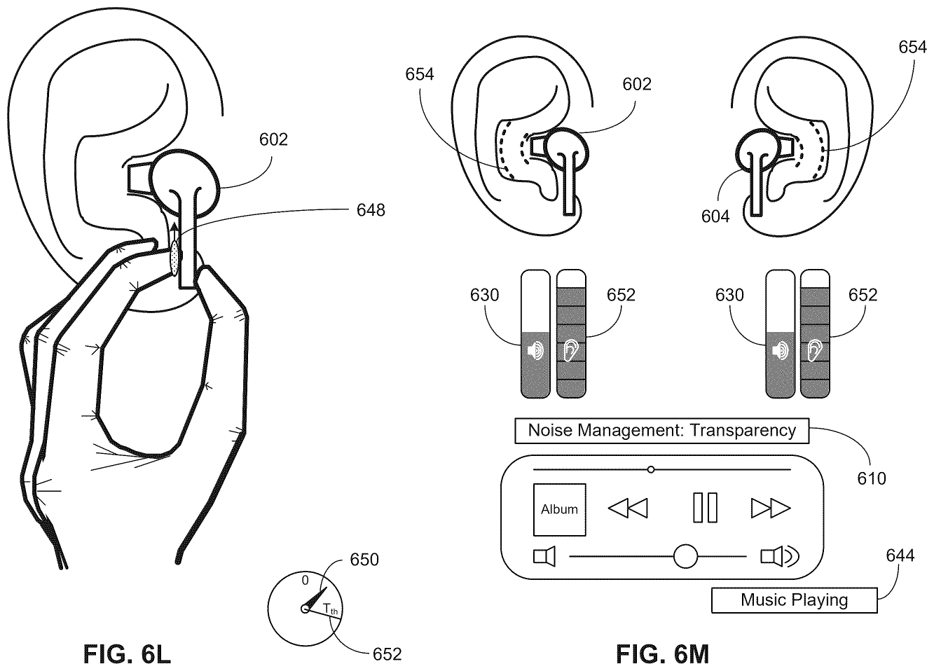

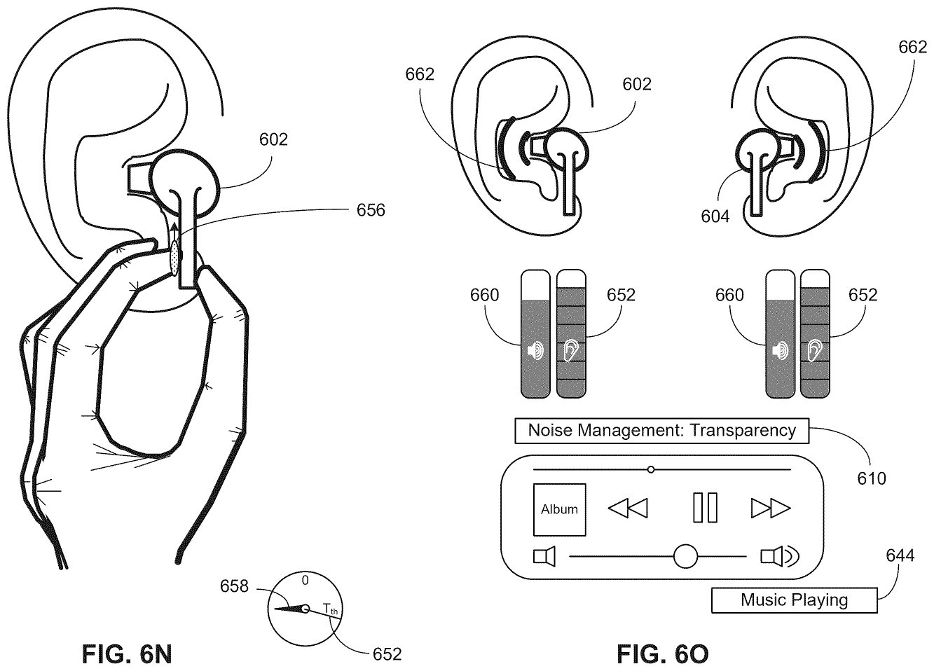

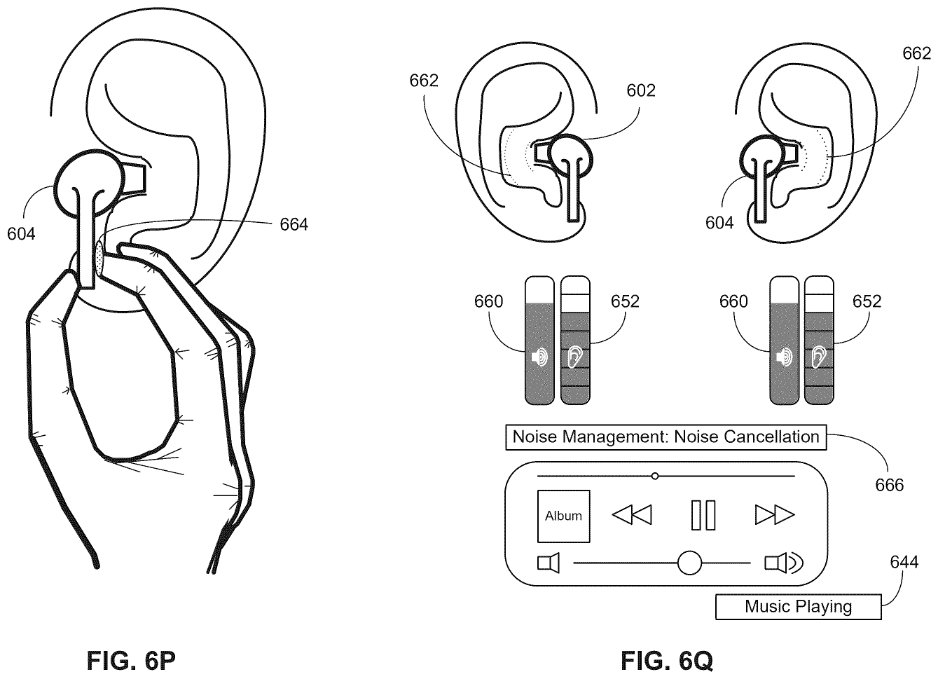

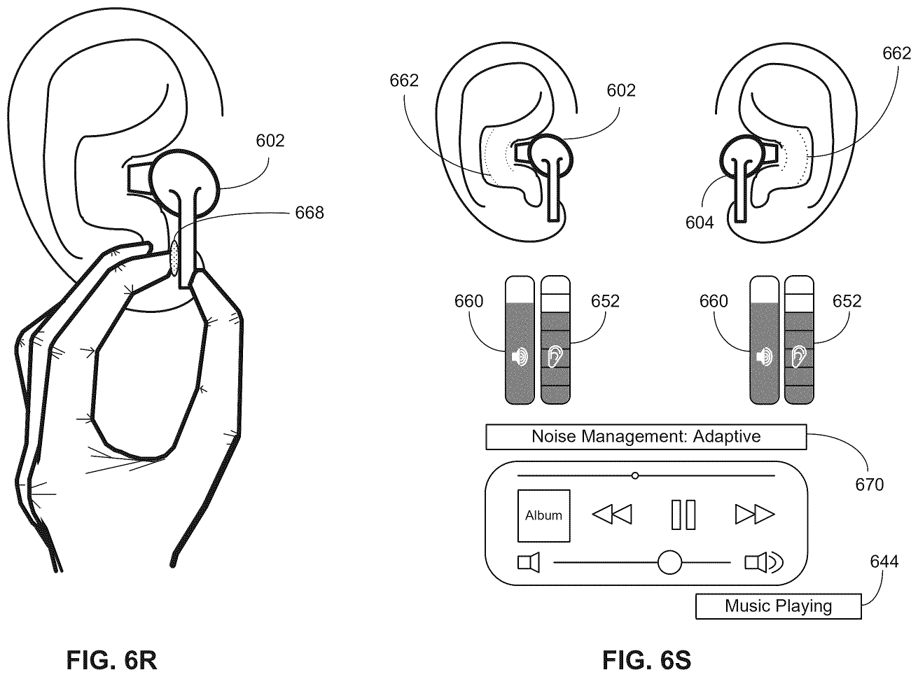

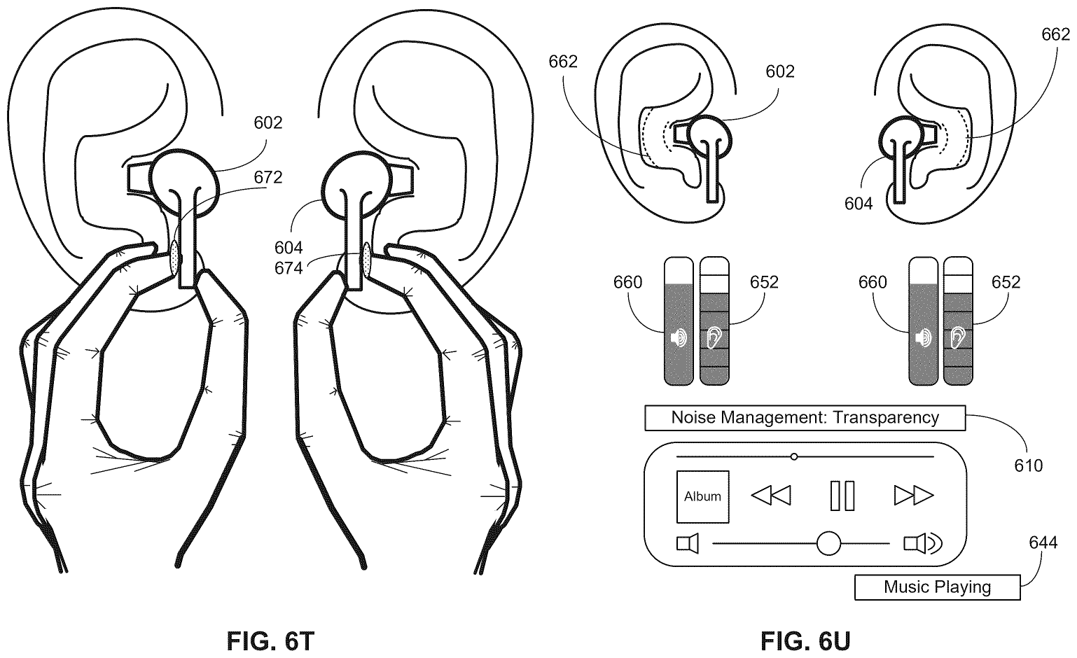

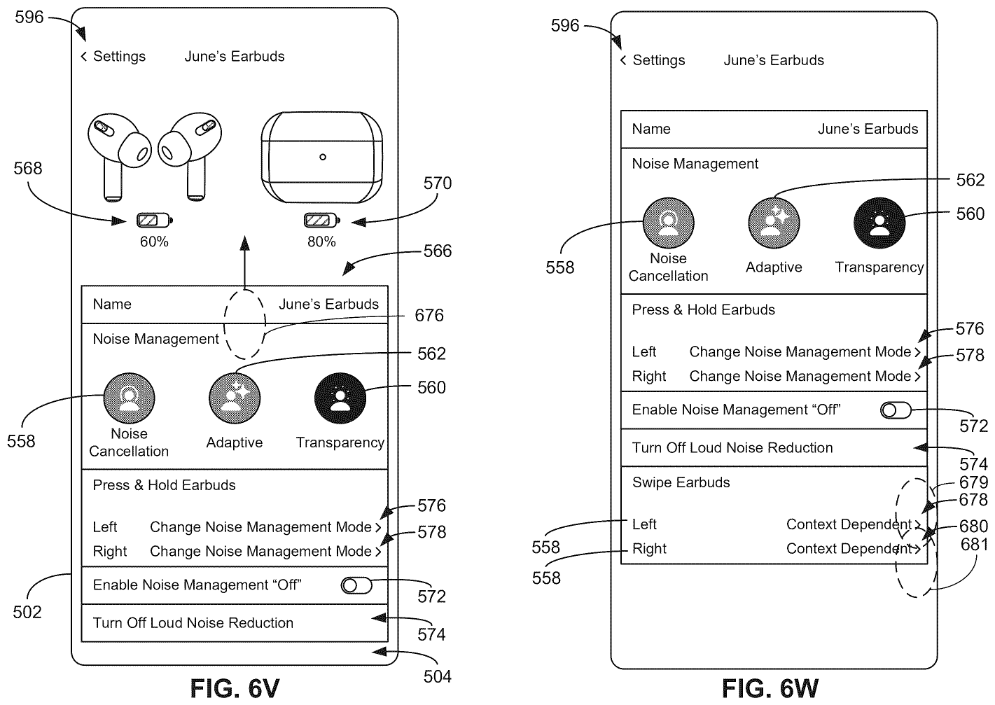

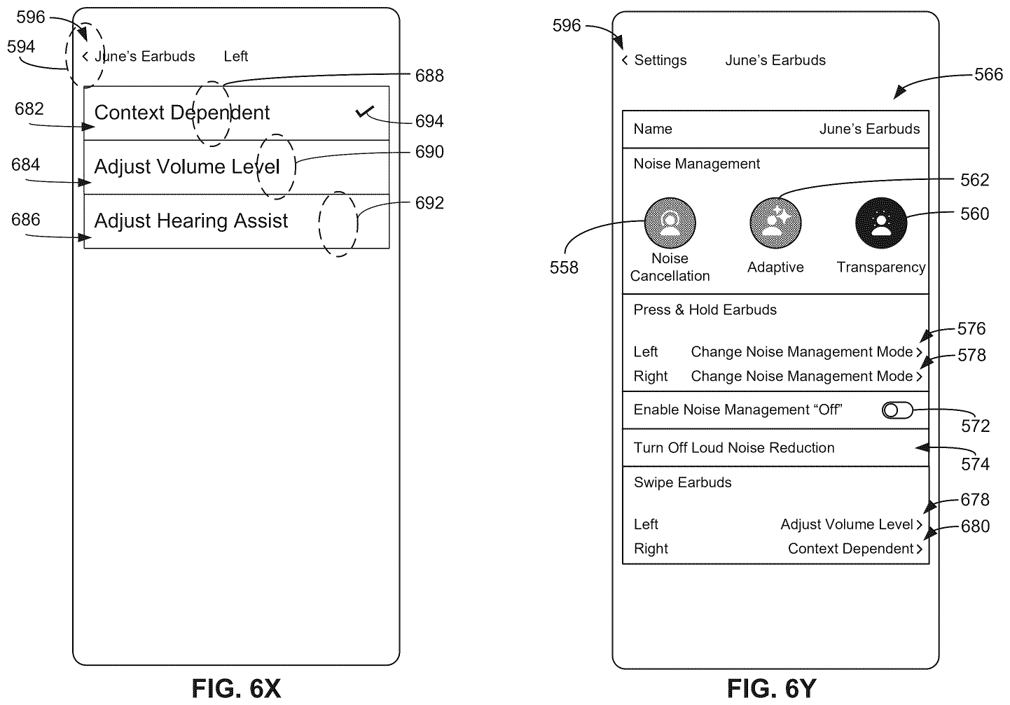

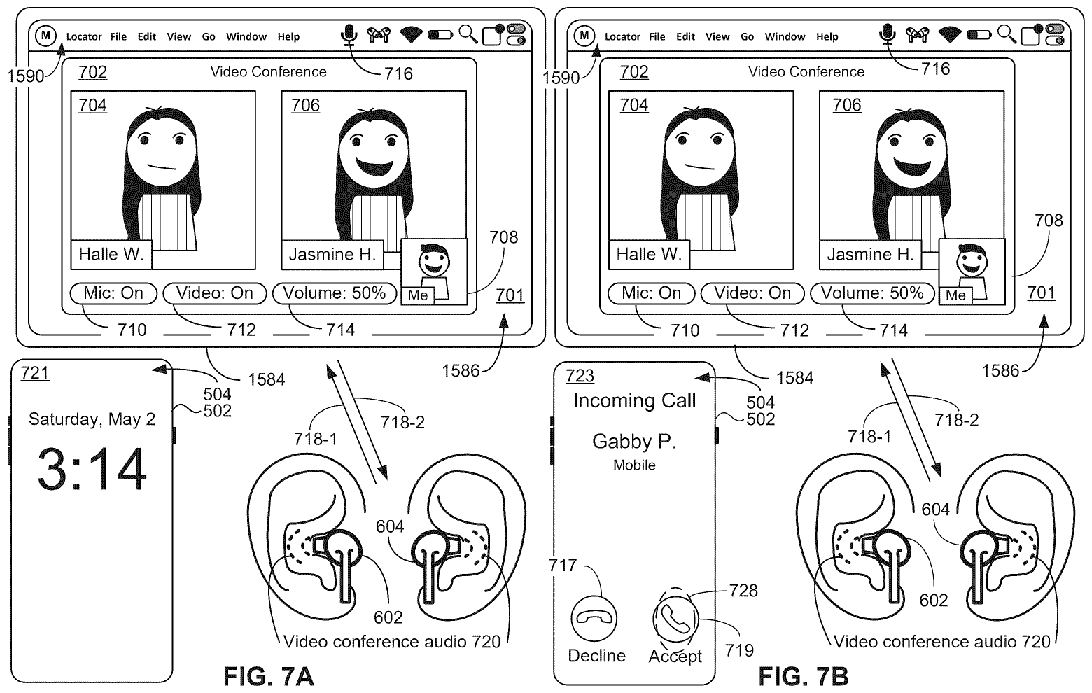

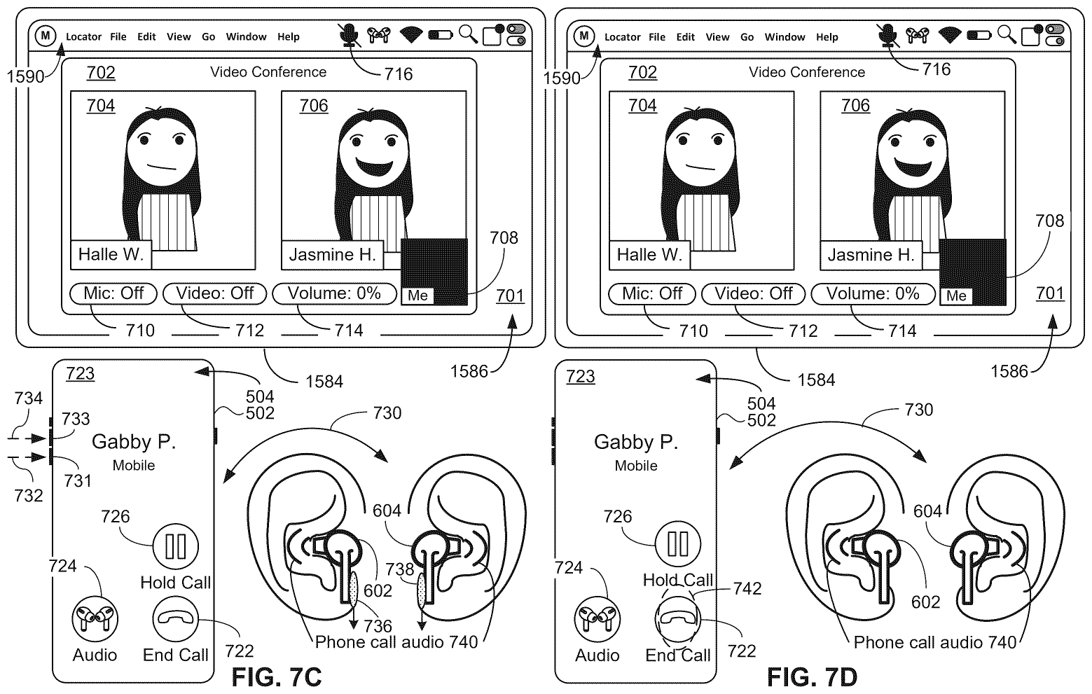

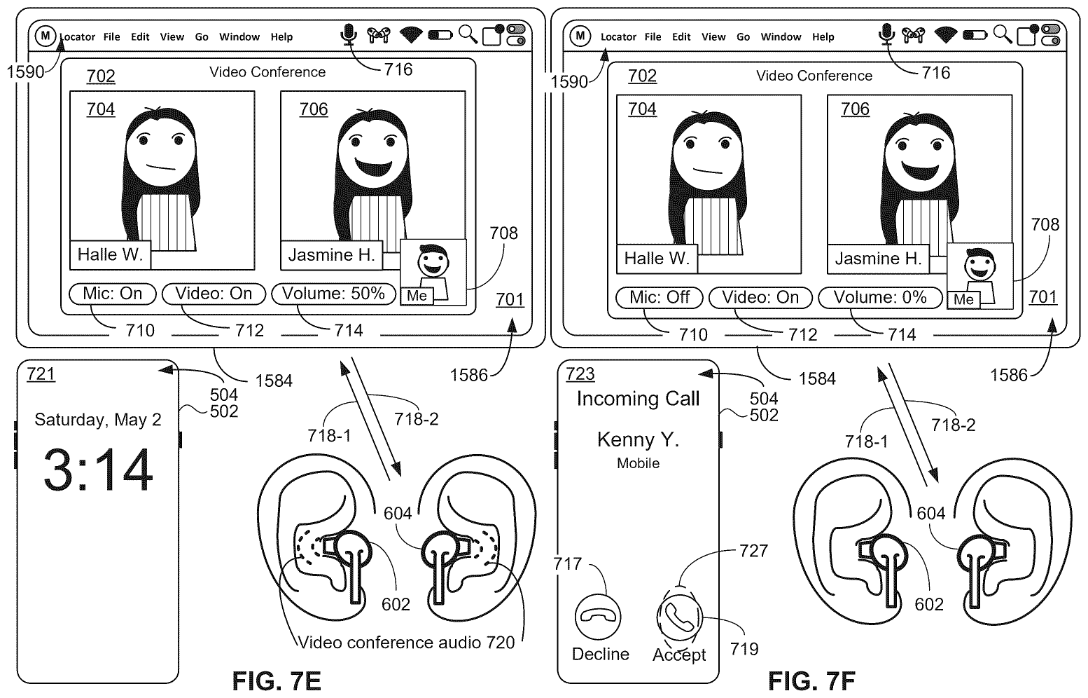

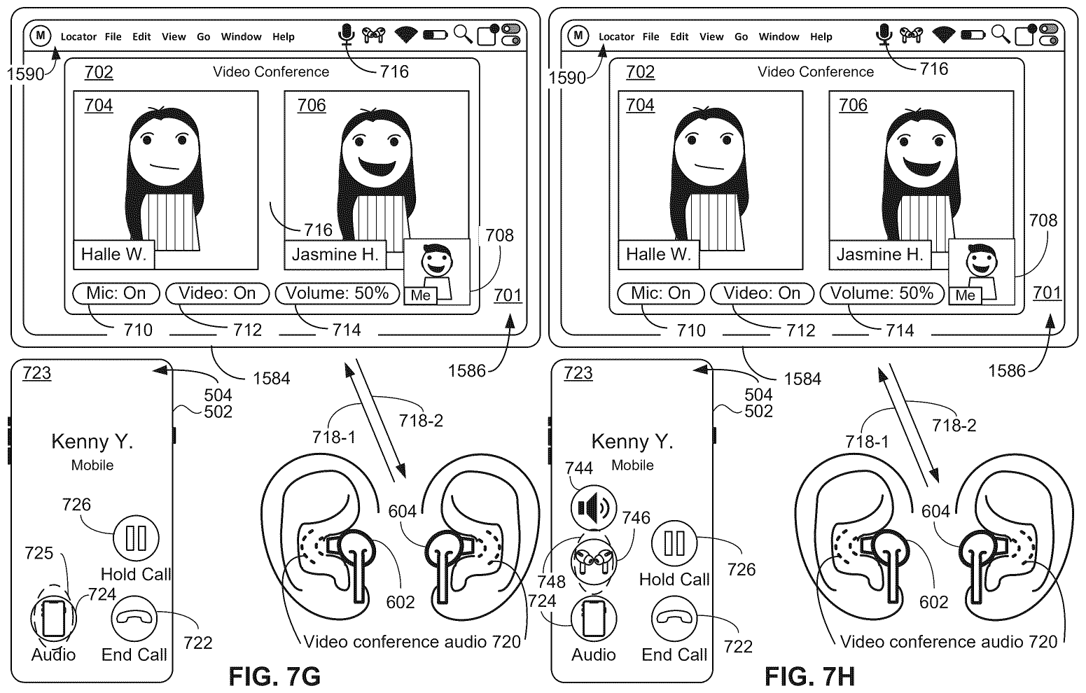

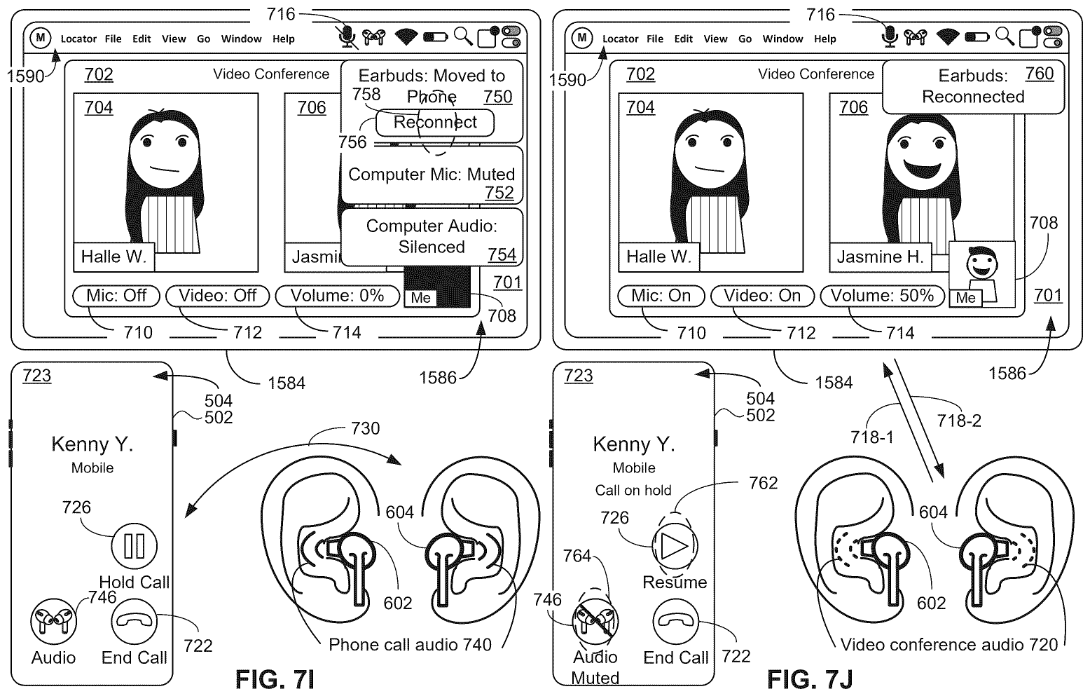

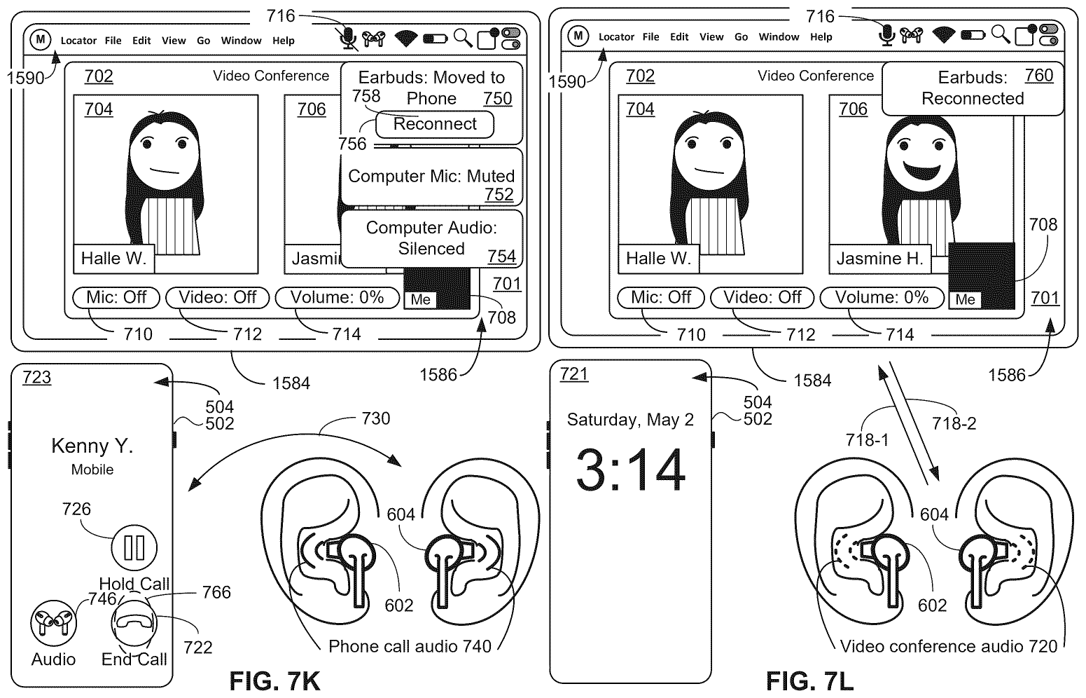

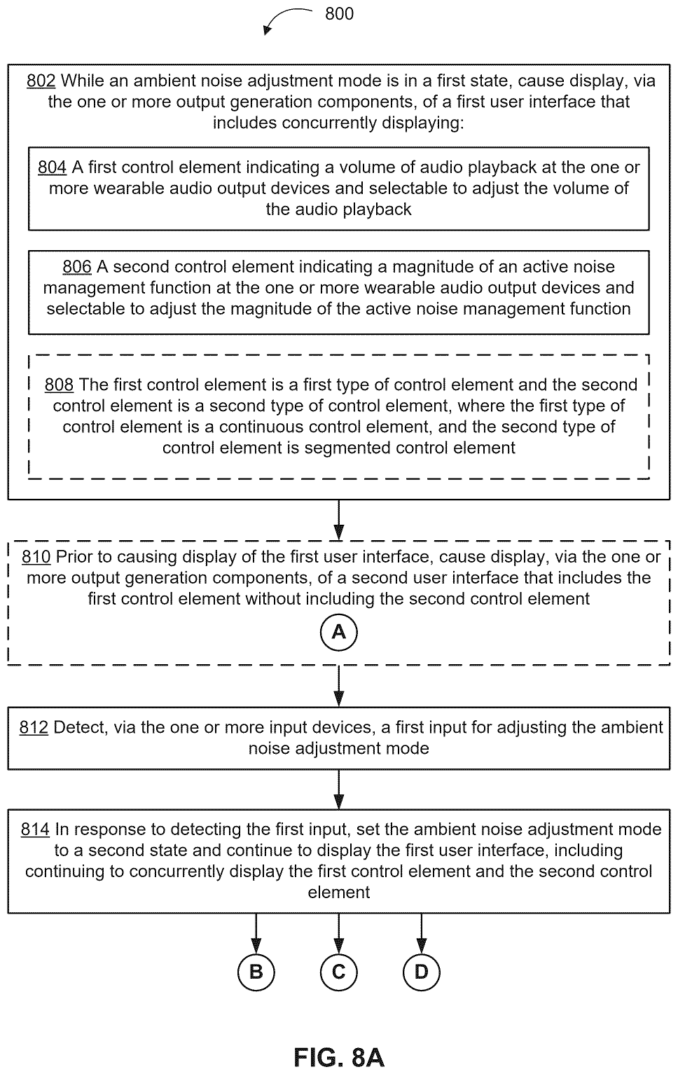

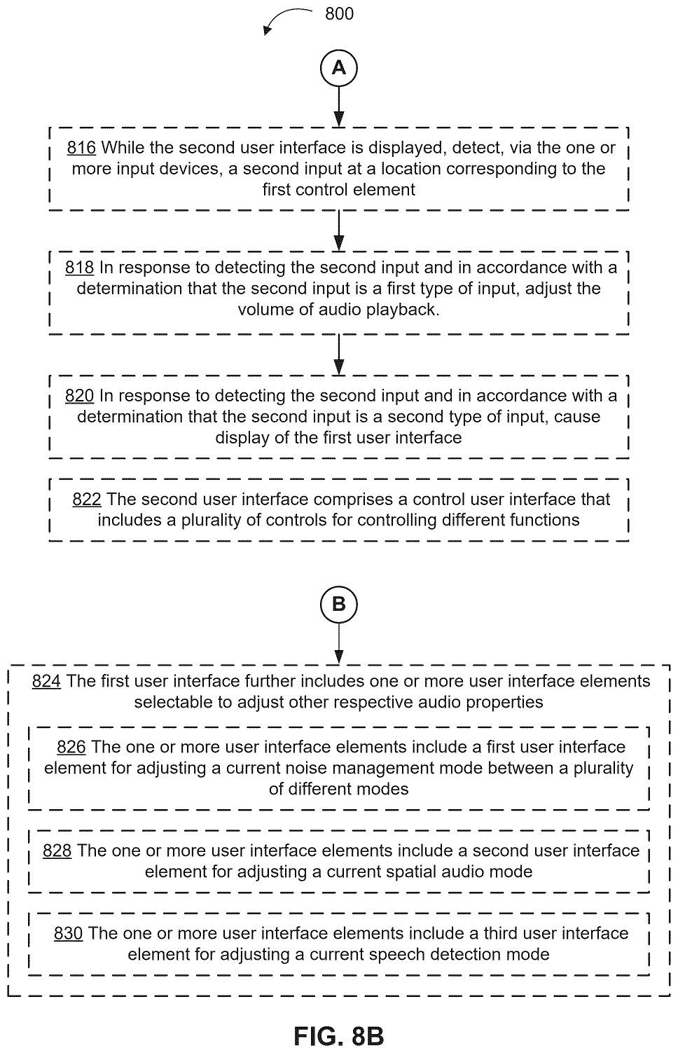

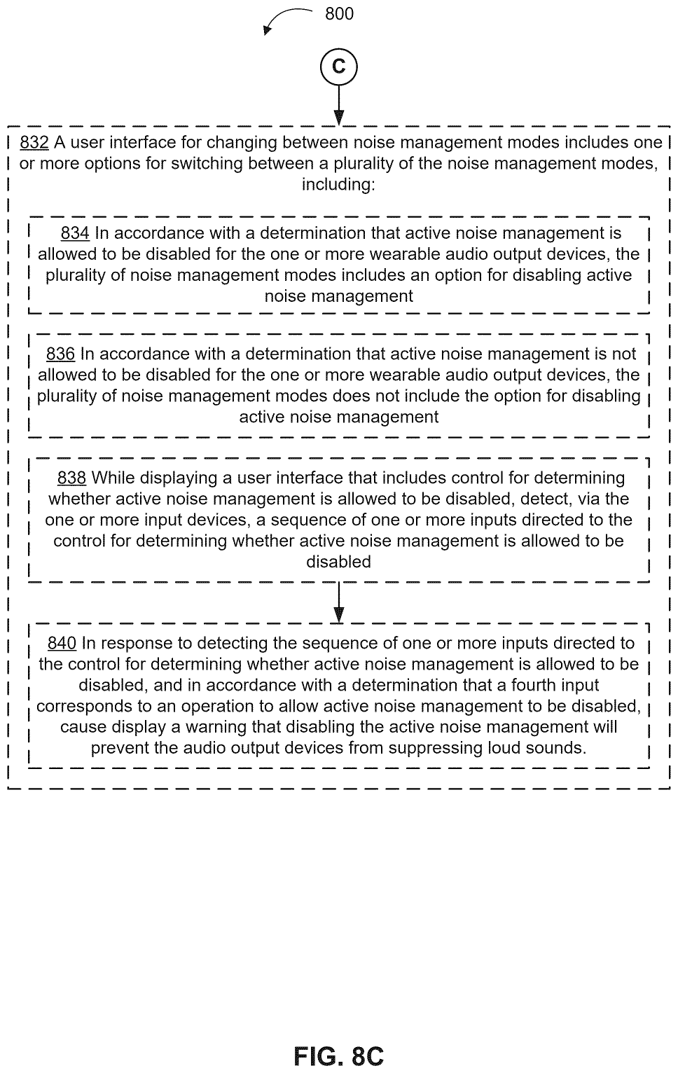

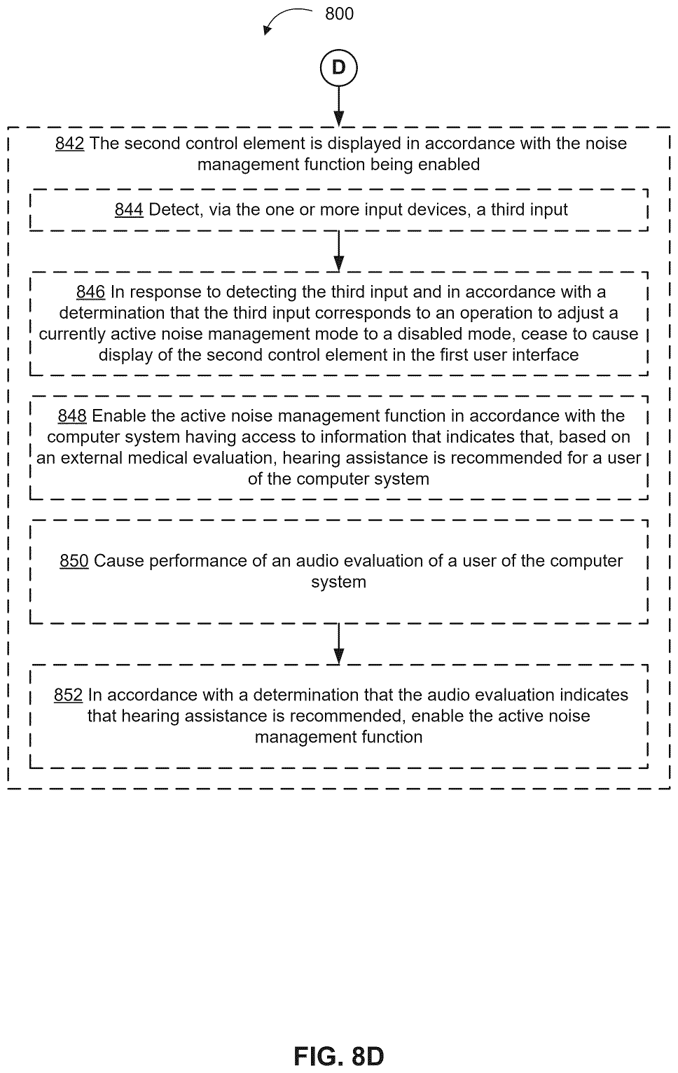

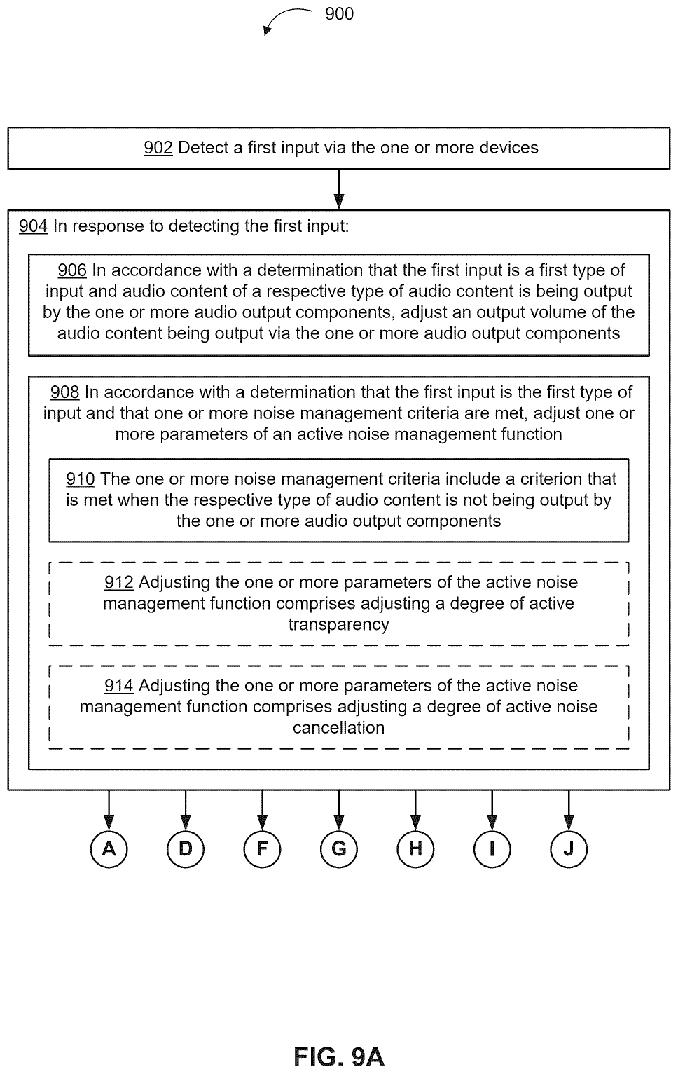

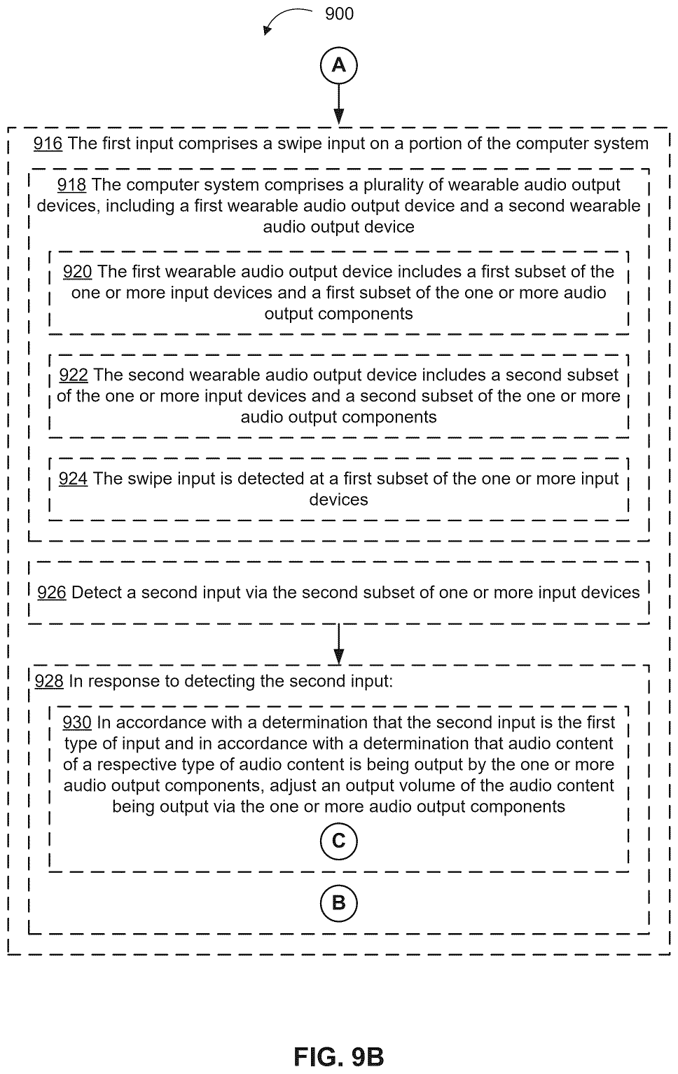

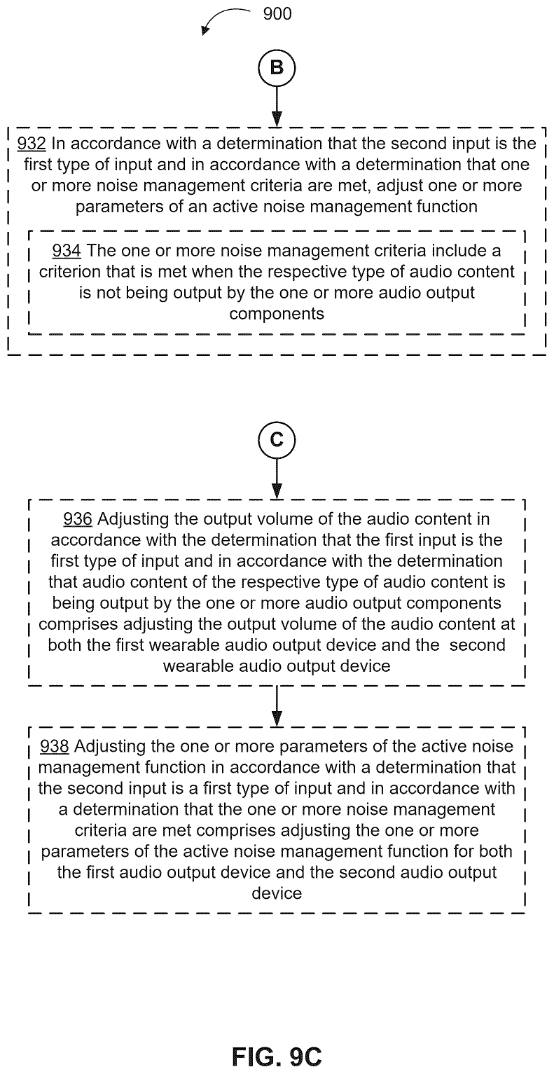

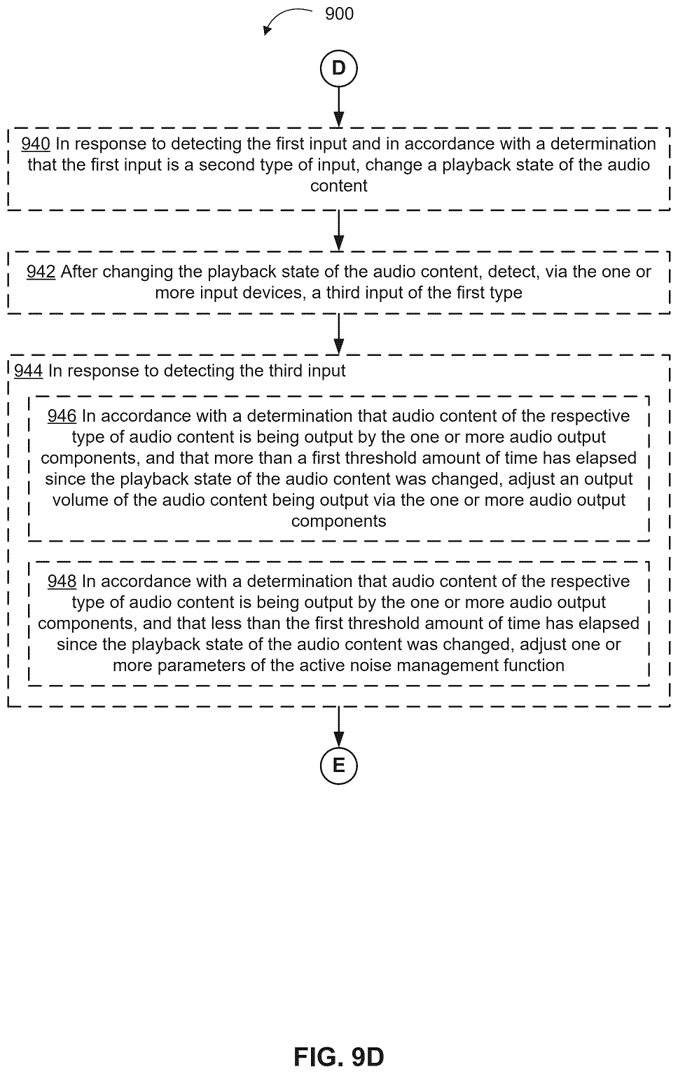

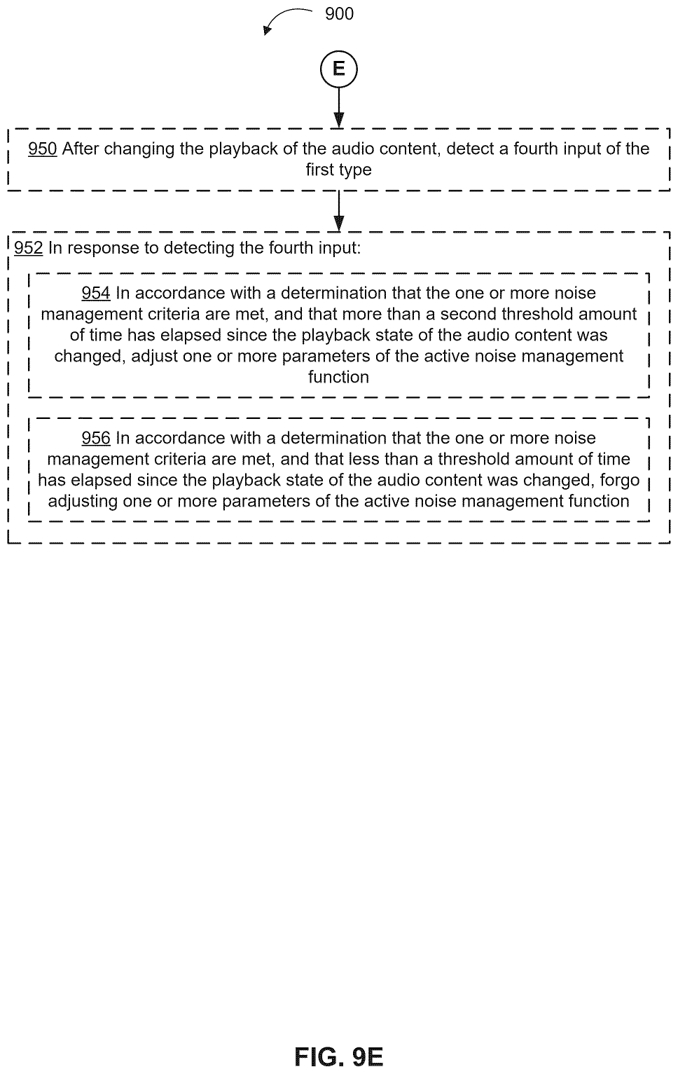

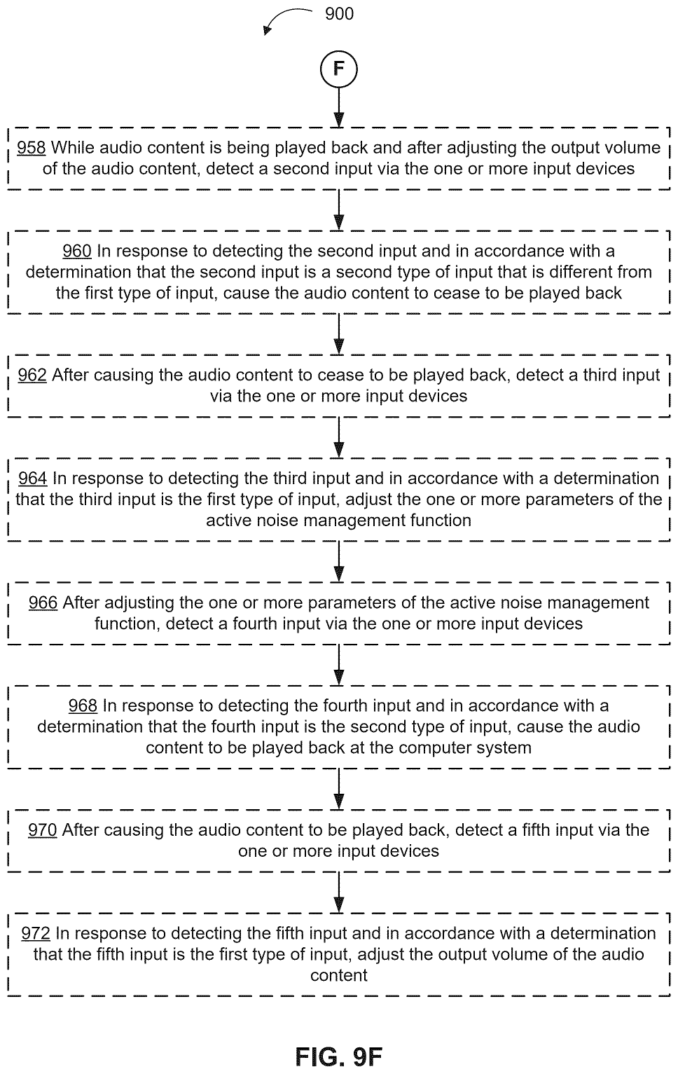

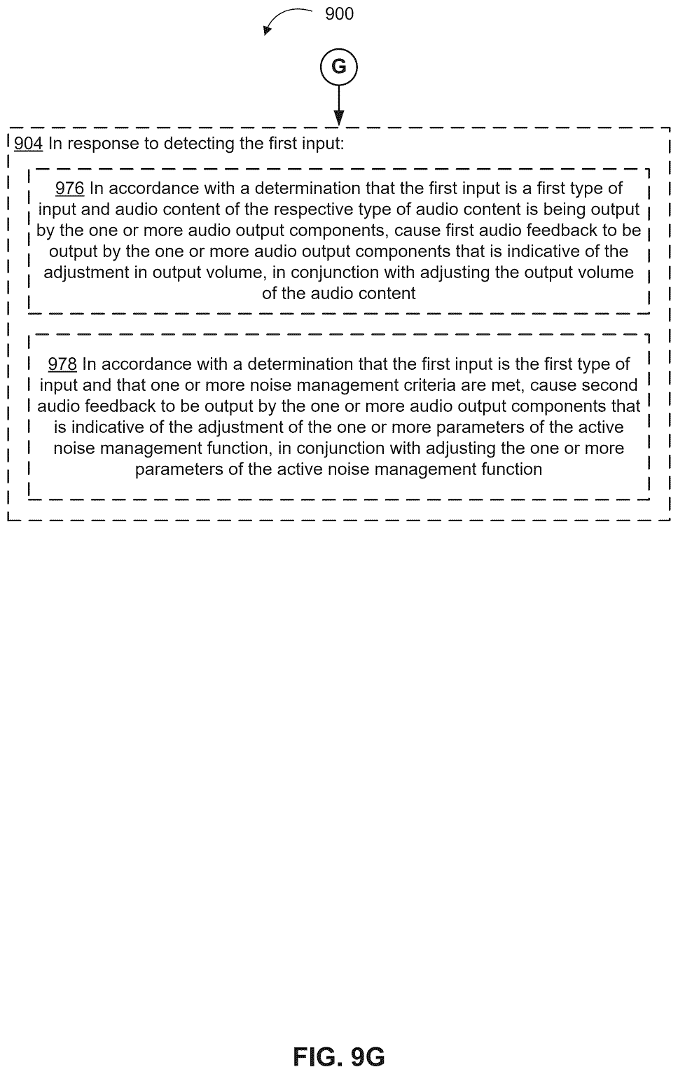

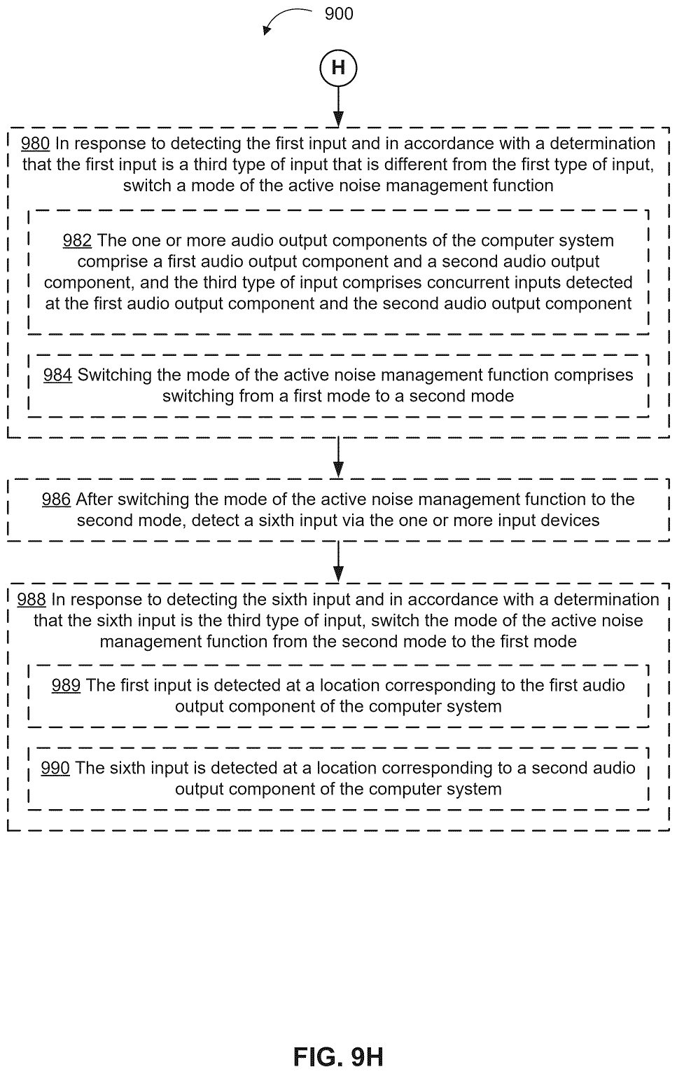

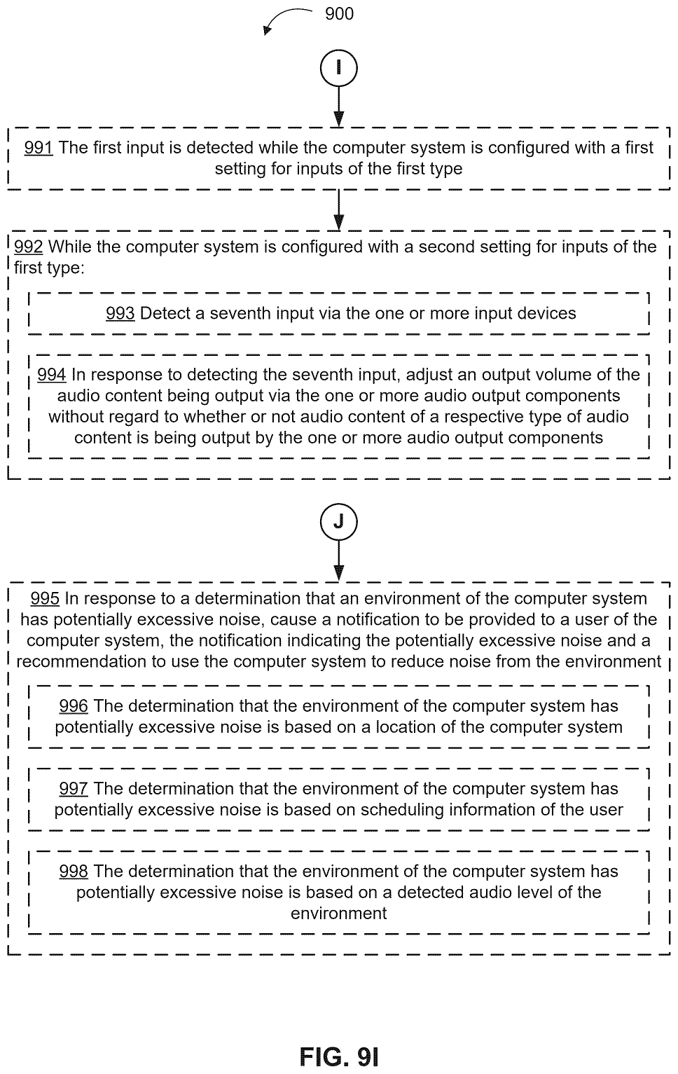

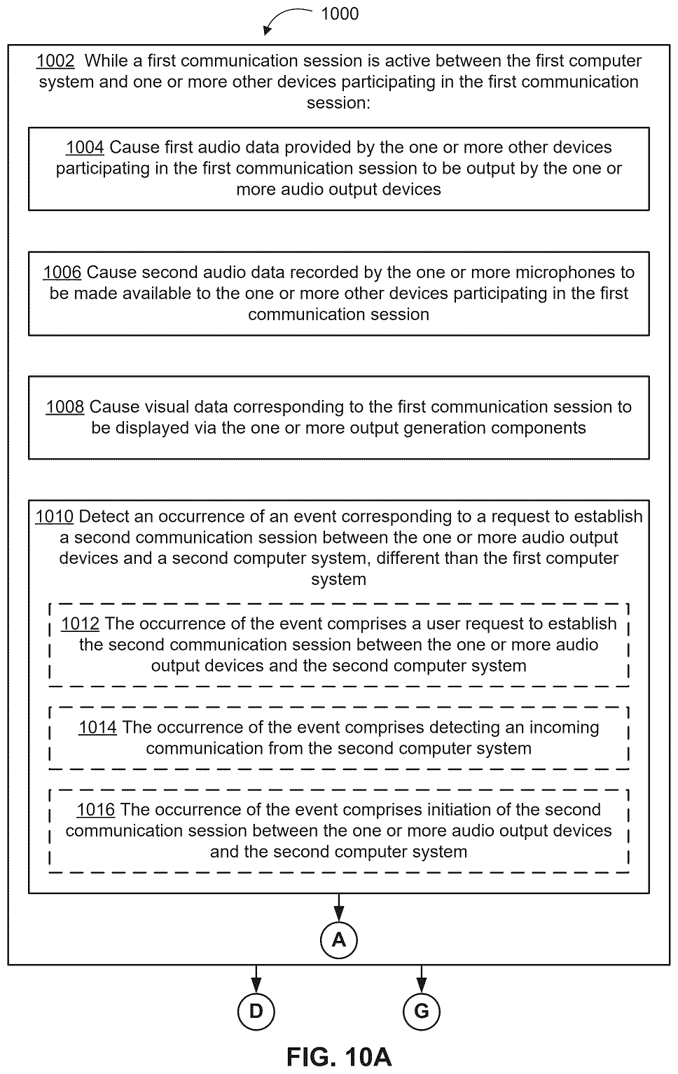

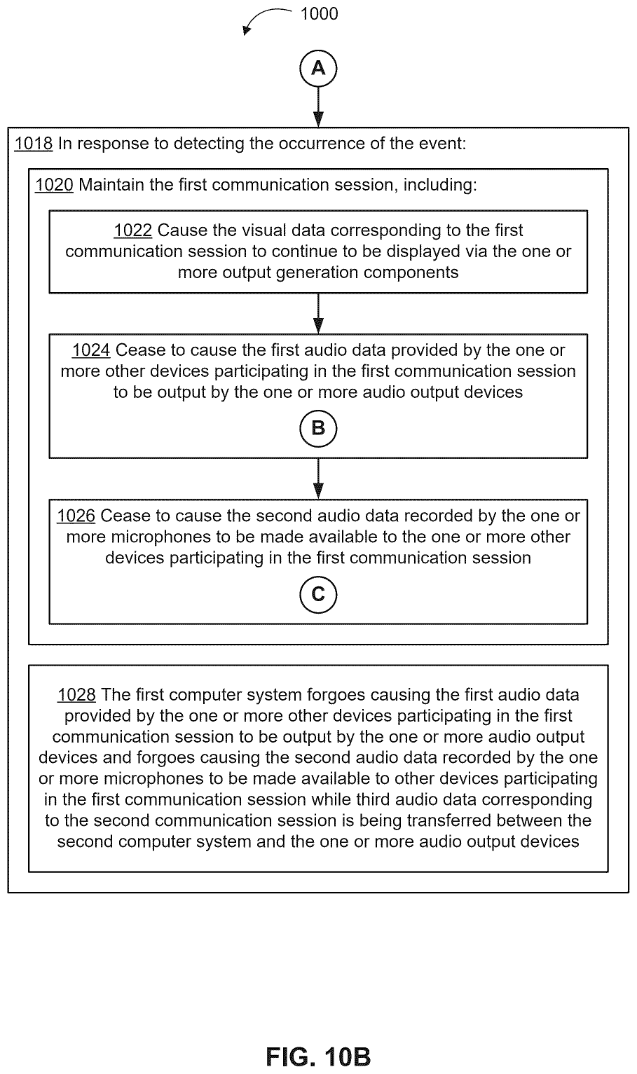

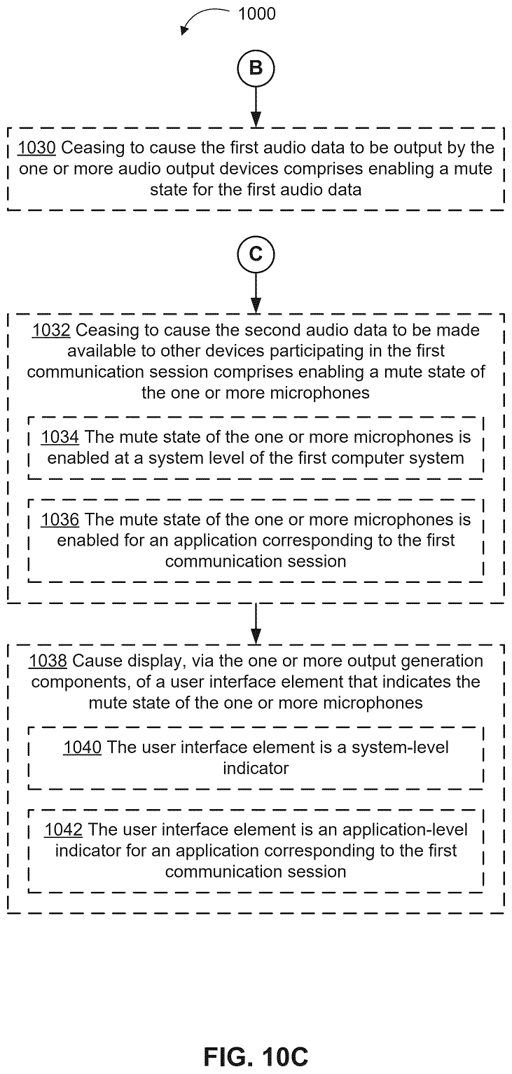

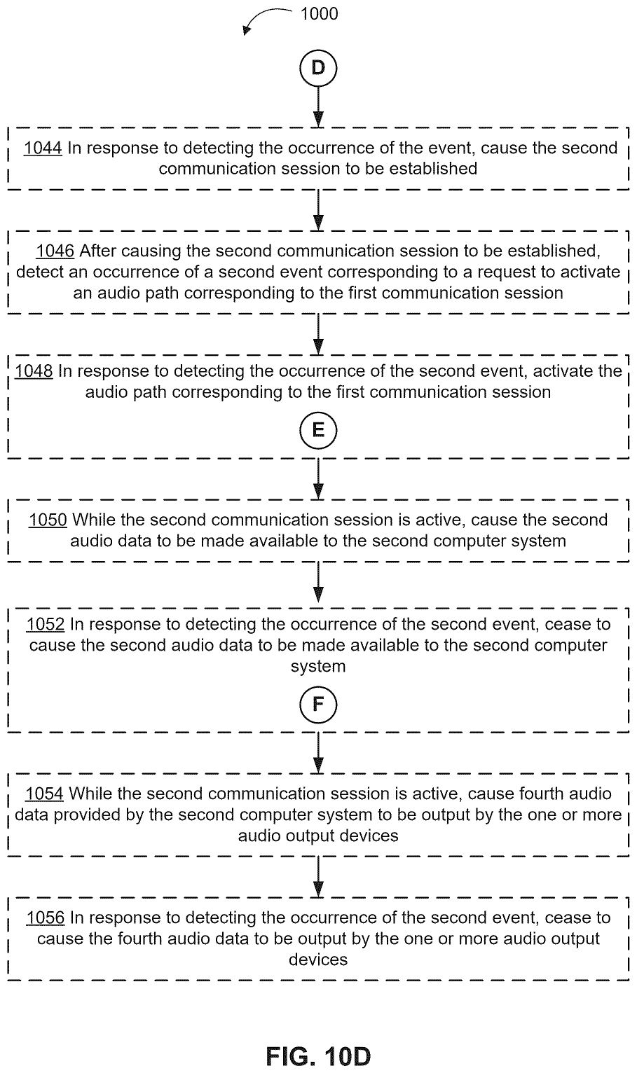

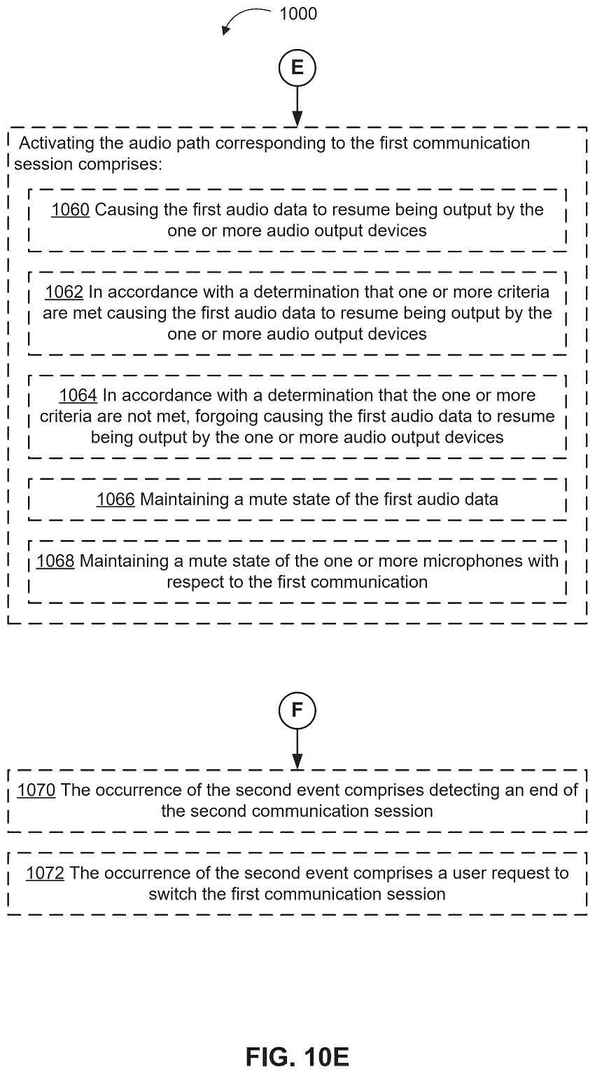

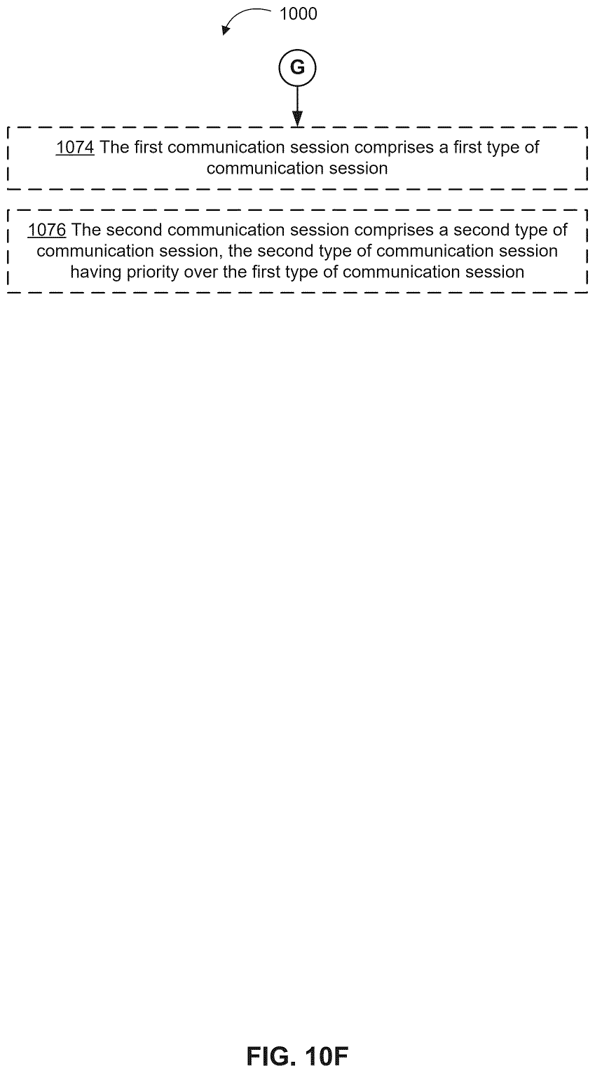

Below, FIGS. 1A-1B, 2, 3A, 3H-3J, and 4A-4B provide a description of example devices. FIGS. 3B-3G describe the use of Application Programming Interfaces (APIs) to perform operations. FIGS. 5A-5AB illustrate example user interfaces for controlling volume and noise levels, FIGS. 6A-6Y illustrate example user interactions and user interfaces for controlling volume and noise management functions, and FIGS. 7A-7L illustrate example user interactions and user interfaces for controlling audio routing. FIGS. 8A-8D are flow diagrams of an example process for controlling active noise management, FIGS. 9A-9I are flow diagrams of an example process for adjusting volume and/or active noise management, and FIGS. 10A-10F are flow diagrams of an example process for adjusting output of audio data. The user interfaces in FIGS. 5A-5AB, FIGS. 6A-6Y, and 7A-7L are used to illustrate the processes in FIGS. 8A-8D, 9A-9I, and 10A-10F.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 307 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

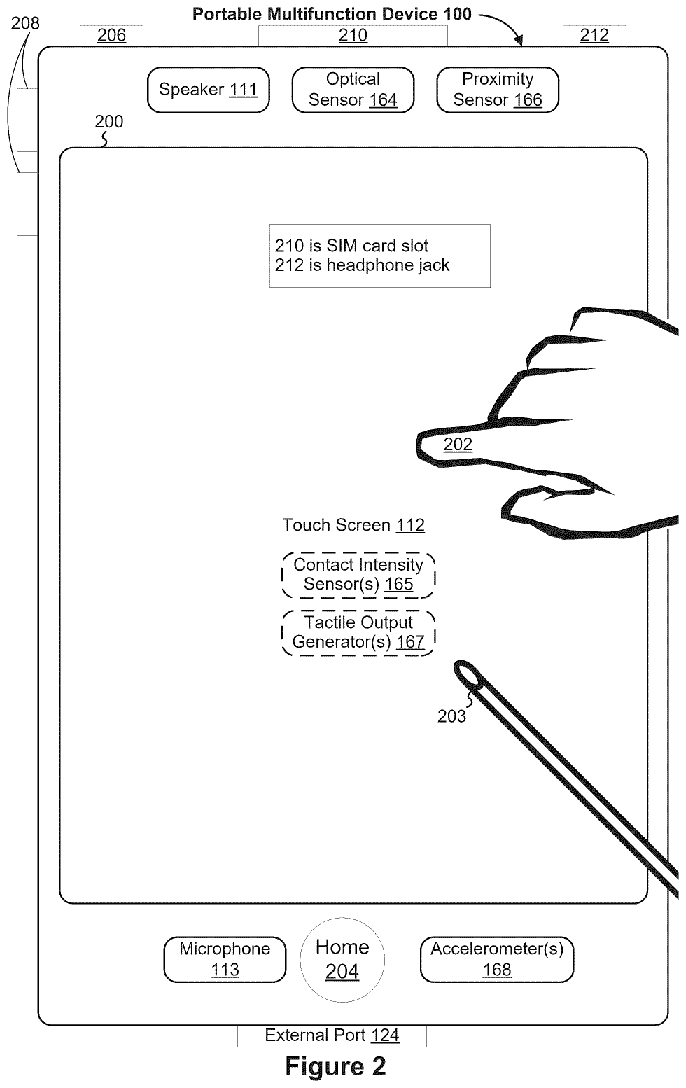

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conference module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 313), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, video conference module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 313 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher-level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event-to-event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 302, one or more network or other communications interfaces 312, memory 313, and one or more communication buses 303 for interconnecting these components. Communication buses 303 optionally include circuitry (sometimes called a chipset) that interconnects and controls communications between system components. Device 300 includes input/output (I/O) interface 304 comprising display 305, which is typically a touch-screen display. I/O interface 304 also optionally includes a keyboard and/or mouse (or other pointing device) 306 and touchpad 307, tactile output generator 308 for generating tactile outputs on device 300 (e.g., similar to tactile output generator(s) 167 described above with reference to FIG. 1A), sensors 309 (e.g., optical, acceleration, proximity, touch-sensitive, and/or contact intensity sensors similar to contact intensity sensor(s) 165 described above with reference to FIG. 1A), audio I/O logic 310, and/or wireless interface 311.

Memory 313 includes high-speed random-access memory, such as DRAM, SRAM, DDR RAM or other random-access solid-state memory devices; and optionally includes non-volatile memory, such as one or more magnetic disk storage devices, optical disk storage devices, flash memory devices, or other non-volatile solid state storage devices. Memory 313 optionally includes one or more storage devices remotely located from CPU(s) 302. In some embodiments, memory 313 stores programs, modules, and data structures analogous to the programs, modules, and data structures stored in memory 102 of portable multifunction device 100 (FIG. 1A), or a subset thereof. Furthermore, memory 313 optionally stores additional programs, modules, and data structures not present in memory 102 of portable multifunction device 100. For example, memory 313 of device 300 optionally stores drawing module 314, presentation module 315, word processing module 316, website creation module 317, disk authoring module 318, and/or spreadsheet module 319, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 313 optionally stores a subset of the modules and data structures identified above. Furthermore, memory 313 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIGS. 8A-8D), method 900 (FIGS. 9A-9I), and/or method 1000 (FIGS. 10A-10F) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 3H illustrates physical features of an example wearable audio output device 301 in accordance with some embodiments. In some embodiments, the wearable audio output device 301 is one or more in-ear earphone(s), earbud(s), over-ear headphone(s), or the like. In the example of FIG. 3H, wearable audio output device 301 is an earbud. In some embodiments, wearable audio output device 301 includes a head portion 323 and a stem portion 325. In some embodiments, head portion 323 is configured to be inserted into a user's ear. In some embodiments, stem portion 325 physically extends from head portion 323 (e.g., is an elongated portion extending from head portion 323). For example, head portion 323 physically extends downward, in front of, and/or past a user's earlobe while head portion 323 is inserted into a user's ear.

In some embodiments, wearable audio output device 301 includes one or more audio speakers 326 (e.g., in head portion 323) for providing audio output (e.g., to a user's ear). In some embodiments, wearable audio output device 301 includes one or more placement sensors 324 (e.g., placement sensors 324-1 and 324-2 in head portion 323) to detect positioning or placement of wearable audio output device 301 relative to a user's ear, such as to detect placement of wearable audio output device 301 in a user's ear.

In some embodiments, wearable audio output device 301 includes one or more microphones 322 for receiving audio input. In some embodiments, one or more microphones 322 are included in head portion 323 (e.g., microphone 322-1). In some embodiments, one or more microphones 322 are included in stem portion 325 (e.g., microphone 322-2). In some embodiments, microphone(s) 322 detect speech from a user wearing wearable audio output device 301 and/or ambient noise around wearable audio output device 301. In some embodiments, multiple microphones of microphones 322 are positioned at different locations on wearable audio output device 301 to measure speech and/or ambient noise at different locations around wearable audio output device 301.

In some embodiments, wearable audio output device 301 includes one or more input devices 328 (e.g., in stem portion 325). In some embodiments, input device(s) 328 includes a pressure-sensitive (e.g., intensity-sensitive) input device. In some embodiments, the pressure-sensitive input device detects inputs from a user in response to the user squeezing the input device (e.g., by pinching stem portion 325 of wearable audio output device 301 between two fingers). In some embodiments, input device(s) 328 include a touch-sensitive surface (e.g., a capacitive sensor) for detecting touch inputs, accelerometer(s), and/or attitude sensor(s) (e.g., for determining an attitude of wearable audio output device 301 relative to a physical environment and/or changes in attitude of the device), and/or other input device by which a user can interact with and provide inputs to wearable audio output device 301. In some embodiments, input device(s) 328 include one or more capacitive sensors, one or more force sensors, one or more motion sensors, and/or one or more orientation sensors. FIG. 3H shows input device(s) 328 at a location in stem portion 325, however in some embodiments one or more of input device(s) 328 are located at other positions within wearable audio output device 301 (e.g., other positions within stem portion 325 and/or head portion 323). In some embodiments, wearable audio output device 301 includes a housing with one or more physically distinguished portions 327 at locations that correspond to input device(s) 328 (e.g., to assist a user in locating and/or interacting with input device(s) 328). In some embodiments, physically distinguished portion(s) 327 include indent(s), raised portion(s), and/or portions with different textures. In some embodiments, physically distinguished portion(s) 327 include a single distinguished portion that spans multiple input devices 328. For example, input devices 328 include a set of touch sensors configured to detect swipe gestures and a single distinguished portion (e.g., a depression or groove) spans the set of touch sensors. In some embodiments, physically distinguished portion(s) 327 include a respective distinguished portion for each input device of input device(s) 328.

In some embodiments, wearable audio output device 301 includes one or more sensors 331 (e.g., sensors 331-1 and 331-2 in stem portion 325). In some embodiments, the one or more sensors 331 include one or more movement sensors (e.g., accelerometers, IMUs, and/or other types of movement sensors). In some embodiments, the one or more sensors 331 include one or more image sensors or cameras. In some embodiments, the sensor(s) 331 include a sensor (e.g., the sensor 331-1) that faces forward while the wearable audio output device 301 is being worn by a user. In some embodiments, the sensor(s) 331 include a sensor (e.g., the sensor 331-2) that faces backwards while the wearable audio output device 301 is being worn by a user. In some embodiments, the sensor(s) 331 consist of one sensor (e.g., with a field of view that is substantially the same as the wearer of the wearable audio output device 301). In some embodiments, the sensor(s) 331 include three or more sensors (e.g., each with a different field of view). In some embodiments, one or more of the sensor(s) 331 are arranged at different positions than shown in FIG. 3H. For example, one of the sensor(s) 331 may be arranged on the head portion 323. As another example, one of the sensor(s) 331 may be arranged near the middle or top of the stem portion 325.

FIG. 3I is a block diagram of an example wearable audio output device 301 in accordance with some embodiments. In some embodiments, wearable audio output device 301 is one or more in-ear earphone(s), earbud(s), over-ear headphone(s), or the like. In some examples, wearable audio output device 301 includes a pair of earphones or earbuds (e.g., one for each of a user's ears). In some examples, wearable audio output device 301 includes over-ear headphones (e.g., headphones with two over-ear earcups to be placed over a user's ears and optionally connected by a headband). In some embodiments, wearable audio output device 301 includes one or more audio speakers 326 for providing audio output (e.g., to a user's ear). In some embodiments, wearable audio output device 301 includes one or more placement sensors 324 to detect positioning or placement of wearable audio output device 301 relative to a user's ear, such as to detect placement of wearable audio output device 301 in a user's ear. In some embodiments, wearable audio output device 301 conditionally outputs audio based on whether wearable audio output device 301 is in or near a user's ear (e.g., wearable audio output device 301 forgoes outputting audio when not in a user's ear, to reduce power usage). In some embodiments where wearable audio output device 301 includes multiple (e.g., a pair) of wearable audio output components (e.g., earphones, earbuds, or earcups), each component includes one or more respective placement sensors, and wearable audio output device 301 conditionally outputs audio based on whether one or both components is in or near a user's ear, as described herein. In some embodiments, wearable audio output device 301 furthermore includes an internal rechargeable battery 329 for providing power to the various components of wearable audio output device 301.

In some embodiments, wearable audio output device 301 includes audio I/O logic 332, which determines the positioning or placement of wearable audio output device 301 relative to a user's ear based on information received from placement sensor(s) 324, and, in some embodiments, audio I/O logic 332 controls the resulting conditional outputting of audio. In some embodiments, wearable audio output device 301 includes an interface 335, e.g., a wireless interface, for communication with one or more multifunction devices, such as device 100 (e.g., as shown in FIG. 1A) or device 300 (e.g., as shown in FIG. 3A). In some embodiments, interface 335 includes a wired interface for connection with a multifunction device, such as device 100 (e.g., as shown in FIG. 1A) or device 300 (e.g., as shown in FIG. 3A) (e.g., via a headphone jack or other audio port). In some embodiments, a user can interact with and provide inputs (e.g., remotely) to wearable audio output device 301 via interface 335. In some embodiments, wearable audio output device 301 is in communication with multiple devices (e.g., multiple multifunction devices, and/or an audio output device case), and audio I/O logic 332 determines, which of the multifunction devices from which to accept instructions for outputting audio.

In some embodiments, wearable audio output device 301 includes one or more microphones 322 for receiving audio input. In some embodiments where wearable audio output device 301 includes multiple (e.g., a pair) of wearable audio output components (e.g., earphones or earbuds), each component includes one or more respective microphones. In some embodiments, audio I/O logic 332 detects or recognizes speech or ambient noise based on information received from microphone(s) 322.

In some embodiments, wearable audio output device 301 includes one or more input devices 328. In some embodiments where wearable audio output device 301 includes multiple (e.g., a pair) of wearable audio output components (e.g., earphones, earbuds, or earcups), each component includes one or more respective input devices. In some embodiments, input device(s) 328 include one or more volume control hardware elements (e.g., an up/down button for volume control, or an up button and a separate down button, as described herein with reference to FIG. 1A) for volume control (e.g., locally) of wearable audio output device 301. In some embodiments, inputs provided via input device(s) 328 are processed by audio I/O logic 332. In some embodiments, audio I/O logic 332 is in communication with a separate device (e.g., device 100, FIG. 1A, or device 300, FIG. 3A) that provides instructions or content for audio output, and that optionally receives, and processes inputs (or information about inputs) provided via microphone(s) 322, placement sensor(s) 324, and/or input device(s) 328, or via one or more input devices of the separate device. In some embodiments, audio I/O logic 332 is located in device 100 (e.g., as part of peripherals interface 118, FIG. 1A) or device 300 (e.g., as part of I/O interface 304, FIG. 3A), instead of device 301, or alternatively is located in part in device 100 and in part in device 301, or in part in device 300 and in part in device 301.

FIG. 3J illustrates example audio control by a wearable audio output device 301 in accordance with some embodiments. While the following example is explained with respect to implementations that include a wearable audio output device having earbuds to which interchangeable eartips (sometimes called silicon eartips or silicon seals) are attached, the methods, devices and user interfaces described herein are equally applicable to implementations in which the wearable audio output devices do not have eartips, and instead each have a portion of the main body shaped for insertion in the user's ears. In some embodiments in which a wearable audio output device has earbuds to which interchangeable eartips may be attached are worn in a user's ears, the earbuds and eartips together act as physical barriers that block at least some ambient sound from the surrounding physical environment from reaching the user's ear. For example, in FIG. 3L, wearable audio output device 301 is worn by a user such that head portion 323 and eartip 334 are in the user's left ear. Eartip 334 extends at least partially into the user's ear canal. Preferably, when head portion 323 and eartip 334 are inserted into the user's ear, a seal is formed between eartip 334 and the user's ear so as to isolate the user's ear canal from the surrounding physical environment. However, in some circumstances, head portion 323 and eartip 334 together block some, but not necessarily all, of the ambient sound in the surrounding physical environment from reaching the user's ear. Accordingly, in some embodiments, a first microphone (or, in some embodiments, a first set of one or more microphones) 322-1 (and optionally a third microphone 322-3) is located on wearable audio output device 301 so as to detect ambient sound, represented by waveform 380, in region 336 of a physical environment surrounding (e.g., outside of) head portion 323. In some embodiments, a second microphone (or, in some embodiments, a second set of one or more microphones) 322-2 (e.g., of microphones 322, FIG. 3I) is located on wearable audio output device 301 so as to detect any ambient sound, represented by waveform 382, that is not completely blocked by head portion 323 and eartip 334 and that can be heard in region 338 inside the user's ear canal. Accordingly, in some circumstances in which wearable audio output device 301 is not producing a noise-cancelling (also called “antiphase”) audio signal to cancel (e.g., attenuate) ambient sound from the surrounding physical environment, as indicated by waveform 384-1, ambient sound waveform 382 is perceivable by the user, as indicated by waveform 386-1. In some circumstances in which wearable audio output device 301 is producing an antiphase audio signal to cancel ambient sound, as indicated by waveform 384-2, ambient sound waveform 382 is not perceivable by the user, as indicated by waveform 386-2.

In some embodiments, ambient sound waveform 380 is compared to attenuated ambient sound waveform 382 (e.g., by wearable audio output device 301 or a component of wearable audio output device 301, such as audio I/O logic 332, or by an electronic device that is in communication with wearable audio output device 301) to determine the passive attenuation provided by wearable audio output device 301. In some embodiments, the amount of passive attenuation provided by wearable audio output device 301 is taken into account when providing the antiphase audio signal to cancel ambient sound from the surrounding physical environment. For example, antiphase audio signal waveform 384-2 is configured to cancel attenuated ambient sound waveform 382 rather than unattenuated ambient sound waveform 380.

In some embodiments, wearable audio output device 301 is configured to operate in one of a plurality of available audio output modes, such as an active noise control audio output mode, an active pass-through audio output mode, and a bypass audio output mode (also sometimes called a noise control off audio output mode). In the active noise control mode (also called “ANC”), wearable audio output device 301 outputs one or more audio-cancelling audio components (e.g., one or more antiphase audio signals, also called “audio-cancelation audio components”) to at least partially cancel ambient sound from the surrounding physical environment that would otherwise be perceivable to the user. In the active pass-through audio output mode, wearable audio output device 301 outputs one or more pass-through audio components (e.g., plays at least a portion of the ambient sound from outside the user's ear, received by microphone 322-1, for example) so that the user can hear a greater amount of ambient sound from the surrounding physical environment than would otherwise be perceivable to the user (e.g., a greater amount of ambient sound than would be audible with the passive attenuation of wearable audio output device 301 placed in the user's ear). In the bypass mode, active noise management is turned off, such that wearable audio output device 301 outputs neither any audio-cancelling audio components nor any pass-through audio components (e.g., such that any amount of ambient sound that the user perceives is due to physical attenuation by wearable audio output device 301).

Attention is now directed towards embodiments of user interfaces (“UI”) that are, optionally, implemented on portable multifunction device 100.

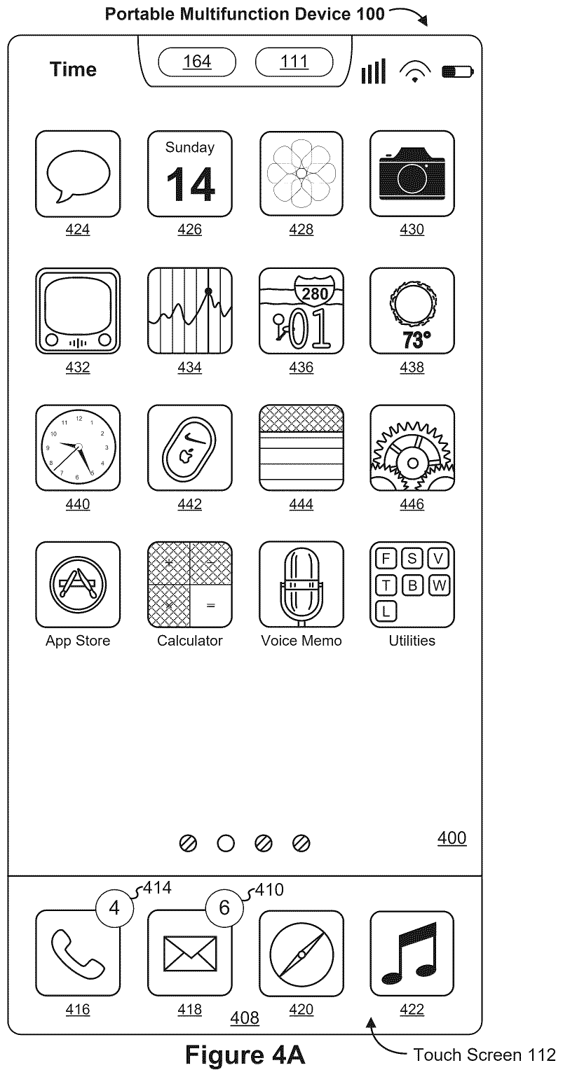

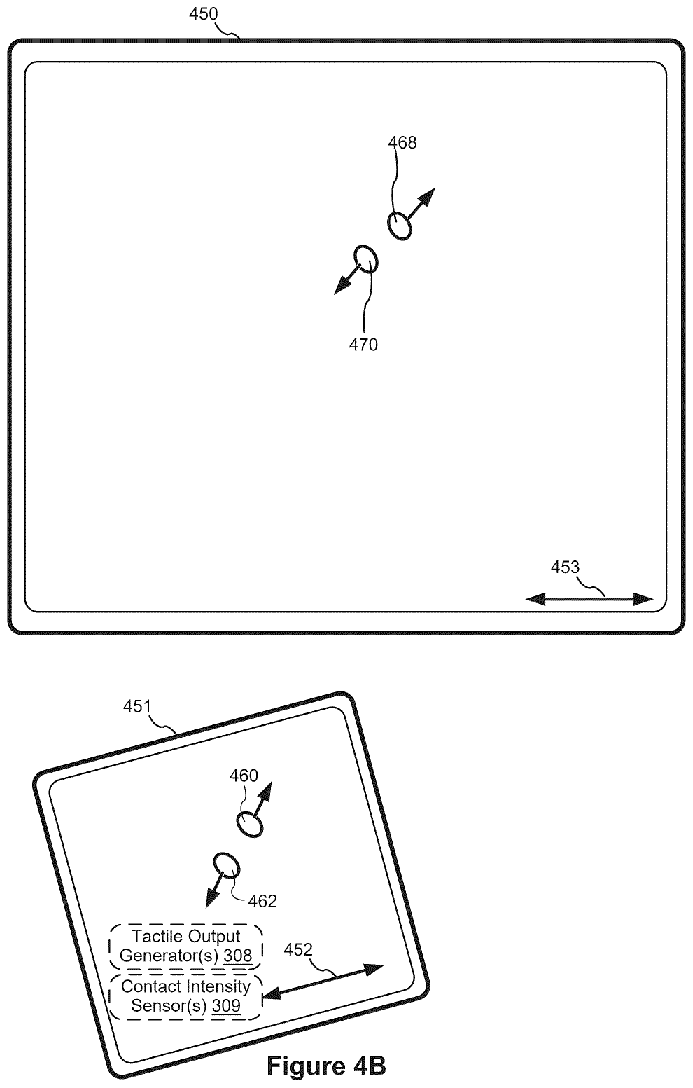

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 307, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5AB illustrate example user interfaces for controlling volume and noise levels, FIGS. 6A-6Y illustrate example user interactions and user interfaces for controlling volume and noise management functions, and FIGS. 7A-7L illustrate example user interactions and user interfaces for controlling audio routing. The user interfaces in FIGS. 5A-5AB, FIGS. 6A-6Y, and 7A-7L are used to illustrate the processes in FIGS. 8A-8D, 9A-9I, and 10A-10F. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIGS. 5A-5AB illustrate example user interfaces for controlling volume and noise levels in accordance with some embodiments. FIG. 5A illustrates a computer system 502 (e.g., an instance of portable multifunction device 100, FIG. 1A) displaying, via a touch-sensitive display 504 (e.g., one or more output generation components, one or more display generation components, and/or one or more touch-sensitive surfaces) a control user interface 506. For example, in FIG. 5A, the control user interface 506 is overlaid on top of a home-screen user interface 507 (e.g., the user interface shown in FIG. 4A) while the computer system 502 is in an unlocked state. In some embodiments, the control user interface 506 is overlaid on top of a lock-screen user interface (e.g., the lock-screen user interface as described in more detail in at least FIGS. 5N-5P) and is, optionally, accessible while the computer system 502 is in a locked and/or unlocked state.

A home-screen user interface (also sometimes referred to as a “home screen”) includes icons for navigating to a plurality of applications that are executed by the computer system. In some embodiments, the home screen user interface is displayed as a default user interface in response to the user powering on, logging into, and/or activating the computer system. In some embodiments, the computer system detects and responds to interaction with the home-screen user interface using one or more gestures, including touch inputs. For example, a tap input or other selection input on or directed to a respective application icon causes the respective application to launch, or otherwise open a user interface for the respective application, on a display. In some embodiments, a plurality of views for the home screen user interface is available. For example, the device detects and responds to user inputs such as swipe gestures or other inputs (e.g., inputs directed to the currently displayed view of the home-screen user interface) that correspond to requests to navigate between the plurality of views, where each view of the home-screen user interface includes different application icons for different applications.

In some embodiments, the control user interface 506 includes one or more control elements 508 configured to cause the computer system 502, the one or more wearable audio output devices, and/or other devices connected to the computer system 502 to perform one or more actions in response to one or more inputs detected at the computer system 502, e.g., via the touch-sensitive display and/or other input devices. For example, as shown in FIG. 5A, the one or more control elements are, optionally, for one or more system properties (e.g., one or more of audio properties, display properties, privacy properties, connectivity properties, and media playback properties) and/or cause the computer system 502 to launch one or more respective applications installed on the computer system 502 (e.g., timer application, calculator application, camera application, and/or other applications installed on the computer system 502) in response to an input directed at a respective control element of the one or more control elements.

In some embodiments, the computer system 502 is paired with one or more wearable audio output devices (e.g., earbuds, a headset, and/or other type of wearable audio output device). In some embodiments, the one or more control elements 508 include a control element 512 (e.g., a first volume slider) for adjusting the volume of audio output at the one or more wearable audio output devices and includes an indication 513 of the volume of the audio output at the one or more wearable audio output devices that ranges from 0% to 100% continuously (e.g., without segmentation). For example, adjustment of the volume of the audio output at the one or more wearable audio output devices via the control element 512 is continuous such that any volume between 0% to 100% is selectable at any integer value, e.g., without being limited to multiple integer steps (e.g., such as steps of 5, 10, or other multiple integer step size).

In some embodiments, the computer system 502 detects, via the touch-sensitive display 504, an input 510 (e.g., a downward swipe input) directed to the control element 512. In response to the input 510, the computer system 502 causes the volume of the audio output at the one or more wearable audio output devices to decrease (e.g., the audio output volume decreases and the audio output becomes quieter in response to input 510). In some embodiments, the computer system 502 detects, via the touch-sensitive display 504, an input 514 (e.g., an upward swipe input) directed to the control element 512.

FIG. 5B is a transition from FIG. 5A in response to the input 514. In response to the input 514, the computer system 502 causes the volume of the audio output at the one or more wearable audio output devices to increase (e.g., the audio output volume increases and the audio output becomes louder in response to input 514). FIG. 5B illustrates the computer system 502 displaying, via the touch-sensitive display 504 at the control element 512, an updated indication 515 of the increased volume of the audio output at the one or more wearable audio output devices in response to the input 514. In some embodiments, the computer system 502 detects, via the touch-sensitive display 504, an input 516 (e.g., a tap input).

FIG. 5C is a transition from FIG. 5B in response to the input 516. In response to input 516, the computer system 502 displays, via the touch-sensitive display 504, user interface 518 for adjusting one or more settings associated with the one or more wearable audio output devices. FIG. 5C illustrates the user interface 518, for adjusting the one or more settings associated with the one or more wearable audio output devices, including a control element 520 for adjusting the volume of the audio output at the one or more wearable audio output devices and a control element 522 for adjusting a magnitude of an active noise management function, and optionally, a control element 524 for adjusting a mode of the active noise management function (e.g., a noise cancellation mode, an adaptive mode, a transparency mode, an “off” mode, or other modes of the active noise management function), a control element 525 for adjusting a mode of a speech detection function, and/or a control element 526 for adjusting a mode of a spatial audio function. As shown in FIG. 5C, each of the control elements 524, 525, and 526 include display of an indication of the active mode (if any) for the respective function. For example, the control element 524 includes display of an indication that the mode of the noise management function is the transparency mode, the control element 525 includes display of an indication that the speech detection function is disabled, and the control element 526 includes display of an indication that the mode of the spatial audio function is a head tracking mode.

In some embodiments, the control element 520 includes the same functionality as control element 512 (as described with respect to FIGS. 5A-5B), such as the computer system 502 causing the volume of the audio output at the one or more wearable audio output devices to increase and/or decrease in response to input(s) directed to the control elements 512 and/or 520. Additionally, the control element 520 also includes an indication of the volume of the audio output at the one or more wearable audio output devices without segmentation.

In one example, the computer system 502 detects, via the touch-sensitive display 504, an input 528 (e.g., an upward swipe) directed to the control element 520 to increase the volume of the audio output at the one or more wearable audio output devices. In another example, the computer system 502 detects, via the touch-sensitive display 504, an input 521 (e.g., a downward swipe) directed to the control element 520 to decrease the volume of the audio output at the one or more wearable audio output devices.

In some embodiments, in response to an input directed at the control element 522 (for adjusting the magnitude of the active noise management function) and detected via the touch-sensitive display 504 of the computer system 502, the computer system 502 adjusts the magnitude (e.g., volume) of ambient sounds heard by the user wearing the one or more wearable audio output devices. In some embodiments, the control element 522 includes display of an indication 531 of the magnitude of the active noise management function.

In some embodiments, the control element 522 for adjusting the magnitude of the active noise management function is segmented. For example, each segment of the control element 522 corresponds with a predefined setting, such as magnitude, of the active noise management function, and adjustments to the setting, such as magnitude, of the active noise management function is limited to the predefined settings, (e.g., magnitudes). As shown in FIG. 5C, segment 530 of the control element 522 corresponds to (e.g., represents) a default magnitude of the active noise management function (e.g., a zero-decibel change from the default setting of the active noise management function), segment 532 of the control element 522 corresponds to a first increased magnitude (e.g., a plus-two decibel change from the default magnitude), segment 534 of the control element 522 corresponds to a second increased magnitude of the active noise management function (e.g., a plus-four decibel change), and segment 536 of the control element 522 corresponds a third increased magnitude of the active noise management function (e.g., a plus-six decibel change). Additionally, continuing with the example, segment 538 corresponds to a first decreased magnitude of the active noise management function (e.g., a minus-two decibel change), segment 540 corresponds to a second decreased magnitude of the active noise management function (e.g., a minus-four decibel change), and segment 542 corresponds to a third decreased magnitude of the active noise management function (e.g., a minus-six decibel change).

In some embodiments, in response to adjustment of the magnitude of the active noise management function from one magnitude to another magnitude (e.g., from one segment to another segment), the computer system 502 outputs haptic feedback 544 (e.g., one or more vibrations) via one or more haptic output devices of the computer system 502. For example, each time the magnitude of the active noise management function is increased or decreased to the next predefined magnitude, the computer system 502 outputs haptic feedback 544. In this example, the computer system 502 outputs first haptic feedback in response to an input (e.g., detected via the touch-sensitive display 504 of the computer system 502) to increase the magnitude of the active noise management function from the segment 530 to the segment 532, and outputs a second haptic feedback in response to a continuation of the input to increase the magnitude of the active noise management function from the segment 532 to the segment 534. In some embodiments, the first haptic feedback and the second haptic feedback are the same, while in some other embodiments they are different (e.g., different haptic feedback pattern, different duration of haptic feedback, different intensity of the haptic feedback, or other differences between the first haptic feedback and the second haptic feedback). In some embodiments, the intensity and/or the number of times that haptic feedback is output by the computer system 502 is based on the amount of the adjustment to the magnitude of the active noise management function, e.g., an amount corresponding to the number of segments traversed by the input when adjusting the magnitude of the active noise management function.

In some embodiments, the computer system 502 detects, via the touch-sensitive display 504, an input 546 (e.g., a downward swipe) directed to the control element 522 to decrease the magnitude of the active noise management function. In some embodiments, in response to the input 546, the computer system 502 decreases the magnitude of the active noise management function and outputs haptic feedback (e.g., the computer system 502 outputs three sets of haptic feedback corresponding to the magnitude of the active noise management function being adjusted from segment 530 to segment 542). Additionally, the computer system 502 displays an indication of the decreased magnitude of the active noise management function at the control element 522. In some embodiments, the computer system 502 detects, via the touch-sensitive display 504, an input 548 (e.g., an upward swipe) directed to the control element 522 to increase the magnitude of the active noise management function. FIG. 5D is a transition from FIG. 5C in response to the input 548. In response to the input 548, the computer system 502 increases the magnitude of the active noise management function and outputs haptic feedback based on the increase of the magnitude of the active noise management function.

FIG. 5D illustrates the computer system 502 displaying, via the touch-sensitive display 504, in response to the input 548, an indication 549 of the increased magnitude (e.g., segment 534) of the active noise management function at the control element 522. In some embodiments, the computer system 502 detects, via the touch-sensitive display 504, an input 550 (e.g., a tap input) directed to the control element 525 for adjusting the mode of the speech detection function. In some embodiments, in response to the input 550 the computer system 502 displays a user interface for adjusting the mode of the speech detection function. For example, the user interface for adjusting the mode of the speech detection function includes one or more control elements for enabling and/or disabling the speech detection function.

In some embodiments, the computer system 502 detects, e.g., via the touch-sensitive display 504, an input 552 (e.g., a tap input) directed to the control element 526 for adjusting the mode of the spatial audio function. In response to the input 552, the computer system 502 displays a user interface for adjusting the mode of the spatial audio function. For example, the user interface for adjusting the mode of spatial audio function includes one or more control elements (e.g., displayed affordances or icons) that, when selected, enable or disable or toggle a state the spatial audio function. Additionally, the user interface for adjusting the mode of the spatial audio function includes a control element for enabling the spatial audio function with head tracking (e.g., the spatial audio moves based on movement of the one or more wearable audio output devices).

In some embodiments, the computer system 502 detects, via the touch-sensitive display 504, an input 554 (e.g., a tap input) directed to the control element 524 for adjusting the mode of the active noise management function. FIG. 5E is a transition from FIG. 5D in response to the input 554. In response to the input 554, the computer system 502 displays a user interface 556 for adjusting the mode of the active noise management function, an example of which is shown in FIG. 5E.

FIG. 5E illustrates the computer system 502 displaying, via the touch-sensitive display 504 and in response to the input 554, the user interface 556 including one or more control elements corresponding to one or more modes of the active noise management function. In some embodiments, the one or more control elements includes a control element 558 for enabling a noise cancellation mode of the active noise management function, a control element 560 for enabling a transparency mode of the active noise management function, and/or a control element 562 for enabling an adaptive mode of the noise management function. For example, in response to an input detected by the touch-sensitive display 504 of the computer system 502 and directed to the control element 558 for enabling the noise cancellation mode, the noise cancellation mode is enabled, and ambient sounds are attenuated by the one or more wearable audio output devices.

In some embodiments, the user interface 556 for adjusting the mode of the active noise management function, optionally includes both the control element 520 for adjusting the volume of the one or more wearable audio output devices and the control element 522 for adjusting a setting, e.g., a magnitude, of an active noise management function. Functionalities of the control element 520 and the control element 522 as described with respect to at least FIGS. 5C and 5D are similarly applicable to the same control elements 520 and 522 as described with respect to FIG. 5E.

In an example, the computer system 502 detects, via the touch-sensitive display 504, an input 564 directed to the control element 562 for enabling the adaptive mode of the noise management function. In some embodiments, in accordance with a determination that the adaptive mode of the noise management is enabled, the computer system 502 automatically switches between the noise cancellation mode and the transparency mode of the noise management function based on context (e.g., based on the volume of ambient sounds, an active application executing on the computer system 502, a location of the user based on the location of the computer system 502, and/or other contexts or criteria). FIG. 5F is a transition from FIG. 5E in response to the input 564. As shown in FIG. 5F, in response to the input 564, the computer system 502 enables the adaptive mode for the one or more wearable audio output devices and the computer system 502 displays the user interface 518 for adjusting one or more settings associated with the one or more wearable audio output devices. Furthermore, in response to the input 564, control element 524 of user interface 518 has been updated to display an indication that the currently active mode of the noise management function is the adaptive mode.

FIG. 5G illustrates a user interface 566 (e.g., a settings user interface) for adjusting one or more settings associated with the one or more wearable audio output devices. In some embodiments, the user interface 566 includes more information and/or settings than the information and/or settings available in the user interface 518 (as described above with respect to at least FIGS. 5C-5F).

In some embodiments, the user interface 566 for adjusting one or more settings associated with the one or more wearable audio output devices includes an indication 568 of the current battery level for the one or more wearable audio output devices and an indication 570 of the current battery level for a case for the one or more wearable audio output devices.

In some embodiments, the user interface 566 for adjusting one or more settings associated with the one or more wearable audio output devices includes the one or more control elements corresponding to one or more respective modes of the active noise management function (e.g., control element 558 for enabling the noise cancellation mode, control element 560 for enabling the transparency mode, and/or control element 562 for enabling the adaptive mode of the noise management function). Functionalities of the control element 558, the control element 560, and the control element 562 as described with respect to at least FIG. 5E are similarly applicable to the same control elements 558, 560, and 562 as described with respect to FIG. 5G.

As shown in FIG. 5G, the computer system 502 displays the control element 560, in the user interface 566, with an indication that the transparency mode of the active noise management function is enabled (e.g., an indication that the transparency mode is the active mode). In some embodiments, the transparency mode is a mode in which the one or more wearable audio output devices capture and playback ambient sounds to the user (e.g., such that the user hears the ambient sounds at a volume similar (e.g., with a predefined margin, such as ten percent or twenty percent) to the volume at which the user would hear the ambient sounds if the user was not wearing the one or more wearable audio output devices). In some embodiments, in response to an input selecting a control element to enable a different mode of the active noise management function (e.g., the noise cancellation mode, the adaptive mode, or another mode of the active noise management function) the computer system 502 displays (e.g., updates) the control element associated with the enabled mode of the active noise management function with an indication that the respective mode is enabled.

In some embodiments, the one or more settings, displayed in the user interface 566, include a control element 572 for enabling an “off” mode of the active noise management function. The “off” mode is described in more detail below with respect to at least FIGS. 5I and 5J.

In some embodiments, the computer system 502 is configured with a loud-noise-reduction mode enabled such that the one or more wearable audio output devices attenuate ambient sounds above a threshold volume (e.g., 70 decibels, 75 decibels, 80 decibels, 90 decibels, 100 decibels, etc.). For example, the one or more wearable audio output devices attenuate ambient sounds (e.g., train horns, loud concerts, or other ambient sounds) above the threshold volume. In some embodiments, the ambient sounds attenuated by the loud-noise-reduction mode are, optionally, attenuated the same as, or alternatively differently from, the attenuation that would be performed on those ambient sounds by the noise cancellation mode (e.g., the loud-noise-reduction mode performs the attenuation only when loud noise is detected, and/or only attenuates the loud noise, without attenuating other ambient sounds, or attenuates the loud noise and applies less attenuation to other ambient sounds than would be applied by the noise cancelation mode). For example, the computer system 502 attenuates live music during a concert such that the user still hears the live music, but at a lower volume. In some embodiments, the computer system 502 is, optionally, configured with the loud-noise-reduction mode enabled by default, and optionally, enabled concurrently with other modes of the active noise management function (e.g., the transparency mode and/or the adaptive mode).

In some embodiments, the one or more settings, displayed in the user interface 566, include a control element 574 for disabling the loud-noise-reduction mode. For example, in response to an input detected by the touch-sensitive display 504 of the computer system 502 and directed to the control element 574, the loud-noise-reduction mode is disabled. For example, when the loud-noise-reduction mode is disabled, the computer system 502 and/or the one or more wearable audio output devices do not attenuate ambient sounds above the threshold volume. In some embodiments, the control element 574 for disabling the loud-noise-reduction mode is, optionally, accessed via a user interface for accessibility settings.

In some embodiments, in response to disabling the loud-noise-reduction mode, the computer system 502 displays, via the touch-sensitive display 504, a warning including information that when the loud-noise-reduction mode is disabled, the one or more wearable audio output devices will not attenuate loud ambient sounds.

In some embodiments, the one or more settings displayed in user interface 566 include settings for configuring the computer system 502 and/or the one or more wearable audio output devices to perform one or more actions, such as invoking a voice assistant and/or adjusting the mode of the active noise management function, in response to an input at the one or more wearable audio output devices. The settings for configuring the actions include a control element 576 for configuring actions associated with interactions with a first wearable audio output device (e.g., a left earbud) of the one or more wearable audio output devices and a control element 578 for configuring actions associated with interactions with a second wearable audio output device (e.g., a right earbud) of the one or more wearable audio output devices. In some embodiments, in accordance with settings made (e.g., by a user of the one or more wearable audio output devices) using control element 576 and control element 578, an input at the first wearable audio output device and an input (e.g., a similar input) at the second audio output device action cause the same action, or alternatively, different actions, to be performed by the computer system 502 and/or the one or more wearable audio output devices.

In some embodiments, the computer system 502 detects, via the touch-sensitive display 504, an input 580 (e.g., a tap input) directed at the control element 576 for configuring actions associated with interactions with the first wearable audio output device. In response to the input 580, the computer system 502 displays a user interface 582 for configuring actions that are performed in response to an input at the first wearable audio output device. In an example, in response to input 580, the computer system 502 transitions from displaying user interface 566, shown in FIG. 5G, to displaying a user interface 582, represented by FIG. 5H.

FIG. 5H illustrates the user interface 582 for configuration actions that are performed in response to an input at the first wearable audio output device. For example, the actions include causing the computer system 502 and/or the one or more wearable audio output devices to invoke the voice assistant, adjusting the mode of the active noise management function, and/or other actions. The user interface 582, as illustrated in FIG. 5H includes a control element 586 for configuring the action to include invoking the voice assistant and a control element 584 for configuring the action to include adjusting the mode of the active noise management function. In some embodiments, the user interface 582, optionally, includes a control element 588 for enabling a transparency mode, a control element 590 for enabling adaptive mode (e.g., an adaptive noise management mode), and/or a control element 592 for enabling a noise cancellation mode to be included in the set of selectable modes for the active noise management function that are invoked (e.g., in sequence) in response to an input (e.g., in response to successive inputs) at the first audio output device.

In some embodiments, the computer system 502 detects, e.g., via the touch-sensitive display 504, an input 594 (e.g., a tap input) directed to a back affordance 596 to return to a previous user interface (e.g., the user interface 566 for adjusting the one or more settings associated with the one or more wearable audio output devices). In response to the input 594 (e.g., while displaying user interface 582, as shown in FIG. 5H), the computer system 502 displays the user interface 566, shown in FIG. 5I, for adjusting the one or more settings associated with the one or more wearable audio output devices.

In some embodiments, as shown in FIG. 5I, the computer system 502 detects, via the touch-sensitive display 504, an input 579 (e.g., a tap input) directed to the control element 572 for enabling an “off” mode of the active noise management function. In response to the input 579, the computer system 502 displays, as shown in FIG. 5J, via the touch-sensitive display 504, a warning 598 regarding enabling the “off” mode of the active noise management function.

FIG. 5J illustrates the computer system 502 displaying, e.g., via the touch-sensitive display 504, the warning 598 overlaid on top of the user interface 566. In some embodiments, the warning 598 prompts the user to confirm enabling the “off” mode of the active noise management function. For example, as shown in FIG. 5J, the warning 598 includes information that when the active noise management function is set to the “off” mode, the one or more wearable audio output devices will not adjust any ambient sounds (e.g., alter, attenuate, amplify, or other adjustments to the ambient sounds) heard by the user while wearing the one or more wearable audio output devices.

In some embodiments, the computer system 502 detects, e.g., via the touch-sensitive display 504, an input 1502 (e.g., a tap input) to confirm enabling the “off” mode of the active noise management function. In response to the input 1502, received while the computer system 502 displays the warning 598, as shown in FIG. 5J, the computer system 502 displays, via the touch-sensitive display 504, the user interface 556, as shown in FIG. 5K.

FIG. 5K illustrates the user interface 556 for adjusting the mode of the active noise management function, including a control element 1504 for enabling the “off” mode of the active noise management function.

In some embodiments, the computer system 502 detects, e.g., via the touch-sensitive display 504, an input 1506 (e.g., a tap input) directed to the control element 558 to enable the noise cancellation mode of the active noise management function. In response to the input 1506, the computer system 502 enables the noise cancellation mode of the active noise management function at the computer system 502 and/or the one or more wearable audio output devices. For example, in response to the input 1506 enabling the noise cancellation mode, the one or more wearable audio output devices attenuate ambient sounds such that the user hears the ambient sounds at a lower volume than when the noise cancellation mode is not enabled.

In some embodiments, the computer system 502 detects, via the touch-sensitive display 504, an input 1508 (e.g., a tap input) directed to the control element 562 to enable the adaptive mode of the active noise management function. In response to the input 1508, the computer system 502 enables the adaptive mode of the active noise management function at the computer system 502 and/or the one or more wearable audio output devices. For example, in response to the input 1508 enabling the adaptive mode, the adaptive mode is enabled, and while the adaptive mode is enabled, the one or more wearable audio output devices alter the ambient sounds based on context such that the user hears the ambient sounds at a quieter volume for a first set of contexts and/or the user hears the ambient sounds at a louder volume for contexts other than the first set of contexts.

In some embodiments, the computer system 502 detects, via the touch-sensitive display 504, an input 1510 (e.g., a tap input) directed to the control element 560 to enable the transparency mode of the active noise management function. In response to the input 1510, the computer system 502 enables the transparency mode of the active noise management function at the computer system 502 and/or the one or more wearable audio output devices. For example, in response to the input 1510 enabling the transparency mode, the one or more wearable audio output devices capture and playback ambient sounds to the user (e.g., such that the user hears the ambient sounds at a volume similar (e.g., with a predefined margin, such as ten percent or twenty percent) to the volume at which the user would hear the ambient sounds if the user was not wearing the one or more wearable audio output devices).

In some embodiments, the computer system 502 detects, via the touch-sensitive display 504, an input 1512 (e.g., a tap input) directed to the control element 1504 to enable the “off” mode of the active noise management function. FIG. 5L represents an example of a user interface displayed in response to the input 1512, which is, in this example, received by the computer system 502 while displaying the user interface shown in FIG. 5K. In response to the input 1512, the computer system enables the “off” mode of the active noise management function at the computer system 502 and/or the one or more wearable audio output devices. For example, in response to the input 1512 enabling the “off” mode, the one or more wearable audio output devices and/or the computer system 502 cease to alter the ambient sounds that are received by the user while the user is wearing the one or more wearable audio output devices.

As shown in FIG. 5L, the computer system 502 displays the control element 1504 for enabling the “off” mode of the active noise management function with an indication that the “off” mode is enabled. For example, the control element 1504 that is enabled is visually distinct from the control elements 558, 560, and 562 that are not enabled. In this example, and as shown in FIG. 5L, the indication includes changing a background color of the control element 1504.

In some embodiments, the computer system 502 detects, via the touch-sensitive display 504, an input 1514 (e.g., a tap input) directed to the control element 578 for configuring actions associated with interactions with the second wearable audio output device. The actions and configurations for the second wearable audio output device are similar to the available actions and configurations for the first wearable audio output device, as described above with respect to at least FIG. 5H.

In some embodiments, the computer system 502 detects, via the touch-sensitive display 504, the input 1512 (e.g., a tap input) directed to the control element 576 for configuring actions associated with interactions with the first wearable audio output device. FIG. 5M is a transition from FIG. 5L in response to the input 1512. In response to the input 1512, the computer system 502 displays, via the touch-sensitive display 504, the user interface 582 for configuring actions that are performed in response to an input at the first wearable audio output device.

As illustrated in FIG. 5M, the user interface 582 for configuring actions that are performed in response to an input at the first wearable audio output device includes, in accordance with a determination that the “off” mode for the active noise management function is enabled, a control element 1518 for enabling the “off” mode to be included in the set of selectable modes for the active noise management function that are invoked (e.g., in sequence) in response to an input (e.g., in response to successive inputs) at the first audio output device.

In some embodiments, the computer system 502 detects, e.g., via the touch-sensitive display 504, an input 1530 directed at the control element 586. In response to the input 1530, the computer system 502 configures the first wearable audio output device to invoke the voice assistance function in response to input received at the first wearable audio output device. Additionally, when the first wearable audio output device is configured to invoke the voice assistance function in response to an input received at the first wearable audio output device, the control element 586 is displayed with an indication indicating that it is currently selected (e.g., that the voice assistance function is mapped to the tap-and-hold input type for the left earbud).

In some embodiments, the computer system 502 detects, e.g., via the touch-sensitive display 504, an input 1532 directed at the control element 584. In response to the input 1532, the computer system 502 configures the first wearable audio output device to change the mode of the active noise management function (e.g., cycle through a list of a plurality of selectable modes of the active noise management function). Additionally, when the first wearable audio output device is configured to change the mode of the active noise management function in response to an input received at the first wearable audio output device, the control element 584 is displayed with an indication 1533 indicating that it is currently selected (e.g., that the noise management function is mapped to the tap-and-hold input type for the left earbud).

In some embodiments, as shown in FIG. 5M, the user interface 582, in accordance with a determination that the control element 584 for configuring the action to include adjusting the mode of the active noise management function is selected (e.g., enabled), includes a control element 588 for enabling a transparency mode, a control element 590 for enabling adaptive mode, and/or a control element 592 for enabling a noise cancellation mode to be included in the list of selectable modes for the active noise management function in response to an input at the first audio output device. In addition, the user interface 582 optionally also includes a control element 1518 for enabling the “off” noise management mode. For example, as explained above with reference to FIGS. 5I and 5J, the “off” noise management mode control element 1518 is included if use of the “off” mode has been enabled by the user (e.g., using control element 572, FIG. 5I).

In some embodiments, the computer system 502 detects, via the touch-sensitive display 504, an input 1534 directed at the control element 1518 (e.g., of user interface 582, shown in FIG. 5M). In response to the input 1534, the computer system 502 includes the “off” mode in the list of selectable modes for the active noise management function, selectable in response to an input at the first audio output device. Additionally, when the first audio output device is configured to select the “off” mode via an input at the first audio output device, the control element 1518 is displayed with an indication indicating that it is currently selected (e.g., that the noise management function is currently off).

In some embodiments, the computer system 502 detects, via the touch-sensitive display 504, an input 1536 directed at the control element 588. In response to the input 1536, the computer system 502 includes the transparency mode in the list of selectable modes for the active noise management function, selectable in response to an input at the first audio output device. Additionally, the control element 588, when the first audio output device is configured to select the transparency mode via an input at the first audio output device, includes display of an indication 1542 indicating that it is currently selected (e.g., that the noise management function is set to transparency mode).

In some embodiments, the computer system 502 detects, via the touch-sensitive display 504, an input 1538 directed at the control element 590. In response to the input 1538, the computer system 502 includes the adaptive mode in the list of selectable modes for the active noise management function, selectable in response to an input at the first audio output device. Additionally, the control element 590, when the first audio output device is configured to select the adaptive mode via an input at the first audio output device, includes display of an indication indicating that it is currently selected (e.g., that the noise management function is set to adaptive mode).

In some embodiments, the computer system 502 detects, via the touch-sensitive display 504, an input 1540 directed at the control element 592. In response to the input 1540, the computer system 502 includes the noise cancellation mode in the list of selectable modes for the active noise management function, selectable in response to an input at the first audio output device. Additionally, the control element 592, when the first audio output device is configured to select the noise cancellation mode via an input at the first audio output device, includes display of an indication 1545 indicating that it is currently selected (e.g., that the noise management function is set to noise cancellation mode).

For example, for the configuration shown in FIG. 5H, the first wearable audio output device, in response to an input detected at the first wearable audio output device, causes the active noise management function to change from the noise cancellation mode to the transparency mode or from the transparency mode to the noise cancellation mode, because those modes have been selected (e.g., by a user of the computer system 502) in the user interface 582. In some embodiments, the first wearable audio output device, in response to an input detected at the first wearable audio output device, causes the active noise management function to transition (e.g., change) to the next mode in the list of modes for the active noise management function.

In some embodiments, the second wearable audio output device can be configured by a user of the computer system 502 using a second set of settings and configurations, selected by the user using a second instance of the user interfaces and control settings described above with reference to the first wearable audio output device. In such embodiments, a user of the computer system 502 can choose to configure the second wearable audio output device with different settings than the settings selected for the first wearable audio output device, or the user can choose to configure the second wearable audio output device with the same settings as the settings selected for the first wearable audio output device.

FIG. 5N illustrates the computer system 502 displaying, via the touch-sensitive display 504, a lock-screen user interface 1520 that includes a notification 1522 regarding a volume of the ambient sound exceeding a volume threshold and another notification 1524 regarding potential loud ambient sound based on a location of the computer system 502, a location of the one or more wearable audio output devices, or other location-information providing devices.

In some embodiments, the computer system 502 displays the notification 1522 regarding the volume of the ambient sound exceeding the volume threshold in accordance with a determination that the volume of the ambient sound exceeds the volume threshold, and optionally, for a threshold amount of time (e.g., the volume of the ambient sound has exceeded the volume threshold for a duration more than the threshold amount of time). Additionally, in some embodiments, the computer system 502 displays the notification 1522 when the “off” mode of the active noise management function (or other mode wherein the mode does not attenuate loud ambient sounds) is enabled. For example, the computer system 502 displays the notification 1522 in accordance with a determination that the volume of the ambient sound near the computer system 502 and/or the one or more wearable audio output devices has exceeded 90 decibels. In some embodiments, the volume threshold is predefined or defined by the user.

In some embodiments, the computer system 502 displays the notification 1524 regarding potential loud ambient sound in accordance with a determination that the user is likely to be in a location with loud ambient sounds. In some embodiments, the determination that the user is likely to be in a location with loud ambient sounds is based on a location of the user, e.g., based on location information provided by the computer system 502 and/or the one or more wearable audio output devices, and information regarding an event (e.g., a concert, movie, sports event, or other events with a potential for loud ambient sounds) at the location. In some embodiments, the notification 1524 and the notification 1522 are, optionally, displayed concurrently or displayed separately.

In some embodiments, the notifications 1522 and 1524 include a recommendation to enable a mode of the active noise management function (e.g., transparency mode, adaptive mode, and/or noise cancellation mode) to reduce (e.g., attenuate) the ambient sound received by the user.

In some embodiments, the computer system 502 detects, via the touch-sensitive display 504, an input 1526 (e.g., a tap input) directed to the notification 1522. In response to the input 1526 the computer system 502 displays, via the touch-sensitive display 504, a user interface 1544 for adjusting the mode of the active noise management function.

In some embodiments, the computer system 502 detects, via the touch-sensitive display 504, an input 1528 (e.g., a tap input) directed to the notification 1524. FIG. 5O illustrates a transition from the user interface shown in FIG. 5N in response to the input 1528. In response to the input 1528, the computer system 502 displays, via the touch-sensitive display 504, the user interface 1544 for adjusting the mode of the active noise management function.

FIG. 5O illustrates the user interface 1544 for adjusting the mode of the active noise management function. The user interface 1544 includes the control element 1518 for enabling the “off” mode of the active noise management function, the control element 558 for enabling a noise cancellation mode of the active noise management function, the control element 560 for enabling a transparency mode of the active noise management function, and/or the control element 562 for enabling an adaptive mode of the noise management function.

In some embodiments, when the “off” mode for the active noise management function is enabled, the control element 520 for adjusting the volume of the one or more wearable audio output devices is displayed on the display 504 of the computer system 502, and, optionally, the control element 522 for adjusting the magnitude of the active noise management function is not displayed, or alternatively control element 522 is “grayed out” or otherwise displayed in a manner to indicate that use of control element 522 is disabled.

In some embodiments, the computer system 502 detects, via the touch-sensitive display 504, an input 1546 (e.g., a tap input) directed to the control element 560 for enabling a transparency mode of the active noise management function. FIG. 5P illustrates a transition from the user interface shown in FIG. 5O in response to the input 1546. In response to the input, the computer system 502 displays, via the touch-sensitive display 504, the user interface 1544 for adjusting the mode of the active noise management function, including an indication at the control element 560 indicating that the transparency mode is enabled.

FIG. 5P illustrates the user interface 1544 for adjusting the mode of the active noise management function. The user interface 1544 includes the control element 1518 for enabling the “off” mode of the active noise management function, the control element 558 for enabling a noise cancellation mode of the active noise management function, the control element 560 for enabling a transparency mode of the active noise management function, and/or the control element 562 for enabling an adaptive mode of the noise management function. For example, selection of control element 1518, e.g., using an input on or directed to control element 1518, disables the active noise management function, and, optionally, causes a transition for displaying the user interface shown in FIG. 5P to displaying the user interface shown in FIG. 5O. As shown in FIG. 5P, displaying the user interface 1544 includes concurrent display of the control element 520 for adjusting the volume of the one or more wearable audio output devices and the control element 522 for adjusting the magnitude of the active noise management on the display 504 of the computer system 502.

FIG. 5Q illustrates a user interface 1548 for configuring a hearing assistance function. In some embodiments, the hearing assistance function alters the audio characteristics of audio output from the one or more wearable audio output devices based on results from a hearing test (e.g., an audiogram). In some embodiments, as illustrated by FIG. 5Q, the user interface 1548 includes an indication 1550 that hearing test results are being used by the computer system 502 and/or the one or more wearable audio output devices to alter the audio characteristics of the audio output at the one or more wearable audio output devices, an affordance 1552 to view the hearing test results, an affordance 1554 to import a new hearing test result, and/or an affordance 1556 to cause the computer system 502 and/or the one or more wearable audio output devices to perform an on-device hearing test.

In some embodiments, the computer system 502 detects, via the touch-sensitive display 504, an input 1558 (e.g., a tap input) directed to the affordance 1552 to view the hearing test results that the computer system 502 and/or the one or more wearable audio output devices are using to alter the audio characteristics of the audio output at the one or more wearable audio output devices. In response to the input 1558 the computer system 502 displays the hearing test results. For example, the computer system 502 displays the hearing test result with information regarding the user's ability to hear audio at a plurality of frequencies.

In some embodiments, the computer system 502 detects, via the touch-sensitive display 504, an input 1560 (e.g., a tap input) directed to the affordance 1554 to import a new hearing test result. The computer system 502 and/or the one or more wearable audio output devices alter the audio characteristics of the audio output from the one or more wearable audio output devices based on the new hearing test result. In some embodiments, at a point in time subsequent to when the new hearing test result is imported and in response to the computer system 502 detecting, via the touch-sensitive display 504, the input 1558 directed to the affordance 1552 to view the hearing test results, the computer system 502 displays the new hearing test result.

In some embodiments, the computer system 502 detects, via the touch-sensitive display 504, an input 1562 (e.g., a tap input) directed to the affordance 1556 to cause the computer system 502 and/or the one or more wearable audio output devices to perform the on-device hearing test. For example, the on-device hearing test includes requesting user feedback in response to a plurality of tones output at a plurality of frequencies and volumes to each ear of the user. Based on the user feedback, the computer system 502 generates a hearing test result. The computer system 502 and/or the one or more wearable audio output devices alter the audio characteristics of the audio output from the one or more wearable audio output devices based on the hearing test result from the on-device hearing test.

In some embodiments, as shown in FIG. 5Q, the user interface 1548 includes one or more control elements corresponding to settings associated with the hearing assistance function, including a control element 1564 for enabling and/or disabling the hearing assistant function, a control element 1566 for enabling and/or disabling the hearing assistance function for voices and/or ambient sounds, a control element 1568 for enabling and/or disabling the hearing assistance function for music and/or video audio, and/or a control element 1570 for enabling and/or disabling the hearing assistance function for phone calls and/or video conference audio.

In some embodiments, the computer system 502 detects, via the touch-sensitive display 504, an input 1572 (e.g., a tap input) directed to the control element 1564 for enabling and/or disabling the hearing assistant function. In response to the input 1572, the computer system 502 changes the state of the hearing assistance function from enabled to disabled or from disabled to enabled. For example, as shown in FIG. 5Q, in response to the computer system 502 detecting the input 1572 directed to the control element 1564, the computer system 502 disables the hearing assistance function for the computer system 502 and/or the one or more wearable audio output devices.

In some embodiments, the computer system 502 detects, via the touch-sensitive display 504, an input 1574 (e.g., a tap input) directed to the control element 1566 for enabling and/or disabling the hearing assistance function for voices and/or ambient sounds. In response to the input 1576, the computer system 502 changes the state of the hearing assistance function for voices and/or ambient sounds from enabled to disabled or from disabled to enabled. For example, as shown in FIG. 5Q, the state of the hearing assistance function for voices and/or ambient sounds is disabled. In response to the input 1576, the computer system 502 enables the hearing assistance function for voices and/or ambient sounds. In some embodiments, the computer system 502, in response to the input 1576, displays, via the touch-sensitive display 504, a user interface for adjusting one or more settings associated with the hearing assistance function for voices and/or ambient sounds. For example, the one or more settings include settings for enabling the hearing assistance function for voices and/or ambient sounds in user-defined locations (e.g., at home, at work, or other locations).

In some embodiments, the computer system 502 detects, via the touch-sensitive display 504, an input 1576 (e.g., a tap input) directed to the control element 1568 for enabling and/or disabling the hearing assistance function for music and/or video audio. In response to the input 1576, the computer system 502 changes the state of the hearing assistance function for music and/or video audio from enabled to disabled or from disabled to enabled. For example, as shown in FIG. 5Q, the state of the hearing assistance function for music and/or video audio is enabled. In response to the input 1576, the computer system 502 disables the hearing assistance function for music and/or video audio. In some embodiments, the computer system 502, in response to the input 1576, displays, via the touch-sensitive display 504, a user interface for adjusting one or more settings associated with the hearing assistance function for music and/or video audio. For example, the one or more settings include settings for enabling the hearing assistance function for select applications (e.g., applications associated with music and/or video playback).

In some embodiments, the computer system 502 detects, via the touch-sensitive display 504, an input 1578 (e.g., a tap input) directed to the control element 1570 for enabling and/or disabling the hearing assistance function for phone calls and/or video conference audio. In response to the input 1578, the computer system 502 changes the state of the hearing assistance function for phone calls and/or video conference audio from enabled to disabled or from disabled to enabled. For example, as shown in FIG. 5Q, the state of the hearing assistance function for phone calls and/or video conference audio is enabled. In response to the input 1578, the computer system 502 disables the hearing assistance function for phone calls and/or video conference audio. In some embodiments, the computer system 502, in response to the input 1578, displays, via the touch-sensitive display 504, a user interface for adjusting one or more settings associated with the hearing assistance function for phone calls and/or video conference audio. For example, the one or more settings include enabling the hearing assistance function for select applications (e.g., applications for phone calls and/or video conferencing).

In some embodiments, as shown in FIG. 5Q, the user interface 1548 includes a control element 1580 (e.g., an affordance) for enabling and/or disabling controlling the hearing assistance function in response to inputs at the one or more wearable audio output devices, which is described in more detail with respect to at least FIGS. 6A-6Y. In some embodiments, the computer system 502 detects, via the touch-sensitive display 504, an input 1582 (e.g., a tap input) directed to the control element 1580 for enabling and/or disabling controlling the hearing assistance function in response to inputs at the one or more wearable audio output devices. In response to the input 1582, the computer system 502 changes the state for controlling the hearing assistance function in response to inputs at the one or more wearable audio output devices from enabled to disabled or from disabled to enabled.

FIG. 5R illustrates a computer system 1584 (e.g., an instance of portable multifunction device 100) displaying, via a display 1586, a user interface 1588 including a menu bar 1590 and an application window 1592. In some embodiments, the menu bar includes an affordance 1594 for adjusting one or more settings associated with the one or more wearable audio output devices. In some embodiments, the computer system 1584 is a tablet computer.

In some embodiments, the computer system 1584 detects, via an input device of the computer system 1584, an input 1596 (e.g., a tap input) directed at the affordance 1594 for adjusting one or more settings associated with the one or more wearable audio output devices. FIG. 5S illustrates a transition from the user interface shown in FIG. 5R in response to the input 1596. In response to the input 1596, the computer system 1584 displays, via the display 1586, a user interface 1598 for adjusting one or more settings associated with the one or more wearable audio output devices. In some embodiments, user interface 1598 is displayed over a portion of user interface 1588.

FIG. 5S illustrates the computer system 1584 displaying, via the display 1586, the user interface 1598 for adjusting the one or more settings associated with the one or more wearable audio output devices, that includes a control element 11502 for adjusting the volume of the audio output at the one or more wearable audio output devices and a control element 11504 for adjusting a magnitude of an active noise management function, and optionally, a control element 11506 for adjusting a mode of the active noise management function (e.g., a noise cancellation mode, an adaptive mode, a transparency mode, an “off” mode, or other modes of the active noise management function), a control element 11508 for adjusting a mode of a speech detection function, and/or a control element 11510 for adjusting a mode of a spatial audio function. In some embodiments, as shown in FIG. 5S, the control element 11506, the control element 11508, and the control element 11510 each include display of an indication of the current mode of a corresponding function. For example, the control element 11506 includes display of an indication 11512 that the current mode of the noise management function is the transparency mode, the control element 11508 includes display of an indication 11514 that the speech detection function is disabled, and the control element 11510 includes display of an indication 11516 that the mode of the spatial audio function is a head tracking mode.

In some embodiments, as shown in FIG. 5S, the computer system 1584 detects, via the input device, an input 11518 (e.g., a leftward swipe input) directed to the control element 11502. FIG. 5T illustrates a transition from displaying the user interface shown in FIG. 5S in response to the input 11518. In response to the input 11518, the computer system 1584 causes the volume of audio output at the one or more wearable audio output devices to decrease (e.g., the audio output volume is quieter).

FIG. 5T illustrates the computer system 1584 displaying, via the display 1586 and at the control element 11502, an updated indication of the decreased volume of the audio output at the one or more wearable audio output devices in response to the input 11518.

In some embodiments, the computer system 1584 detects, via the input device, an input 11520 (e.g., a leftward swipe input) directed to the control element 11504 to decrease the magnitude of the active noise management function. FIG. 5U illustrates a transition from user interface shown in FIG. 5T in response to the input 11520. In response to the input 11520, the computer system 1584 decreases the magnitude of the active noise management function, as shown in FIG. 5U. Additionally, the computer system 1584 displays an indication of the decreased magnitude of the active noise management function at the control element 11504.

FIG. 5U illustrates the computer system 1584 displaying, via the display 1586 and at the control element 11504, an updated indication of the decreased magnitude of the active noise management function in response to the input 11520.

In some embodiments, the computer system 1584 detects, via the input device, an input 11522 (e.g., a tap input) directed to the control element to select the computer speakers of the computer system 1584 as the audio output device. In some embodiments, in response to the input 11522, the computer system 1584 outputs audio to the computer speakers of the computer system 1584.

In some embodiments, the computer system 1584 detects, via the input device, an input 11524 (e.g., a tap input) directed to the control element to select the one or more wearable audio output devices paired with the computer system 1584 as the audio output device. In some embodiments, in response to the input 11524, the computer system 1584 outputs audio to the one or more wearable audio output devices paired with the computer system 1584.

In some embodiments, the computer system 1584 detects, via the input device, an input 11526 (e.g., a tap input) directed to the control element to enable the “off” mode of the active noise management function. In response to the input 11526, the computer system enables the “off” mode of the active noise management function at the computer system 1584 and/or the one or more wearable audio output devices. For example, in response to the input 11526 enabling the “off” mode, the one or more wearable audio output devices and/or the computer system 1584 cease to alter the ambient sounds that are received by the user while the user is wearing the one or more wearable audio output devices.

In some embodiments, the computer system 1584 detects, via the input device, an input 11528 (e.g., a tap input) directed to the control element to enable the transparency mode of the active noise management function. In response to the input 11528, the computer system 1584 enables the transparency mode of the active noise management function at the computer system 1584 and/or the one or more wearable audio output devices. For example, in response to the input 11528 enabling the transparency mode, the one or more wearable audio output devices capture and playback ambient sounds to the user (e.g., such that the user hears the ambient sounds at a volume similar (e.g., with a predefined margin, such as ten percent or twenty percent) to the volume at which the user would hear the ambient sounds if the user was not wearing the one or more wearable audio output devices).

In some embodiments, the computer system 1584 detects, via the input device, an input 11530 (e.g., a tap input) directed to the control element to enable the adaptive mode of the active noise management function. In response to the input 11530, the computer system 1584 enables the adaptive mode of the active noise management function at the computer system 1584 and/or the one or more wearable audio output devices. For example, in response to the input 11530 enabling the adaptive mode, the one or more wearable audio output devices alter the ambient sounds based on context such that the user hears ambient sounds at a quieter volume for a first set of contexts and/or the user hears the ambient sounds at a louder volume for in a second set of contexts (e.g., contexts other than the first set of contexts) while the adaptive mode is enabled.

In some embodiments, the computer system 1584 detects, via the input device, an input 11532 (e.g., a tap input) directed to the control element to enable the noise cancellation mode of the active noise management function. In response to the input 11532, the computer system 1584 enables the noise cancellation mode of the active noise management function at the computer system 1584 and/or the one or more wearable audio output devices. For example, in response to the input 11532 enabling the noise cancellation mode, the one or more wearable audio output devices attenuate ambient sounds such that the user hears the ambient sounds at a lower volume while the noise cancellation mode is enabled.

In some embodiments, the computer system 1584 detects, via the input device, an input 11533 (e.g., a tap input) directed to the control element to disable the spatial audio function. In response to the input 11533, the computer system 1584 disables the spatial audio function at the computer system 1584 and/or the one or more wearable audio output devices. For example, in response to the input 11533 disabling the spatial audio function, the audio output at the one or more wearable audio output devices is not altered with a spatial audio affect.

In some embodiments, the computer system 1584 detects, via the input device, an input 11534 (e.g., a tap input) directed to the control element to enable the spatial audio function. In response to the input 11534, the computer system 1584 enables the spatial audio function at the computer system 1584 and/or the one or more wearable audio output devices. For example, in response to the input 11534 enabling the spatial audio function, the audio output at the one or more wearable audio output devices is altered with a spatial audio affect.

In some embodiments, the computer system 1584 detects, via the input device, an input 11536 (e.g., a tap input) directed to the control element to enable the spatial audio function with head tracking. In response to the input 11536, the computer system 1584 enables the spatial audio function with head tracking at the computer system 1584 and/or the one or more wearable audio output devices. For example, in response to the input 11536 enabling the spatial audio function with head tracking, the audio output at the one or more wearable audio output devices is altered with a spatial audio affect, where the spatial audio affect is based on the position and/or orientation of the one or more wearable audio output devices relative to the source of the audio (e.g., the computer system 1584).

In some embodiments, the computer system 1584 detects, via the input device, an input 11538 (e.g., a tap input) directed to the control element to disable the speech detection function. In response to the input 11538, the computer system 1584 disables the speech detection function at the computer system 1584 and/or the one or more wearable audio output devices. For example, in response to the input 11538 disabling the speech detection function, the volume of the audio output (e.g., audio from an application, or more generally audio from a source other than the source of the detected speech) at the one or more wearable audio output devices is not automatically lowered in accordance with a determination that the user is engaged in a physical conversation.

In some embodiments, the computer system 1584 detects, via the input device, an input 11540 (e.g., a tap input) directed to the control element to enable the speech detection function. In response to the input 11540, the computer system 1584 enables the speech detection function at the computer system 1584 and/or the one or more wearable audio output devices. For example, in response to the input 11540 enabling the speech detection function, the volume of the audio output at the one or more wearable audio output devices is automatically lowered in accordance with a determination that the user is engaged in a physical conversation.

FIG. 5V illustrates a computer system 11542 (e.g., an instance of portable multifunction device 100) displaying, via a touch-sensitive display 11544, a user interface 11546, and the computer system 11542 includes an input device 11548. In some embodiments, the user interface 11546 includes one or more control elements 11550 configured to cause the computer system 11542, the one or more wearable audio output devices, or other devices connected to the computer system 11542 to perform one or more actions in response to one or more inputs detected at the computer system 11542, via the touch-sensitive display 11544, the input device 11548, and/or other input devices. For example, as shown in FIG. 5V, the one or more control elements 11550 are, optionally, control elements for setting one or more system properties (e.g., one or more of audio properties, display properties, privacy properties, connectivity properties, and media playback properties). In some embodiments, the computer system 11542 is a watch device (e.g., a smartwatch).

In some embodiments, the computer system 11542 detects, via the touch-sensitive display 11544, an input 11552 directed to the control element 11554. FIG. 5W illustrates a transition from the user interface shown in FIG. 5V in response to the input 11552. In response to the input 11552, the computer system 11542 displays, via the touch-sensitive display 11544, a user interface 11556 for adjusting one or more settings associated with the one or more wearable audio output devices.

FIG. 5W illustrates the computer system 11542 displaying, via the touch-sensitive display 11544, the user interface 11556 for adjusting one or more settings associated with the one or more wearable audio output devices. The user interface 11556 includes a control element 11558 for adjusting the volume of audio output at the one or more wearable audio output devices. In some embodiments, the user interface 11556 includes a control element 11560 for adjusting the mode of an active noise management function of the computer system 11542.

In an example, the computer system 11542 detects, via the touch-sensitive display 11544, an input 11566 (e.g., a rightward swipe input) to increase the volume of the audio output at the one or more wearable audio output devices. In response to the input 11566, the computer system 11542 increase the volume of the audio output at the one or more wearable audio output devices.

In another example, the computer system 11542 detects, via the touch-sensitive display 11544, an input 11562 (e.g., an upward swipe input) or, optionally, the computer system 11542 detects, via the input device 11548, an input 11564 (e.g., a rotation input). FIG. 5X illustrates a transition from the user interface shown in FIG. 5W in response to the input 11562, or the input 11564. In response to the input 11562, the computer system 11542 scrolls the user interface 11556, such that additional content of the user interface 11556 is displayed on the touch-sensitive display 11544.

FIG. 5X illustrates the user interface 11556 with the additional content in response to the input 11562 or the input 11564. The user interface 11556 includes a control element 11568 for enabling a transparency mode of the active noise management function, a control element 11570 for enabling an adaptive mode of the active noise management function, a control element 11572 for enabling a noise cancellation mode of the active noise management function, and/or, optionally, a control element 11574 for enabling an “off” mode of the active noise management function.

In some embodiments, the user interface 11556 includes an indication of the currently enabled mode of the active noise management function. For example, as shown in FIG. 5X, the computer system 11542 displays, via the touch-sensitive display 11544, an indication 11577 that the noise cancellation mode of the active noise management function is enabled.

In some embodiments, the computer system 11542 detects, via the touch-sensitive display 11544, an input 11576 (e.g., a tap input) or, optionally, the computer system 11542 detects, via the input device 11548, an input 11578 (e.g., a press input). FIG. 5Y illustrates a transition from the user interface shown in FIG. 5X in response to the input 11576 or the input 11578. In response to the input 11576 or the input 11578, the computer system 11542 changes the mode of the active audio management function from the noise cancellation mode to the transparency mode.

FIG. 5Y illustrates the computer system 11542 displaying, via the touch-sensitive display 11544, the user interface 11556 for adjusting one or more settings associated with the one or more wearable audio output devices. In accordance with a determination that the transparency mode of the active noise management function is enabled, the computer system 11542 displays, via the touch-sensitive display 11544 at the control element 11568, an indication 11580 that the transparency mode of the active noise management function is enabled.

In some embodiments, the computer system 11542 detects, via the touch-sensitive display 11544, an input 11582 (e.g., a tap input) directed at a return affordance 11583 or, optionally, the computer system 11542 detects, via the input device 11548, an input 11584 (e.g., a press input). FIG. 5Z illustrates a transition from the user interface shown in FIG. 5Y in response to the input 11582 or the input 11584. In response to the input 11582 or the input 11584, the computer system 11542 displays, via the touch-sensitive display 11544, the user interface 11556.

FIG. 5Z illustrates the computer system 11542 displaying, via the touch-sensitive display 11544, the user interface 11556 for adjusting the one or more settings associated with the one or more wearable audio output devices. In accordance with a determination that the transparency mode (or the adaptive mode) of the active noise management function is enabled, the user interface 11556 includes display of a control element 11586 for adjusting the magnitude of the active noise management function.

In some embodiments, the computer system 11542 detects, via the touch-sensitive display 11544, an input 11588 (e.g., a rightward swipe input) directed at the control element 11558 to increase the volume of the audio output at the one or more wearable audio output devices or, optionally, the computer system 11542 detects, via the input device 11548, an input 11590 (e.g., a rotation input). FIG. 5AA is a transition from FIG. 5A in response to the input 11588 or the input 11590. In response to the input 11588 or the input 11590, the computer system 11542 increases the volume of the audio output at the one or more wearable audio output devices.

FIG. 5AA illustrates the computer system 11542 displaying, via the touch-sensitive display 11544, in response to the input 11588 or the input 11590, an indication 11559 of the increased volume of the audio output at the one or more wearable audio output devices.

In some embodiments, the computer system 11542 detects, via the touch-sensitive display 11544, an input 11591 (e.g., a leftward swipe input) directed at the control element 11586 to adjust the magnitude of the active noise management function or, optionally, the computer system 11542 detects, via the input device 11548, an input 11592 (e.g., a rotation input). FIG. 5AB illustrates a transition from the user interface shown in FIG. 5AA in response to the input 11591 or the input 11592. In response to the input 11591 or the input 11592, the computer system 11542 decreases the magnitude of the active noise management function, and optionally, causes the computer system 11542 to output haptic feedback.

FIG. 5AB illustrates the computer system 11542 displaying, via the touch-sensitive display 11544, in response to the input 11588 or the input 11590, an indication 11593 of the decreased magnitude of the active noise management function.

FIGS. 6A-6Y illustrate example user interactions and user interfaces for controlling volume and noise management functions in accordance with some embodiments. FIG. 6A illustrates the one or more wearable audio output devices (e.g., wearable audio output devices 301) including a (first) wearable audio output device 602 and a (second) wearable audio output device 604. As shown in FIG. 6A, a computer system and/or the wearable audio output devices 602 and 604 are playing audio (e.g., music) as indicated by status 605, and the wearable audio output devices 602 and 604 are outputting the audio associated with the audio playback at the wearable audio output devices 602 and 604. In some embodiments, the wearable audio output devices 602 and 604 output the audio associated with the music at a volume 606. The wearable audio output device 602 and the wearable audio output device 604 have synchronized (e.g., the same) volume, or alternatively have different volumes, for audio output at each respective wearable audio output device. For example, in FIG. 6A, the volume of the audio output at the wearable audio output device 602 is at the same volume as the volume of the audio output at the wearable audio output device 604.

In some embodiments, the wearable audio output devices 602 and 604 output the audio associated with the music with a magnitude of the hearing assistance function at a magnitude 608. The wearable audio output device 602 and the wearable audio output device 604 have synchronized (e.g., the same) magnitude of the hearing assistance function, or alternatively or have different magnitudes of the hearing assistance function, for audio output at each respective wearable audio output device. For example, in FIG. 6A, the magnitude of the hearing assistance function for the audio output at the wearable audio output device 602 is at the same magnitude as the magnitude of the hearing assistance function for the audio output at the wearable audio output device 604.

In an example, the wearable audio output devices 602 and 604 both have (e.g., are operating with, or used with) an enabled mode of the active noise management function. For example, as shown in FIG. 6A, the transparency mode 610 of the active noise management function for the wearable audio output devices 602 and 604 is enabled.

FIG. 6B illustrates the wearable audio output device 604 detecting, via an input device of the wearable audio output device 604, an input 612 (e.g., a swipe input). In some embodiments, the input 612 is detected while the wearable audio output devices 602 and 604 are outputting audio. FIG. 6C illustrates a transition from FIG. 6A in response to input 612, as shown in FIG. 6B. In response to input 612, the volume of the audio output at the wearable audio output devices 602 and 604 increases (e.g., from volume 606 to volume 614).

FIG. 6C illustrates the volume of the audio output at the wearable audio output devices 602 and 604 increases in response to input 612. In some embodiments, the increase in volume is in accordance with a determination that input 612 is detected while the wearable audio output devices 602 and 604 are outputting audio. For example, as shown in FIG. 6C, the volume of the wearable audio output device 602 and the wearable audio output device 604 increases from volume 606 to volume 614 in response to the input 612 while audio is being outputted at the wearable audio output devices 602 and 604. In some embodiments, input 612 is received at the wearable audio output device 602 or the wearable audio output device 604, and in response to input 612 received at either the wearable audio output device 602 or the wearable audio output device 604, the volume of both wearable audio output devices is increased.

In some embodiments, in response to the input 612 to increase the volume of the audio output, the wearable audio output devices 602 and 604 output feedback (e.g., audio feedback) to indicate that the volume has increased at the wearable audio output devices. For example, as shown in FIG. 6C, the wearable audio output devices 602 and 604 output feedback 616 in response to the input 612.

FIG. 6D illustrates the wearable audio output device 604 detecting, via the input device of the wearable audio output device 604, an input 618 (e.g., a squeeze input). In some embodiments, the input 618 is detected while the wearable audio output devices 602 and 604 are outputting audio. FIG. 6E illustrates a transition from FIG. 6C in response to the input 618, as shown in FIG. 6D. In response to the input 618, the wearable audio output devices 602 and 604 cease to output the audio (e.g., audio playback is paused as indicated by status 620).

FIG. 6E illustrates the wearable audio output devices 602 and 604 ceasing to output audio in response to the input 618. In some embodiments, ceasing the output of the audio is in accordance with a determination that the input 618 is detected while the wearable audio output devices 602 and 604 are outputting audio. For example, as shown in FIG. 6E, the audio output at the wearable audio output device 602 and the wearable audio output device 604 cease in response to the input 618. In some embodiments, ceasing the audio output includes pausing audio playback, and/or muting the wearable audio output devices 602 and 604.

In some embodiments, in response to the input 618 to cause the wearable audio output devices 602 and 604 to cease audio output, the wearable audio output devices 602 and 604, or alternatively one of the wearable audio output devices (e.g., the wearable audio output device at which input 618 is detected), output feedback 622 (e.g., audio feedback) to indicate that the audio output has ceased. For example, as shown in FIG. 6E, the wearable audio output devices 602 and 604 output feedback 622 in response to the input 618. In some embodiments, the feedback 616 is distinct from the feedback 622 (e.g., a different tone, a different duration, a different pattern, or other different audio or audio characteristics that distinguishes one feedback from another feedback).

FIG. 6F illustrates the wearable audio output device 604 detecting, via the input device of the wearable audio output device 604, an input 624 (e.g., a swipe input). In some embodiments, the input 624 is detected while the wearable audio output devices 602 and 604 are not outputting audio, and in accordance with a determination that the amount of time 626 that has elapsed since the wearable audio output devices 602 and 604 ceased to output audio is less than a threshold amount of time 628. FIG. 6G illustrates a transition from FIG. 6E in response to the input 624, as shown in FIG. 6F. In response to the input 624 and in accordance with a determination that the amount of time 626 that has elapsed since the wearable audio output devices 602 and 604 ceased to output audio is less than the threshold amount of time 628, cause the volume of the audio output at the wearable audio output devices 602 and 604 to decrease.

FIG. 6G illustrates the volume of the audio output at the wearable audio output devices 602 and 604 decreasing in response to the input 624. In some embodiments, the decrease in volume is in accordance with a determination that the input 624 is detected while the wearable audio output devices 602 and 604 are not outputting audio, and in accordance with a determination that the amount of time 626 that has elapsed since the wearable audio output devices 602 and 604 ceased to output audio is less than a threshold amount of time 628. For example, as shown in FIG. 6G, the volume of the wearable audio output device 602 and the wearable audio output device 604 decreases from volume 614 to volume 630 in response to the input 624. In some embodiments, the input 624 is received at the wearable audio output device 602 or the wearable audio output device 604, and in response to the input 624 received at either the wearable audio output device 602 or the wearable audio output device 604, the volume of both wearable audio output devices is decreased.

In some embodiments, in response to the input 624 to decrease the volume of the audio output, the wearable audio output devices 602 and 604, or alternatively one of the wearable audio output devices (e.g., the wearable audio output device at which input 624 is detected), output feedback 632 (e.g., audio feedback) to indicate that the volume has decreased at the wearable audio output devices. For example, as shown in FIG. 6G, the wearable audio output devices 602 and 604 output feedback 632 in response to the input 624.

FIG. 6H illustrates the wearable audio output device 604 detecting, via the input device of the wearable audio output device 604, an input 634 (e.g., a swipe input). In some embodiments, the input 634 is detected while the wearable audio output devices 602 and 604 are not outputting audio, and in accordance with a determination that the amount of time 636 that has elapsed since the wearable audio output devices 602 and 604 ceased to output audio is greater than a threshold amount of time 628. FIG. 6I illustrates a transition from FIG. 6G in response to the input 634, as shown in FIG. 6H. In response to the input 634 and in accordance with a determination that the amount of time 636 that has elapsed since the wearable audio output devices 602 and 604 ceased to output audio is greater than the threshold amount of time 628, the computer system and/or the wearable audio output devices 602 and 604 cause the magnitude of the active noise management function of the wearable audio output devices 602 and 604 to increase.

FIG. 6I illustrates the magnitude of the active noise management function of the wearable audio output devices 602 and 604 increasing in response to the input 634. In some embodiments, the increase in the magnitude of the active noise management function is in accordance with a determination that the input 634 is detected while the wearable audio output devices 602 and 604 are not outputting audio, and in accordance with a determination that the amount of time 636 that has elapsed since the wearable audio output devices 602 and 604 ceased to output audio is greater than a threshold amount of time 628. For example, as shown in FIG. 6I, the magnitude of the active noise management function of the wearable audio output device 602 and the wearable audio output device 604 increases from magnitude 608 to magnitude 638 in response to the input 634. In some embodiments, the input 634 is received at the wearable audio output device 602 or the wearable audio output device 604, and in response to the input 634 received at either the wearable audio output device 602 or the wearable audio output device 604, the magnitude of the active noise management function of both wearable audio output devices is increased.

In some embodiments, in response to the input 634 to increase the magnitude of the active noise management function, the wearable audio output devices 602 and 604 output feedback 640 (e.g., audio feedback) to indicate that the magnitude of the active noise management function has increased at the wearable audio output devices 602 and 604. For example, as shown in FIG. 6I, the wearable audio output devices 602 and 604 output feedback 632 in response to the input 634.

FIG. 6J illustrates the wearable audio output device 604 detecting, via the input device of the wearable audio output device 604, an input 642 (e.g., a squeeze input). In some embodiments, the input 642 is detected while the wearable audio output devices 602 and 604 are not outputting audio. FIG. 6K illustrates a transition from FIG. 6I in response to the input 642, as shown in FIG. 6J. In response to the input 642, the wearable audio output devices 602 and 604 resume outputting the audio (e.g., audio playback is resumed, as indicated by music playing indicator 644).

FIG. 6K illustrates the wearable audio output devices 602 and 604 outputting audio in response to the input 642. In some embodiments, outputting the audio is in accordance with a determination that the input 642 is detected while the wearable audio output devices 602 and 604 are not outputting audio. For example, as shown in FIG. 6K, the audio output at the wearable audio output device 602 and the wearable audio output device 604 resumes in response to the input 642. In some embodiments, resuming the audio output includes resuming audio playback, and/or unmuting the wearable audio output devices 602 and 604.

In some embodiments, in response to the input 642 to cause the wearable audio output devices 602 and 604 to resume audio output, the wearable audio output devices 602 and 604, or alternatively one of the wearable audio output devices (e.g., the wearable audio output device at which input 642 is detected), output feedback 646 (e.g., audio feedback) to indicate that the audio output has ceased. For example, as shown in FIG. 6K, the wearable audio output devices 602 and 604 output feedback 646 in response to the input 642. In some embodiments, the feedback 646 is distinct from other feedback, such as feedback 616, 622, 632, and/or 640 (e.g., a different tone, a different duration, a different pattern, or other different audio or audio characteristics that distinguishes first feedback from second, different, feedback).

FIG. 6L illustrates the wearable audio output device 602 detecting, via the input device of the wearable audio output device 602, an input 648 (e.g., a swipe input). In some embodiments, the input 648 is detected while the wearable audio output devices 602 and 604 are outputting audio, and in accordance with a determination that the amount of time 650 that has elapsed since the wearable audio output devices 602 and 604 resumed outputting audio is less than a threshold amount of time 652. FIG. 6M illustrates a transition from FIG. 6K in response to the input 648, as shown in FIG. 6L. The threshold amount of time 628 shown in FIGS. 6L and 6N is optionally the same as, or different from, the threshold amount of time 628, discussed above with reference to FIGS. 6F and 6H. In response to the input 648 and in accordance with a determination that the amount of time 650 that has elapsed since the wearable audio output devices 602 and 604 resumed outputting audio is less than a threshold amount of time 628, cause the magnitude of the active noise management function of the wearable audio output devices 602 and 604 to increase.

FIG. 6M illustrates the magnitude of the active noise management function of the wearable audio output devices 602 and 604 increasing in response to the input 648. In some embodiments, the increase in the magnitude of the active noise management function is in accordance with a determination that the input 648 is detected while the wearable audio output devices 602 and 604 are outputting audio, and in accordance with a determination that the amount of time 650 that has elapsed since the wearable audio output devices 602 and 604 resumed outputting audio is less than a threshold amount of time 628. For example, as shown in FIG. 6M, the magnitude of the active noise management function of the wearable audio output device 602 and the wearable audio output device 604 increases from magnitude 638 to magnitude 652 in response to the input 648. In some embodiments, the input 648 is received at the wearable audio output device 602 or the wearable audio output device 604, and in response to the input 648 received at either the wearable audio output device 602 or the wearable audio output device 604, the magnitude of the active noise management function of both wearable audio output devices is increased.

In some embodiments, in response to the input 648 to increase the magnitude of the active noise management function of the audio output, the wearable audio output devices 602 and 604, or alternatively one of the wearable audio output devices (e.g., the wearable audio output device at which input 648 is detected), output feedback 654 (e.g., audio feedback) to indicate that the magnitude of the active noise management function has increased at the wearable audio output devices 602 and 604. For example, as shown in FIG. 6M, the wearable audio output devices 602 and 604 output feedback 654 in response to the input 648.

FIG. 6N illustrates the wearable audio output device 602 detecting, via the input device of the wearable audio output device 602, an input 624 (e.g., a swipe input). In some embodiments, the input 656 is detected while the wearable audio output devices 602 and 604 are not outputting audio, and in accordance with a determination that the amount of time 658 that has elapsed since the wearable audio output devices 602 and 604 ceased to output audio is greater than a threshold amount of time 628. FIG. 6O illustrates a transition from FIG. 6M in response to the input 656, as shown in FIG. 6N. In response to the input 656 and in accordance with a determination that the amount of time 658 that has elapsed since the wearable audio output devices 602 and 604 ceased to output audio is greater than a threshold amount of time 628, cause the volume of the audio output at the wearable audio output devices 602 and 604 to increase.

FIG. 6O illustrates the volume of the audio output at the wearable audio output devices 602 and 604 increasing in response to the input 656. In some embodiments, the increase in volume is in accordance with a determination that the input 656 is detected while the wearable audio output devices 602 and 604 are not outputting audio, and in accordance with a determination that the amount of time 658 that has elapsed since the wearable audio output devices 602 and 604 ceased to output audio is greater than a threshold amount of time 628. For example, as shown in FIG. 6O, the volume of the wearable audio output device 602 and the wearable audio output device 604 increases from volume 630 to volume 660 in response to the input 656. In some embodiments, the input 656 is received at the wearable audio output device 602 or the wearable audio output device 604, and in response to the input 656 received at either the wearable audio output device 602 or the wearable audio output device 604, the volume of both wearable audio output devices is increased.

In some embodiments, in response to the input 656 to increase the volume of the audio output, the wearable audio output devices 602 and 604, or alternatively one of the wearable audio output devices (e.g., the wearable audio output device at which input 656 is detected), output feedback 662 (e.g., audio feedback) to indicate that the volume has increased at the wearable audio output devices. For example, as shown in FIG. 6O, the wearable audio output devices 602 and 604 output feedback 662 in response to the input 656.

FIG. 6P illustrates the wearable audio output device 604 detecting, via the input device of the wearable audio output device 604, an input 664 (e.g., a squeeze input). In some embodiments, the input 664 is detected while the wearable audio output devices 602 and 604 are outputting audio or not outputting audio. FIG. 6Q illustrates a transition from FIG. 6O in response to the input 664, as shown in FIG. 6P. In response to the input 664, the mode of the active noise management function is adjusted according to the list of selectable modes for the active noise management function for the wearable audio output devices 602 and 604.

FIG. 6Q illustrates the computer system or the wearable audio output devices 602 and 604 adjusting the mode of the active noise management function. As illustrated in FIG. 6Q, the mode of the active noise management function is adjusted from the transparency mode 610 to the noise cancellation mode 666.

FIG. 6R illustrates the wearable audio output device 602 detecting, via the input device of the wearable audio output device 602, an input 668 (e.g., a squeeze input). In some embodiments, the input 668 is detected while the wearable audio output devices 602 and 604 are outputting audio or not outputting audio. FIG. 6S illustrates a transition from FIG. 6Q in response to the input 668, as shown in FIG. 6R. In response to the input 668, the mode of the active noise management function is adjusted according to the list of selectable modes for the active noise management function for the wearable audio output devices 602 and 604.

FIG. 6S illustrates the computer system or the wearable audio output devices 602 and 604 adjusting the mode of the active noise management function. As illustrated in FIG. 6S, the mode of the active noise management function is adjusted from the noise cancellation mode 666 to the adaptive mode 670.

FIG. 6T illustrates the wearable audio output device 602 detecting, via the input device of the wearable audio output device 602, an input 672 (e.g., a squeeze input) and concurrently, the wearable audio output device 604 detecting, via the input device of the wearable audio output device 604, an input 674 (e.g., a squeeze input). In some embodiments, the concurrent inputs 672 and 674 are detected while the wearable audio output devices 602 and 604 are outputting audio or not outputting audio. FIG. 6U illustrates a transition from FIG. 6S in response to the concurrent inputs 672 and 674, as shown in FIG. 6T. In response to the concurrent inputs 672 and 674, the mode of the active noise management function is adjusted to the transparency mode, independent of the list of selectable modes for the active noise management function for the wearable audio output devices 602 and 604.

FIG. 6U illustrates the computer system or the wearable audio output devices 602 and 604 adjusting the mode of the active noise management function. As illustrated in FIG. 6U, the mode of the active noise management function is adjusted to the transparency mode, independent of the which mode in the list of selectable modes for the active noise management function is active at the time the concurrent inputs 672 and 674 are detected and/or independent of whether the transparency mode is in the list of selectable modes.

FIG. 6V illustrates the user interface 566 for adjusting the one or more settings associated with the wearable audio output devices 602 and 604. In some embodiments, the user interface 566 for adjusting one or more settings associated with the wearable audio output devices 602 and 604 includes an indication 568 of the current battery level for the wearable audio output devices 602 and 604 and an indication 570 of the current battery level for a case for the wearable audio output devices (e.g., a case for charging the wearable audio output devices while the wearable audio output devices are positioned inside the case).

In some embodiments, the user interface 566 for adjusting one or more settings associated with the one or more wearable audio output devices includes the one or more control elements corresponding to one or more respective modes of the active noise management function (e.g., control element 558 for enabling the noise cancellation mode, control element 560 for enabling the transparency mode, and/or control element 562 for enabling the adaptive mode of the noise management function). Functionalities of the control element 558, the control element 560, and the control element 562 as described above with respect to at least FIG. 5E are similarly applicable to the same control elements 558, 560, and 562 as described with respect to FIG. 6V.

As shown in FIG. 6V, the computer system 502 displays the control element 560, in the user interface 566, with an indication that the transparency mode of the active noise management function is enabled (e.g., an indication that the transparency mode is the active mode). In some embodiments, in response to an input selecting a control element to enable a different mode of the active noise management function (e.g., the noise cancellation mode, the adaptive mode, or another mode of the active noise management function) the computer system 502 displays (e.g., updates) the control element associated with the enabled mode of the active noise management function with an indication that the respective mode is enabled.

In some embodiments, the one or more settings, displayed in the user interface 566, include a control element 572 for enabling an “off” mode of the active noise management function. The “off” mode of the active noise management function is described above.

As described above, in some embodiments, the computer system 502 is configured with a loud-noise-reduction mode enabled such that the one or more wearable audio output devices automatically attenuate ambient sounds above a threshold volume (e.g., 70 decibels, 75 decibels, 80 decibels, 90 decibels, or 100 decibels.). For example, the one or more wearable audio output devices automatically attenuate ambient sounds (e.g., train horns, loud concerts, or other ambient sounds) above the threshold volume. As described above, in some embodiments, ambient sounds attenuated by the loud-noise-reduction mode are, optionally, attenuated the same as or differently than the attenuation that would be performed on those ambient sounds by the noise cancellation mode (e.g., the loud-noise-reduction mode performs the attenuation only when loud noise is detected, and/or only attenuates the loud noise, without attenuating other ambient sounds, or attenuates the loud noise and applies less attenuation to other ambient sounds than would be applied by the noise cancelation mode). For example, the computer system 502 attenuates live music during a concert such that the user still hears the live music at a lower volume. In some embodiments, the computer system 502 is, optionally, configured with the loud-noise-reduction mode enabled by default, and optionally, enabled concurrently with other modes of the active noise management function (e.g., the transparency mode and/or the adaptive mode).

In some embodiments, the one or more settings, displayed in the user interface 566, include a control element 574 for disabling the loud-noise-reduction mode. For example, in response to an input detected by the touch-sensitive display 504 of the computer system 502 and directed to the control element 574, the loud-noise-reduction mode is disabled. For example, when the loud-noise-reduction mode is disabled, the computer system 502 and/or the one or more wearable audio output devices do not attenuate ambient sounds above the threshold volume. In some embodiments, the control element 574 for disabling the loud-noise-reduction mode is, optionally, accessed via a user interface for accessibility settings.

In some embodiments, the one or more settings displayed in user interface 566 include settings for configuring the computer system 502 and/or the wearable audio output devices 602 and 604 to perform one or more actions, such as invoking a voice assistant and/or adjusting the mode of the active noise management function, in response to an input at the wearable audio output devices 602 and/or 604. The settings for configuring the actions include a control element 576 for configuring actions associated with interactions with a first wearable audio output device (e.g., wearable audio output device 604) of the one or more wearable audio output devices and a control element 578 for configuring actions associated with interactions with a second wearable audio output device (e.g., wearable audio output device 602) of the one or more wearable audio output devices. In some embodiments, in accordance with settings made (e.g., by a user of the one or more wearable audio output devices) using control element 576 and control element 578, an input at the first wearable audio output device and an input at the second audio output device action cause the same action, or alternatively, different actions, to be performed by the computer system 502 and/or the one or more wearable audio output devices.

In some embodiments, the computer system 502 detects, via the touch-sensitive display 504, an input 676 (e.g., a swipe input) directed at the user interface 566 to scroll the user interface 566 and cause the computer system 502 to display additional content (e.g., more information) of the user interface 566.

FIG. 6W is a transition from FIG. 6V in response to the input 676. In response to the input 676, the computer system 502 displays additional content (e.g., control elements) of the user interface 566. FIG. 6W illustrates additional content of the user interface 566, including a control element 678 for configuring actions associated with interactions with the wearable audio output device 602 of the one or more wearable audio output devices and a control element 680 for configuring actions associated with interactions with the wearable audio output device 604 of the one or more wearable audio output devices.

In some embodiments, the computer system 502 detects, via the touch-sensitive display 504, an input 681 (e.g., a tap input) directed to the control element 680 for configuring actions associated with interactions with the wearable audio output device 604. For example, the interaction(s) include a swipe input detected at the wearable audio output device 604.

In some embodiments, the computer system 502 detects, via the touch-sensitive display 504, an input 679 (e.g., a tap input) directed to the control element 678 for configuring actions associated with interactions with the wearable audio output device 602. For example, the interaction(s) include a swipe input detected at the wearable audio output device 602.

FIG. 6X illustrates a transition from FIG. 6W in response to the input 679. In response to the input 679, the computer system 502 displays, via the touch-sensitive display 504, a user interface for configuring actions associated with interactions with the wearable audio output device 602. FIG. 6X illustrates the user interface for configuring actions associated with interactions with the wearable audio output device 602. In some embodiments, the user interface includes a control element 682 for context dependent actions, a control element 684 for only adjusting the volume of audio output at the wearable audio output device 602 in response to interactions with the wearable audio output device 602, and/or a control element 686 for only adjusting a hearing assistance function of the wearable audio output device 602 in response to interactions with the wearable audio output device 602. In the example of FIG. 6X, the control element 682 includes an indicator 694 indicating that it is the currently selected mapping for the swipe input type. In one example, an input 688 is detected at a location corresponding to control element 682, and, in response, the swipe input type is mapped to a context dependent mode (e.g., whether the volume is adjusted or the hearing assist is adjusted is dependent on the context when the swipe input is detected). In another example, an input 690 is detected at a location corresponding to control element 684, and, in response, the swipe input type is mapped to a volume level adjustment operation. In yet another example, an input 692 is detected at a location corresponding to control element 686, and, in response, the swipe input type is mapped to a hearing assist (e.g., active noise management) adjustment operation.

In some embodiments, in accordance with a determination that the control element 684 for only adjusting the volume of the audio output at the wearable audio output device 602 is enabled, in response to an input (e.g., a swipe input) at the wearable audio output device 602, the computer system 502 and/or the wearable audio output devices 602 and/or 604 adjust volume of audio output at the wearable audio output device 602 and/or wearable audio output device 604.

In some embodiments, in accordance with a determination that the control element 686 for only adjusting the hearing assistance function of the audio output at the wearable audio output device 602 is enabled, in response to an input (e.g., a swipe input) at the wearable audio output device 602, the computer system 502 and/or the wearable audio output devices 602 and/or 604 adjust the magnitude of the hearing assistance function of audio output at the wearable audio output device 602 and/or wearable audio output device 604.

In some embodiments, in accordance with a determination that the control element 682 for context dependent actions is enabled, the computer system 502 and/or the wearable audio output devices 602 and/or 604 perform different actions based on the state of audio playback (e.g., whether the one or more wearable audio output devices are outputting audio) and/or based on whether the input is received within the threshold amount of time 628 since the state of audio playback was changed. For example, as described with respect to FIGS. 6F-6G, when the input is received while the state of audio playback is paused and within the threshold amount of time 628 since audio playback was paused, the input causes adjustments to the volume of audio output at the wearable audio output devices. In another example, as described with respect to FIGS. 6H-6I, when the input is received while the state of audio playback is paused and at a point in time after the threshold amount of time since the audio playback was paused has elapsed, the input causes adjustments to the magnitude of the active noise management function. In yet another example, as described with respect to FIGS. 6L-6M, when the input is received while the state of audio playback is playing and within the threshold amount of time 628 since audio playback resumed, the input causes adjustments to the magnitude of the active noise management function. In a fourth example, as described with respect to FIGS. 6N-6O, when the input is received while the state of audio playback is playing and at a point in time after the threshold amount of time since audio playback resumed has elapsed, the input causes adjustments to the volume of audio output at the wearable audio output devices.

FIG. 6Y illustrates the user interface 566 in response to the input 594 directed to the back affordance 596. FIG. 6Y illustrates a transition from FIG. 6X in response to the input 594 directed to the back affordance 596. In response to the input 594, the computer system 502 displays the user interface 566 for adjusting the one or more settings associated with the wearable audio output devices 602 and/or 604.

FIGS. 7A-7L illustrate example user interactions and user interfaces for controlling audio routing in accordance with some embodiments. FIG. 7A illustrates a computer system 1584 displaying, via a display 1586 (e.g., a touch-sensitive display), a user interface 701 including a menu bar 1590 and an application window 702 for a video conferencing application. In some embodiments, the computer system 1584 displays, via the display 1586 at the application window 702, video data 704 for a remote person denoted as Halle W., video data 706 for another remote person denoted as Jasmine H., and video data 708 of the user (e.g., captured by a camera of the computer system 1584)

In some embodiments, the computer system 1584 displays, via the display 1586 at the application window 702, a control element 710 for enabling and/or disabling audio capture, a control element 712 for enabling and/or disabling video capture, and/or a control element 714 for adjusting the volume of audio output. In some embodiments, the computer system 1584 captures audio for the video conference application via an audio capture device (e.g., a microphone or other audio capture devices). In some embodiments, the computer system 1584 captures video data for the video conference application via a video capture device (e.g., a webcam, camera, or other video capture devices). In some embodiments, the computer system 1584 outputs audio of the video conference application via an audio output device (e.g., computer speakers of the computer system 1584, the wearable audio output devices 602 and 604, or other audio output devices).

In some embodiments, the computer system 1584 displays, via the display 1586 at the menu bar 1590, a control element 716 for enabling and/or disabling audio capture. In some embodiments, the computer system 1584 is paired with the wearable audio output devices 602 and 604. In some embodiments, while the user is in the video conference and while audio capture is enabled and/or while the audio output is enabled and/or at a volume greater than 0%, the computer system 1584 and the wearable audio output devices 602 and 604 are configured for bidirectional communication 718. For example, the computer system 1584 communicates 718-2 video conference audio 720 (e.g., speech from a remote user, such as the remote user denoted as Halle W. or Jasmine H.). In another example, the wearable audio output devices 602 and 604 communicate 718-1 the audio captured by the wearable audio output devices 602 and 604 to the computer system 1584 (e.g., such that the remote users can hear speech from the user). FIG. 7A also illustrates the computer system 502 displaying, via the touch-sensitive display 504, a user interface 721. In some embodiments, the user interface 721 is a wake-screen user interface.

As used herein, a wake-screen user interface (also sometimes called a lock screen or a lock-screen user interface) is a user interface that is displayed after the display of device 502 has entered a low power state during which the touch-sensitive display 504 is at least partially off. In some embodiments, in the low power state, the touch-sensitive display 504 optionally displays an “always on” indicator of a time and/or date and the device 502 displays the wake-screen user interface when the device is prompted to come out of the low power state. In some embodiments, optionally in response to a user input and/or in response to a threshold amount of time elapsing, the computer system 502 enters a locked state in which a password, passcode and/or biometric authentication is required to unlock the computer system 502, wherein the device has limited functionality in the locked state and must be unlocked before accessing respective applications (e.g., a communication application, such as a phone or voice-over-internet-protocol application) and/or data stored on device 100. In some embodiments, the wake screen user interface is displayed regardless of whether the device is in the locked state or has already been unlocked (e.g., the wake screen user interface is displayed upon waking the device before the user accesses a home screen user interface and/or other application user interfaces). In some embodiments, one or more alerts (e.g., system alerts and/or notifications) are displayed on the wake screen user interface, optionally in response to a user input (e.g., a swipe gesture upward in the middle of the display or another gesture).

In some embodiments, the wearable audio output devices 602 and 604 are paired with the computer system 502. As shown in FIG. 7A, the computer system 502 is not outputting audio (e.g., phone call audio data, music audio data, or other audio data from the computer system 502) to the wearable audio output devices 602 and 604, and the wearable audio output devices 602 and 604 are not communicating captured audio (by the wearable audio output devices 602) to the computer system 502. In some embodiments, the wearable audio output devices 602 and 604 are not engaged in bidirectional communication with the computer system 502 in accordance with a determination that the computer system 1584 is engaged in bidirectional communication with the wearable audio output devices 602 and 604.

FIG. 7B illustrates the computer system 502 displaying, via the touch-sensitive display, a user interface 723 of the computer system 502 receiving an incoming call. For example, the user interface 723 includes information about the caller (e.g., caller name) and an accept element 722 to accept the incoming call and a decline element 717 to decline the incoming call. As shown in FIG. 7B, the bidirectional communication between the wearable audio output devices 602 and 604 and the computer system 1584 is maintained while the computer system 502 receives the incoming call. For example, the incoming call received at the computer system 502 does not interrupt the bidirectional communication 718 between the computer system 1584 and the wearable audio output devices 602 and 604. In some embodiments, the computer system 502 detects, via the touch-sensitive display 504, an input 728 directed at the accept element 722. FIG. 7C is a transition from FIG. 7B in response to the input 728. In response to the input 728, the computer system 502 accepts the incoming call.

FIG. 7C illustrates the computer system 502 displaying, via the touch-sensitive display 504, the user interface 723 of the call. The user interface 723 includes information about the caller (e.g., caller name), an end-call element 722, an audio output element 724, and a hold-call element 726. In some embodiments, the end-call element 722 ends the call, or optionally removes the user from the call (e.g., the user leaves a multi-way phone call). In some embodiments, the hold-call element 726 places the call on hold (e.g., temporarily suspending the call without disconnecting the call). In some embodiments, the audio output element 724 includes an indication of which audio output device the computer system 502 is outputting the audio associated call to. For example, as shown in FIG. 7C, the audio output element 724 includes an indication that the computer system 502 is outputting the audio associated with the call to the wearable audio output devices 602 and 604. FIG. 7C further shows inputs 736 and 738 (e.g., swipe inputs) detected at the wearable audio output devices 602 and 604 respectively. In some embodiments, in response to detecting one (or both) of the inputs 736 and 738, a corresponding operation is performed (e.g., a volume adjustment operation or an active noise management adjustment operation as described previously).

In some embodiments, in response to accepting the call received at the computer system 502, the bidirectional communication 718 between the computer system 1584 and wearable audio output devices 602 and 604 ceases, and a bidirectional communication 730 between computer system 502 and the wearable audio output devices 602 and 604 is established for communication of phone call audio 740.

In some embodiments, in response to the bidirectional communication 718 ceasing, the video conferencing application and/or the computer system 1584 disables audio capture. For example, the control element 710 for audio capture includes an indication that audio capture is disabled (e.g., the microphone of the computer system 1584 and/or the microphone of the wearable audio output devices 602 and 604 are muted). In some embodiments, selection of the control element 710 re-enables audio capture. In some embodiments, in response to the bidirectional communication 718 ceasing, the control element 716 displays an indication that audio capture is disabled. In some embodiments, selection of the control element 716 re-enables audio capture.

In some embodiments, in response to the bidirectional communication 718 ceasing, the video conferencing application and/or the computer system 1584 disables video capture. For example, the control element 712 for video capture includes an indication that video captured is disabled (e.g., a webcam is no longer capturing video data), and the computer system 1584 ceases to display the video data 708 (e.g., the display of the video data 708 is replaced with a black box, profile picture, or other data other than the video data 708). In some embodiments, selection of the control element 712 re-enables video capture. In some embodiments, in response to the bidirectional communication 718 ceasing, the video conferencing application and/or the computer system 1584 disables audio output. For example, the control element 710 for audio output includes an indication that the volume for the audio output is at 0% (e.g., muted). In some embodiments, selection of the control element 714 re-enables audio output (e.g., such that the volume of the audio output is greater than 0%).

In some embodiments, the computer system 502 detects, via the volume elements 731, an input 732 (e.g., a press input). In response to the input 732, the computer system 502 and/or the wearable audio output devices 602 and 604 decrease the volume of the phone call audio 740. In some embodiments, the computer system 502 detects, via the volume elements 733, an input 734 (e.g., a press input). In response to the input 734, the computer system 502 and/or the wearable audio output devices 602 and 604 increase the volume of the phone call audio 740.

FIG. 7D illustrates the computer system 502 detecting, via the touch-sensitive display 504, an input 742 (e.g., a tap input) directed to the end-call element 722. FIG. 7E is a transition from FIG. 7D in response to the input 742. In response to the input 742, the computer system 502 ends the call, and optionally causes the bidirectional communication 730 to cease.

FIG. 7E illustrates the computer system 502 displaying, via the touch-sensitive display 504, the user interface 721 in response to the call ending. FIG. 7E also illustrates the computer system 1584 displaying, via the display 1586 and in response to the bidirectional communication 718 resuming in accordance with a determination that the call received at the computer system 502 has ended, the application window 702, including the control element 710 displaying an indication that audio capture is enabled, the control element 712 displaying an indication that the video capture is enabled, and the control element 714 displaying an indication that audio output is enabled, in response to the call ending. In some embodiments, in response to the bidirectional communication 718 resuming, the computer system 1584 displays, via the display 1586, the control element 716 with an indication that audio capture is enabled. In some embodiments, in response to the call ending, the bidirectional communication 730 between the wearable audio output devices 602 and 604 and the computer system 502 ceases, and the bidirectional communication 718 between the wearable audio output devices 602 and 604 and the computer system 1584 (automatically) resumes. In some embodiments, in response to the bidirectional communication 718 between the wearable audio output devices 602 and 604 and the computer system 1584 resuming, the computer system 1584 enables the audio capture, the video capture, and/or the audio output.

In some embodiments, the computer system 1584 (automatically) enables the audio capture, the video capture, and/or the audio output with the same settings as the settings prior to disabling the respective functions. For example, the volume of the audio output was at 50% (see FIG. 7B) prior to the computer system 1584 disabling the audio output, and the computer system 1584 enables the audio output to the same volume level (e.g., 50%) in response to the bidirectional communication 718 between the wearable audio output devices 602 and 604 and the computer system 1584 resuming.

In some embodiments, the computer system 1584 enables the audio capture, the video capture, and/or the audio output with a default setting that is different from the respective settings prior to disabling the respective functions. For example, the volume of the audio output was at 50% prior to the computer system 1584 disabling the audio output, and the computer system 1584 enables the audio output to a default volume level (e.g., 20%) that is different from the volume level of the audio output prior to the computer system 1584 disabling the audio output. In another example, the video capture was enabled prior to the computer system 1584 disabling the respective functions, and the computer system 1584 does not enable the video capture in response to the bidirectional communication 718 resuming.

FIG. 7F illustrates a computer system 1584 displaying, via the display 1586, the user interface 701 described above with respect to FIGS. 7A and 7E. FIG. 7F further shows computer system 502, displaying, via the touch-sensitive display 504, the user interface 723. In the example of FIG. 7F, an incoming call from a person denoted as “Kenny Y.” is detected at the computer system 502, while the user is participating in the video conference as indicated by communications 718 and application window 702. The user interface 723 in FIG. 7F includes the decline control element 717 (e.g., selectable to decline the incoming call and forgo establishing an audio path with Kenny Y.) and the accept element 719 (e.g., selectable to accept the incoming call and establish an audio path with Kenny Y.). In the example of FIG. 7F, in response to detecting the incoming call, audio data corresponding to the outgoing communication 718-1 is muted, as indicated by control element 710) and audio data corresponding to the incoming communication 718-2 is muted, as indicated by control element 714. FIG. 7F further shows input 727 detected on accept element 719 (e.g., accepting the incoming call from Kenny Y.).

FIG. 7G illustrates a transition from FIG. 7F in response to detection of input 727. FIG. 7G illustrates the phone call being established between the computer system 502 and the remote device (e.g., Kenny Y.'s mobile phone). The user interface 723 includes an indication of the remote device, Kenny Y.'s mobile, and control elements 722, 724, and 726. In the example of FIG. 7G, the incoming audio for the phone call is being output by the computer system 502 and the outgoing audio is being captured by a microphone of the computer system 502, as indicated by the icon of control element 724. In this example, audio associated with the phone call is not routed to the wearable audio output devices 602 and 604. FIG. 7G further shows the user continuing to participate in the video conference as indicated by communications 718 and application window 702. In FIG. 7G, the audio data for incoming communications 718-2 is output at the wearable audio output devices 602 and 604 as the video conference audio 720 (e.g., at 50% volume as indicated by control element 714) and the audio data for outgoing communications 718-1 is unmuted for the video conference as indicated by control elements 710 and 716. FIG. 7G further shows input 725 detected at a location corresponding to control element 724.

FIG. 7H illustrates a transition from FIG. 7G in response to detection of input 725. The user interface 723 in FIG. 7H is updated to include control elements 744 and 746 corresponding to different audio output options for the phone call. The control element 744 corresponds to a speaker mode of the computer system 502. For example, activation of the control element 744 causes the computer system 502 to output audio data from the phone call in a manner in which a user does not need to hold the computer system 502 to their ear in order to hear the audio from the remote device (e.g., and optionally also adjusts operation of one or more microphones of the computer system 502 accordingly). The control element 746 corresponds routing audio of the phone call to the wearable audio output devices 602 and 604. For example, activation of control element 746 causes incoming audio communications for the phone call to be output by one or more speakers of the wearable audio output devices 602 and 604 and causes one or more microphones of the wearable audio output devices 602 and 604 to be activated to capture audio to be transmitted to the remove device (e.g., Kenny Y.'s mobile phone). In accordance with some embodiments, selection of the control element 724 in FIG. 7G causes display of available audio output options for the phone call. In accordance with some embodiments, selection of one of the control elements 724, 744, and 746 in FIG. 7H causes audio to be routed accordingly. In accordance with some embodiments, each control element includes an icon indicating the corresponding audio output device. In some embodiments, each control element includes a label indicating the corresponding audio output device. FIG. 7H further shows input 748 detected at a location corresponding to control element 746.

FIG. 7I illustrates a transition from FIG. 7H in response to detection of the input 748. In FIG. 7I, bidirectional communications 730 have been established between the wearable audio output devices 602 and 604 corresponding to the phone call with the remote device, as indicated by phone call audio 740 and control element 746. In this way, the user is able to communicate with the remote person, Kenny Y., using the wearable audio output devices 602 and 604. FIG. 7I further shows, the video conference continuing, as indicated by application window 702, but with incoming audio and outgoing audio being muted, as indicated by control elements 710, 714, and 716. The user interface 701 in FIG. 7I includes a notification 750 that the wearable audio output devices 602 and 604 are currently be used by the computer system 502 (e.g., audio from the computer system 1584 is no longer being transmitted to the wearable audio output devices). The notification 750 includes a control element 756 to reconnect the computer system 1584 with the wearable audio output devices 602 and 604 (e.g., re-establish and/or re-activate an audio path between the computer system 1584 and the wearable audio output devices). In accordance with some embodiments, the user interface 701 further includes a notification 752 indicating that a microphone for the computer system 1584 has been muted (e.g., as further indicated by control elements 710 and 716), and a notification 754 indicating that audio data of the computer system 1584 is being muted (e.g., not longer being output by a speaker of, or coupled to, the computer system). In accordance with some embodiments, the video data 708 for the user of the computer system 1584 is not shown in the application window 702 (e.g., the video data ceases to be captured, transmitted, and/or displayed in accordance with the wearable audio output devices not being communicatively connected to the video conference application). FIG. 7I further shows an input 758 detected at a location corresponding to control element 756.

FIG. 7J illustrates a transition from FIG. 7I in response to detection of the input 758. In FIG. 7J, communications 718 corresponding to the video conference have been reestablished between the wearable audio output devices 602 and 604 and the computer system 1584. Specifically, incoming communications 718-2 are output by the wearable audio output devices as indicated by video conference audio 720, and outgoing communications 718-1 are being transmitted to the remote devices of the video conference as indicated by control elements 710 and 716. The user interface 701 in FIG. 7J includes a notification 760 indicating that the wearable audio output devices 602 and 604 are reconnected to the computer system 1584 (e.g., for use in participating in the video conference). In accordance with some embodiments, the video data 708 is being displayed in the application window 702 in FIG. 7J in accordance with the wearable audio output devices being reconnected with the video conference application. The user interface 723 of the computer system 502 in FIG. 7J indicates that the phone call is in an “on hold” state in accordance with the wearable audio output devices 602 and 604 being reconnected to the computer system 1584. The appearance of the control element 726 in FIG. 7J is updated to indicate that activation of the control element 726 while the phone call is in the “on hold” state would cause the call to be resumed. In accordance with some embodiments, the appearance of the control element 746 is updated in FIG. 7J to indicate that audio corresponding to the phone call is muted. In some embodiments, an input 764 detected at a location corresponding to the control element 746 while the phone call is in the “on hold” state. In response to the input 764, a set of audio output options is displayed in the user interface 723 (e.g., the control elements 724, 744, and 746 shown in FIG. 7H). In accordance with some embodiments, in response to selection of a different audio output options (e.g., the control element 724), the phone call is transitioned to an active state (e.g., is resumed and no longer “on hold”) and audio corresponding to the phone call is unmuted. FIG. 7J also shows an input 762 detected at a location corresponding to the control element 726 while the phone call is in the “on hold” state.

FIG. 7K illustrates a transition from FIG. 7J in response to detection of the input 762. In FIG. 7K, the bidirectional communications 730 have been resumed (e.g., reestablished and/or reactivated) as indicated by phone call audio 740. In accordance with some embodiments, in response to detection of the input 762, the phone call is transitioned to an active state (e.g., is resumed and no longer “on hold”). The appearance of the control element 726 is updated in FIG. 7K to indicate that activation of the control element 726 would transition the phone call to the “on hold” state. The appearance of the control element 746 is updated in FIG. 7K to indicate audio corresponding to the phone call is no longer muted. In this way, FIG. 7K illustrates an example of rerouting audio involving the wearable audio output devices in response to a communication session (e.g., a phone call) being activated. The user interface 701 in FIG. 7K includes the notifications 750, 752, and 754 in accordance with the communications 718 in FIG. 7J ceasing (e.g., due to the audio paths for the wearable audio output devices being adjusted). The control elements 710, 712, and 714 in FIG. 7K indicate that audio and output video for the video conference have ceased to be output (e.g., audio is muted, and video is not being displayed). FIG. 7K further shows an input 766 being detected at a location corresponding to end-call element 722.

FIG. 7L illustrates a transition from FIG. 7K in response to detection of the input 766. In accordance with some embodiments, the phone call has ended (e.g., the computer system 502 has been disconnected from Kenny Y.'s mobile phone) in response to activation of the end-call element 722. FIG. 7L also shows that communications 718 have resumed between the wearable audio output devices and the computer system 1584, as indicated by video conference audio 720. The user interface 701 in FIG. 7L includes the notification 760 indicating that the wearable audio output devices have reconnected to the computer system 1584.

In the example of FIG. 7L, the control element 716 indicates that a microphone for the computer system 1584 is unmuted (e.g., audio captured by a microphone of the wearable audio output devices is being transmitted to the computer system 1584). In accordance with some embodiments, audio data corresponding to the video conference remains muted in FIG. 7L. In FIG. 7L, the control element 710 indicates that a microphone for the computer system 1584 is muted with respect to the video conference application (e.g., audio captured by a microphone of the wearable audio output devices is not provided to and/or output by the video conference application). The control element 712 in FIG. 7L indicates that video data 708 corresponding to the user is not being output by the video conference application, and the control element 714 indicates that audio data corresponding to the video conference application is not being output by a speaker for the computer system 1584 (e.g., audio from the remote person in the video conference is not being output by the wearable audio output devices).

FIGS. 8A-8D are flow diagrams illustrating method 800 for controlling active noise management in accordance with some embodiments. Method 800 is performed at a computer system (e.g., including device 300, FIG. 3A, portable multifunction device 100, FIG. 1A, wearable audio output device 301, FIG. 3I, computer system 502, computer system 1584, and/or computer system 11542) with one or more input devices (e.g., one or more buttons, switches, joysticks, click wheels, keys, microphones, sensors (e.g., image sensors, capacitive sensors, and/or other types of sensors), touch-sensitive surfaces, and/or other input elements) and one or more output generation components (e.g., one or more speakers, one or more tactile output generators, one or more display generation components such as displays, and/or projectors). The computer system is in communication (e.g., wireless or wired communication) with one or more wearable audio output devices (e.g., wearable audio output devices 301) (e.g., earbuds, a headset, and/or other type of wearable audio output device). In some embodiments, the one or more output generation components include a display, such as a touch-screen display (e.g., touch-sensitive display 504). In some embodiments, the one or more input devices comprises a touch-sensitive surface that is on or integrated with the display. In some embodiments, the display is separate from the touch-sensitive surface. Some operations in method 800 are, optionally, combined and/or the order of some operations is, optionally, changed.

The computer system is optionally an electronic device, a portable multifunction device, a laptop device, a desktop device, a wearable electronic device, or other type of computer system. In some embodiments, the computer system comprises a wearable electronic device. For example, the computer system is a watch, a wristband, an armband, a device with a head mounted display, or other type of wearable electronic device. In some embodiments, the computer system comprises a portable multifunction device. For example, the computer system is a phone, a tablet, or other type of portable device. In some embodiments, the computer system comprises a laptop device or desktop device.

As described below, method 800 includes providing a user interface that includes selectable controls for indicating and adjusting volume of audio playback and indicating and adjusting a magnitude of an active noise management function, which provides improved feedback to the user and reduces the number of inputs needed to adjust the volume of audio playback and the magnitude of the active noise management function.

While an ambient noise adjustment mode (e.g., of the computer system, e.g., computer system 502, FIG. 5C, and/or one or more wearable audio output devices that are in communication with the computer system) is in a first state (e.g., an ANC mode, an transparency mode, or other mode), the computer system causes (802) display, via the one or more output generation components (e.g., via one or more display generation components), of a first user interface (e.g., user interface 518, FIG. 5C) that includes a first control element and second control element that are concurrently displayed, the first control element (e.g., a first volume slider) (e.g., control element 520) indicating (804) a volume of audio playback at the one or more wearable audio output devices and selectable to adjust the volume of the audio playback, and the second control element (e.g., a second volume slider) (e.g., control element 522) indicating (806) a magnitude of an active noise management function (e.g., amplifying, attenuating, frequency shifting, and/or other audio adjustments) at the one or more wearable audio output devices and selectable to adjust the magnitude of the active noise management function.

In some embodiments, the active noise management function is a hearing assistance function that includes amplifying, attenuating, frequency shifting, and/or other audio adjustments based on a hearing assessment of the user. In some embodiments, the ambient noise adjustment mode is toggleable between an active noise cancellation (ANC) mode, an active transparency mode, and a passive (e.g., off) mode. In some embodiments, the user interface includes a third control element corresponding to the ambient noise adjustment mode, and the input is detected at a location corresponding to the third control element.

In some embodiments, the first control element is (808) a first type of control element and the second control element is a second type of control element, where the first type of control element is a continuous control element, and the second type of control element is segmented control element. In some embodiments, the first type of control element comprises a continuous volume slider and the second type of control element comprises a segmented volume slider, examples of which are shown in FIGS. 5C-5F. In some embodiments, the first type of control element allows for more fine adjustment than the second type of control (e.g., allowing magnitude of volume of audio playback to be controlled in steps of, or with a level of precision, of 0.5 decibels (dB), 1 dB, 2 dB, or other amount of dB) as compared to the second type of control element (e.g., allowing magnitude to be controlled in steps of, or with a level of precision, of 2 dB, 5 dB, or other amount of dB). In some embodiments, the second type of control element has different visual properties (e.g., a different color, shape, segmentation, shading, and/or other visual property) from the first type of control element. Providing different types of control elements for different functions allows a user to distinguish between the control elements more easily, and provides feedback to the user about how each function may be controlled (e.g., adjusted).

In some embodiments, prior to causing display of the first user interface, the computer system causes (810) display, via the one or more output generation components (e.g., one or more display generation components), of a second user interface (e.g., control user interface 506, FIG. 5A) that includes the first control element (e.g., control element 512) without including the second control element (e.g., control element 522). In some embodiments, the first user interface is an audio control interface for the computer system and/or the one or more wearable audio output devices. In some embodiments, the first user interface is displayed in response to selection of an audio element in a control center user interface (e.g., an audio element, such as control element 512, in the second user interface). In some embodiments, the audio element in the control center user interface indicates the volume of audio playback at the one or more wearable audio output devices. Providing a second user interface that includes the first control element, but without the second control element, enables volume adjustment to be performed and provides feedback about a state of the computer system and/or the wearable audio output devices without displaying additional audio controls that may not be needed by the user, thereby reducing user interface complexity and improving both user and device efficiency.

The computer system detects (812), via the one or more input devices (e.g., touch-sensitive display 504), a first input (e.g., a selection input, a tap input, a tap-and-hold input, a swipe input, a movement input, or other type of input) (e.g., input 554, FIG. 5D) for adjusting the ambient noise adjustment mode (e.g., the first input is detected at a location corresponding to control element 524) of the computer system and/or one or more wearable audio output devices. In one example, the input triggers an ambient noise adjustment function that activates a transparency mode (or pass-through mode or non-noise canceling mode) that allows the user to hear audio (e.g., sometimes called ambient sound or ambient noise) from the physical environment. In some embodiments, when ambient sound from the physical environment is being actively passed through, noise-cancellation is disabled.

In response to detecting the first input, the computer system sets (814) the ambient noise adjustment mode to a second state (e.g., a transparency mode) and continues to display the first user interface, including continuing to concurrently display the first control element and the second control element. In some embodiments, the first input triggers an ambient noise adjustment function that activates an active noise control mode (sometimes called an ANC mode) and the wearable audio output device(s) outputs one or more audio-cancelling audio components (e.g., one or more antiphase audio signals, also called “audio-cancellation audio components”) to at least partially cancel ambient sound from the surrounding physical environment that would otherwise be perceivable to the user. In some embodiments, when noise cancellation is enabled, little or no ambient sound from the physical environment is actively passed through by the one or more wearable audio output devices to the user) for at least a portion of the audio spectrum or a majority of the audio spectrum. In some embodiments, an ambient sound waveform is detected by one or more microphones of the wearable audio output device(s), and an antiphase (or partially antiphase) audio signal waveform is produced by the wearable audio output device(s) to at least partially cancel the ambient sound waveform.

In some embodiments, while the second user interface is displayed, the computer system detects (816), via the one or more input devices, a second input (e.g., input 516, FIG. 5B) at a location corresponding to the first control element. In response to detecting the second input and in accordance with a determination that the second input is a first type of input (e.g., a selection input, a tap input, a tap-and-hold input, a swipe input, a movement input, or other type of input on or directed to the first control element), the computer system adjusts (818) the volume of audio playback. For example, a user may adjust the volume of audio playback via the second user interface or the control center user interface (e.g., without causing display of the second control element). Selectively performing volume adjustment based on a type of the input allows for multiple operations to be performed according to the type of input, which reduces the number of inputs needed to adjust volume and enables volume adjustment to be performed without displaying additional controls.

In some embodiments, in response to detecting the second input and in accordance with a determination that the second input is a second type of input (e.g., a type of input different from the first type of input, such as selection input, a tap input, a tap-and-hold input, a swipe input, a movement input, or other type of input at a location corresponding to the first control element), the computer system causes (820) display of the first user interface (e.g., user interface 518). As an example, FIGS. 5B and 5C illustrate a transition from control user interface 506 to user interface 518 in response to input 516. For example, in response to a swipe input detected by the computer system while displaying the second user interface, the volume of audio playback is adjusted (e.g., in accordance with movement of the swipe input) and, in response to a tap input detected by the computer system while displaying the second user interface, the first user interface is displayed. Selectively performing volume adjustment or navigation based on a type of input allows for multiple operations to be performed according to the type of input, which reduces the number of inputs needed to adjust volume or display user interfaces and enables volume adjustment and display of user interfaces to be performed without displaying additional controls.

In some embodiments, the second user interface comprises (822) a control user interface that includes a plurality of controls (e.g., control elements 508, FIG. 5A) for controlling different functions (e.g., a plurality of system functions and/or application functions) of the computer system. In some embodiments, the control user interface includes respective user interface elements, sometimes called control elements, for a set of system properties. For example, the set of system properties optionally includes one or more of audio properties, display properties, privacy properties, connectivity properties, and media playback properties. In some embodiments, the control user interface is displayed in response to a swipe gesture on a home screen user interface of the computer system. Providing a user interface that includes multiple controls for different functions reduces the need to navigate multiple user interfaces and reduces the number of inputs needed to activate the different functions.

In some embodiments, the first user interface further includes (824) one or more user interface elements (e.g., control elements 524, 525, and 526, FIG. 5C) selectable to adjust other respective audio properties (e.g., other audio output properties). In some embodiments, the first control element and the second control element are first types of elements, and the one or more user interface elements are other types of elements. For example, the first and second control elements are sliders, and the one or more user interface elements are selectable icons. In some embodiments, a respective selectable icon, or each selectable icon, in the first user interface is configured to expand in response to a user selection to provide additional information about the corresponding audio property and enable the user to adjust the corresponding audio property. Providing a user interface that includes multiple controls for respective audio properties reduces the need to navigate multiple user interfaces and reduces the number of inputs needed to adjust the respective audio properties.

In some embodiments, the one or more user interface elements include (826) a first user interface element (e.g., control element 524, FIG. 5C) for adjusting a current noise management mode between a plurality of different modes (e.g., switching whether one or more audio output devices are operating in an active noise-cancellation mode, an active transparency mode, an adaptive mode where the one or more audio output devices are switched dynamically between the active noise-cancellation mode and the active transparency mode based on contextual information, or a neutral mode in which neither active noise-cancellation nor active transparency are occurring). In some embodiments, the first user interface element indicates a current state (or mode) of an ambient noise adjustment function of the computer system and/or one or more wearable audio output devices and is selectable to adjust the current state (or mode) of the ambient noise adjustment function. For example, the current state of the ambient noise adjustment function is, optionally, one of an active transparency mode, an active noise cancellation mode, an adaptive mode, or off. In some embodiments, a first type of input (e.g., a tap input, a swipe input, or other type of input) on or directed to the first user interface element causes an adjustment to the current state of the ambient noise adjustment function, and a second type of input (e.g., a tap-and-hold input, a double tap input, or other type of input) on or directed to the first user interface element causes additional information about and/or options for changing the current state of the ambient noise adjustment to be displayed in the first user interface. In some embodiments, causing the additional information about and/or the options for changing the current state of the ambient noise adjustment to be displayed comprises ceasing to display one or more other user interface elements (e.g., a user interface element for spatial audio control). Providing a user interface that includes multiple controls for respective audio properties, including a control to switch noise management modes, reduces the need to navigate multiple user interfaces and reduces the number of inputs needed to switch noise management modes.

In some embodiments, the one or more user interface elements include (828) a second user interface element (e.g., control element 526, FIG. 5C) for adjusting a current spatial audio mode. In some embodiments, the second user interface element indicates a current spatial audio mode and is selectable to adjust the current spatial audio mode. For example, the current spatial audio mode is, optionally, one or a fixed spatial audio mode, a head tracking spatial audio mode, or an “off” mode (e.g., a mode in which spatial audio is disabled). In some embodiments, a first type of input (e.g., a tap input, a swipe input, or other type of input) on or directed to the second user interface element causes an adjustment to the current spatial audio mode, and a second type of input (e.g., a tap-and-hold input, a double tap input, or other type of input) on or directed to the second user interface element causes additional information about and/or options for changing the current spatial audio mode to be displayed in the first user interface. In some embodiments, causing the additional information about and/or the options for changing the current spatial audio mode to be displayed comprises ceasing to display one or more other user interface elements (e.g., a user interface element for ambient noise adjustment). Providing a user interface that includes multiple controls for respective audio properties, including a control to adjust a spatial audio mode, reduces the need to navigate multiple user interfaces and reduces the number of inputs needed to adjust the spatial audio mode.

In some embodiments, the one or more user interface elements include (830) a third user interface element (e.g., control element 525, FIG. 5C) for adjusting a current speech detection mode. In some embodiments, the third user interface element indicates a current speech detection mode and is selectable to adjust the current speech detection mode. For example, the current speech detection mode is, optionally, on or off. For example, while the speech detection mode is enabled, detecting speech (e.g., detected by the computer system and/or one or more wearable audio output devices) causes a change in the modification of ambient sound (e.g., a degree of active noise cancellation or a degree of active transparency), and while the speech detection mode is disabled, detecting speech does not cause a change in the modification of the ambient sound (e.g., a degree of active noise cancellation or a degree of active transparency) or, alternatively, speech is not detected (e.g., not actively detected). As an example, while the speech mode is disabled, speech in the physical environment is not identified/recognized by the computer system and/or one or more wearable audio output devices. Providing a user interface that includes multiple controls for respective audio properties, including a control to adjust a speech detection mode, reduces the need to navigate multiple user interfaces and reduces the number of inputs needed to adjust the speech detection mode.

In some embodiments, a first type of input (e.g., a tap input, a swipe input, or other type of input) on or directed to the third user interface element causes an adjustment to the current speech detection mode, and a second type of input (e.g., a tap-and-hold input, a double tap input, or other type of input) on or directed to the third user interface element causes additional information about and/or options for changing the current speech detection mode to be displayed in the first user interface (e.g., as illustrated by input 550 directed to control element 525 in user interface 518 in FIG. 5D). In some embodiments, causing the additional information about and/or the options for changing the current speech detection mode to be displayed comprises ceasing to display one or more other user interface elements (e.g., a user interface element for ambient noise adjustment).

In some embodiments, a user interface for changing between noise management modes (e.g., a user interface that is displayed in response to detecting selection of the first user interface element) includes (832) one or more options for switching between a plurality of the noise management modes (e.g., control elements 558, 560, and 562, FIG. 5E). In accordance with a determination that active noise management is allowed to be disabled for the one or more wearable audio output devices (e.g., based on a setting of a control or system setting for the computer system or the one or more audio output devices), the plurality of noise management modes for which options are displayed includes (834) an option for disabling active noise management (e.g., selecting a neutral mode in which neither active noise-cancellation nor active transparency are enabled or applied to ambient sound). In accordance with a determination that active noise management is not allowed to be disabled for the one or more wearable audio output devices (e.g., based on a setting of a control or system setting for the computer system or the one or more audio output devices), the plurality of noise management modes for which options are displayed does not include (836) the option for disabling active noise management. In some embodiments, the user interface for changing between noise management modes does not include an option to disable the active noise management function. In some embodiments, the option to disable the active noise management function is displayed in an accessibility user interface. In some embodiments, the selectable control element configured to disable the active noise management function is selectively displayed in the user interface for changing between noise management modes according to a user preference setting. In some embodiments, the user preference setting is based on a toggleable setting in an accessibility user interface. Selectively displaying the option to disable active noise management reduces the likelihood of users mistakenly and/or inadvertently disabling active noise management, which improves user satisfaction and reduces the risk of the user inadvertently disabling the active noise management, which, in turn, reduces the risk of the user suffering hearing damage due to loud environmental noises.

In some embodiments, while displaying a user interface (e.g., user interface 566, FIG. 5G) that includes a control (e.g., control element 572) for determining whether active noise management is allowed to be disabled, the computer system detects (838), via the one or more input devices, a sequence of one or more inputs (e.g., a tap input, a tap-and-hold input, or other type of input) (e.g., input 579, FIG. 5I) directed to the control for determining whether active noise management is allowed to be disabled. In response to detecting the sequence of one or more inputs directed to the control for determining whether active noise management is allowed to be disabled, and in accordance with a determination that a respective input (e.g., fourth input) corresponds to an operation to allow active noise management to be disabled, the computer system causes display (840) of a warning (e.g., warning 598, FIG. 5J) that disabling the active noise management will prevent the audio output devices from suppressing loud sounds. Providing a warning in response to a user disabling the active noise management or enabling display of the option to disable the active noise management provides feedback about a state of the computer system and reduces the risk of the user inadvertently suffering hearing damage due to loud environmental noises.

In some embodiments, the second control element is (842) displayed in accordance with the noise management function being enabled. For example, FIGS. 5O and 5P illustrate second control element 522 being displayed in accordance with the active transparency mode being enabled. The computer system detects (844), via the one or more input devices, a third input (e.g., an input on control element 1518, FIG. 5P). In response to detecting the third input and in accordance with a determination that the third input corresponds to an operation to adjust the currently active noise management mode to a disabled mode, the computer system ceases (846) to cause display of the second control element (e.g., control element 522) in the first user interface (e.g., as illustrated in FIG. 5O). In some embodiments, the second control element is displayed only while the active noise management function is enabled. In some embodiments, while the active noise management function is disabled, a different control is displayed in the first user interface, the different control selectable to enable the active noise management function (e.g., selectable to toggle the state (e.g., enablement) of the active noise management function). In some embodiments, in response to enabling the active noise management function, the second control element is displayed in the first user interface. Selectively displaying the second control element according to whether the noise management function is enabled reduces the number of control elements that need to be displayed, thereby reducing the cognitive burden on the user.

In some embodiments, the computer system enables (848) the active noise management function in accordance with the computer system having access to information (e.g., medical information or hearing information) that indicates that, based on an external medical evaluation (e.g., a test result, as illustrated in FIG. 5Q), hearing assistance is recommended for a user of the computer system. In some embodiments, the medical information is, or includes, the results of a hearing test or other type of medical examination. In some embodiments, the medical information is uploaded to the computing system by the user. In some embodiments, the medical information is obtained from another device (e.g., a server system, a medical device, a server that has access to a set of one or more medical records for the user, or other type of device). In some embodiments, an option is displayed at the computer system (e.g., via a system settings user interface, an audio user interface, an accessibility user interface, or other type of user interface) for the user to upload hearing information, and the hearing information is obtained in accordance with the user selecting the option. In some embodiments, enabling the active noise management function comprises modifying sounds at audio frequencies for which hearing assistance is recommended (e.g., indicated by the hearing information). For example, the medical information may indicate certain audio frequencies are difficult for the user to hear and the active noise management function may amplify, magnify, shift, and/or otherwise modulate those frequencies. As another example, other audio frequencies are, optionally, filtered, reduced, and/or otherwise modulated (e.g., so that the user may better hear the certain audio frequencies). Selectively enabling the active noise management function according to the computer system having access to information that indicates that hearing assistance is recommended causes the computer system to automatically enable the active noise management function, thereby reducing the number of inputs needed to enable the active noise management function.

In some embodiments, the computer system causes (850) performance of an audio evaluation of a user of the computer system (e.g., in response to input 1562, FIG. 5Q). In accordance with a determination that the audio evaluation indicates that hearing assistance is recommended (e.g., after or in response to detecting the audio evaluation), the computer system enables (852) (e.g., automatically enables) the active noise management function. In some embodiments, the audio evaluation is performed in response to a user selecting a user interface element configured to initiate the audio evaluation. For example, the user interface element is, optionally, displayed in a system settings user interface, an audio user interface, an accessibility user interface, or other type of user interface. In some embodiments, the audio evaluation is configured to test the user's hearing of different audio frequencies. For example, the audio evaluation includes playback of audio tones with different audio characteristics (e.g., frequency, volume, and/or other audio characteristics), and receiving feedback from the user as to whether or not the user can hear each of the audio tones with different audio characteristics. In some embodiments, enabling the active noise management function comprises modifying sounds at audio frequencies according to results of the audio evaluation. In some embodiments, in accordance with a determination that the audio evaluation indicates that hearing assistance is not recommended (e.g., after or in response to detecting the audio evaluation), the computer system and/or one or more wearable audio output devices forgoes automatically enabling the active noise management function. Selectively enabling the active noise management function according to the computer system determining that hearing assistance is recommended causes the computer system to automatically enable the active noise management function when predefined hearing assistance criteria are satisfied, thereby reducing the number of inputs needed to enable the active noise management function.

It should be understood that the particular order in which the operations in FIGS. 8A-8D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900 and 1000) are also applicable in an analogous manner to method 800 described above with respect to FIGS. 8A-8D. For example, the inputs, controls, and user interfaces described above with reference to method 800 optionally have one or more of the characteristics of the inputs, controls, and user interfaces described herein with reference to other methods described herein (e.g., methods 900 and 1000). For brevity, these details are not repeated here.

FIGS. 9A-9I are flow diagrams of method 900 for adjusting volume and/or active noise management in accordance with some embodiments. Method 900 is performed at a computer system (e.g., including device 300, FIG. 3A, portable multifunction device 100, FIG. 1A, and/or wearable audio output device 301, FIG. 3I) with one or more input devices (e.g., one or more buttons, switches, joysticks, click wheels, keys, microphones, sensors (e.g., image sensors, capacitive sensors, and/or other types of sensors), touch-sensitive surfaces, and/or other input elements), one or more audio output components (e.g., speakers, transducers, and/or other types of audio output components), and optionally one or more output generation components. In some embodiments, the one or more output generation components include a display, such as a touch-screen display. In some embodiments, the one or more input devices comprises a touch-sensitive surface that is on or integrated with the display. In some embodiments, the display is separate from the touch-sensitive surface. Some operations in method 900 are, optionally, combined and/or the order of some operations is, optionally, changed.

As described below, method 900 includes selectively adjusting output volume of audio content or one or more parameters of an active noise management function in response to a first type of input based on whether one or more noise management criteria are met, which provides additional control options without cluttering a user interface with additional displayed controls, and reduces the number of inputs needed to perform each operation.

The computer system detects (902) a first input (e.g., input 612, FIG. 6B) via the one or more devices (e.g., a tap input, a tap-and-hold input, a swipe input, a rotation of a rotatable input mechanism, or other type of input). An example computer system is an electronic device, a portable multifunction device, a laptop device, a desktop device, a wearable electronic device, an audio output device such as an earbud or pair of headphones, or other type of computer system. In some embodiments, the one or more input devices include an input device configured to detect inputs based on touch (e.g., a capacitive touch sensor) and/or pressure (e.g., a force sensor). In some embodiments, the one or more input devices include an accelerometer (e.g., configured to detect taps a housing of the computer system, shaking of the computer system, and/or other types of inputs). In some embodiments, the one or more input devices include a knob and/or dial device.

In some embodiments, the computer system is a wearable audio output device (e.g., an earbud, headphones, or other type of wearable audio output device). For example, the computer system optionally includes wearable audio output devices 301 (e.g., wearable audio output device 602 and a wearable audio output device 604). In some embodiments, the computer system is a companion device (e.g., portable multifunction device 100) that is communicatively coupled to one or more wearable audio output devices and optionally controls at least a subset of the functions of the wearable audio output device(s) and/or provides processing to enable one or more capabilities of the wearable audio output device(s). In some embodiments, audio content of a respective type is selected, generated, and/or managed via a user interface of a companion device. In some embodiments, audio content of the respective type is selected, generated, and/or managed via a user interface of a wearable audio output device. In some embodiments, the computer system is a wearable audio output device, and the first input is detected while the wearable audio output device is being worn by a user of the wearable audio output device.

In response to detecting the first input (904) and in accordance with a determination that the first input is a first type of input and audio content of a respective type of audio content (e.g., user-selected audio content that is not based on environmental audio, where the user-selected audio content includes one or more of music, a podcast, a radio show, an audio book, a phone call, video chat audio, tv audio, movie audio, video audio, or the like) is being output (e.g., the music playing in FIG. 6C) by the one or more audio output components, the computer system adjusts (906) an output volume of the audio content being output via the one or more audio output components (e.g., adjusts the output volume in accordance with movement, magnitude, location, and/or other attributes of the first input) (e.g., FIGS. 6A-6C illustrate the output volume increasing in response to input 612).

In response to detecting the first input (904) and in accordance with a determination that the first input is the first type of input and that one or more noise management criteria are met, the computer system adjusts (908) one or more parameters of an active noise management function (e.g., adjusting a magnitude, a tuning, and/or other parameter of the active noise management function in accordance with movement, magnitude, location, and/or other attributes of the first input). For example, FIGS. 6G-6I illustrate a magnitude of the active noise management function increasing from magnitude 608 to magnitude 638 in response to the input 634 at wearable audio output device 604. In some embodiments, the one or more noise management criteria include a criterion that a noise management function is active (e.g., that a noise management state is active). In some embodiments, the one or more noise management criteria include a criterion that the audio output devices are mounted on and/or inserted in a user's ear(s). The one or more noise management criteria include (910) a criterion that is met when (e.g., even when) the respective type of audio content is not being output by the one or more audio output components (e.g., the audio output components are not outputting content other than noise management audio effects such as active passthrough and/or active noise cancellation audio effects).

In some embodiments, adjusting the one or more parameters of the active noise management function comprises (912) adjusting a degree of active transparency. For example, FIGS. 6G-6I illustrate a magnitude of the active noise management function increasing from magnitude 608 to magnitude 638 in response to the input 634 while the transparency mode is active (e.g., corresponding to adjusting the degree of active transparency). In some embodiments, increasing the degree of active transparency includes enabling an active transparency mode. In some embodiments, adjusting the one or more parameters of the active noise management function comprises switching from a noise cancellation mode to an active transparency mode. In some embodiments, increasing the degree of active transparency comprises increasing an amplification factor for ambient sound from the physical environment from a first value that is below a threshold to a second value that is above the threshold (e.g., the threshold being 0.5, 0.75, or 1). In some embodiments, increasing the degree of active transparency comprises increasing the active transparency from below a threshold percentage (e.g., 15%, 20%, 30%, or 50%) to above the threshold percentage. In an example, detecting the first input includes detecting speech, and in response to detecting speech, the degree of active transparency is increased from an initial ambient-sound audio level of 10%, 20%, or 35% to an adjusted ambient-sound audio level of 80%, 75%, 70%, or 50%. Selectively adjusting a degree of active transparency based on a type of input (e.g., speech) and noise management criteria enables a user to perform the operation automatically, without requiring additional inputs or displaying additional controls. Additionally, performing the operation based on the type of input and noise management criteria provides the user with an intuitive and efficient man-machine interface.

In some embodiments, adjusting the one or more parameters of the active noise management function comprises (914) adjusting a degree of active noise cancellation. For example, FIG. 6Q illustrates a magnitude 652 of the active noise management function while the noise cancellation mode is active. As an example, an input adjusting the active noise management function while the noise cancellation mode is active causes an adjustment to the degree of active noise cancellation. In some embodiments, decreasing the degree of active noise cancellation (ANC) comprises disabling the ANC mode. In some embodiments, decreasing the degree of ANC comprises reducing the ANC from above a threshold percentage (e.g., 90%, 80%, 75%, or 50%) to below the threshold percentage. For example, prior to detecting speech, the ANC reduces the ambient sound to an ambient-sound audio level of 20%, 10%, or 5% and, in response to detecting speech, the ANC reduces the ambient sound to an ambient-sound audio level of 80%, 75%, 70%, or 50%. Selectively adjusting a degree of active noise cancellation based on a type of input and noise management criteria enables a user to perform the operation without requiring additional inputs or displaying additional controls. Additionally, performing the operation based on the type of input and noise management criteria provides the user with an intuitive and efficient man-machine interface.

In some embodiments, the first input comprises (916) a swipe input (e.g., input 612, FIG. 6B) on a portion of the computer system (e.g., on a housing, on a touch-sensitive surface, or on a display of the computer system). For example, the first input is detected at a portion of the housing incorporating and/or encasing the one or more input devices. In some embodiments, the housing includes physically distinguished portion(s) (e.g., indentations, grooves, ridges, and/or other types of physically-distinguished portions) to indicate respective input devices. Selectively adjusting an output volume or one or more parameters of an active noise management function in response to detecting a swipe input reduces the number of inputs needed to adjust the output volume or the one or more parameters of the active noise management function and enables a user to perform these operations without needing to power a display component or display user interface elements.

In some embodiments, the computer system comprises (918) a plurality of wearable audio output devices (e.g., a pair of earbuds) (e.g., two wearable audio output devices 301), including a first wearable audio output device (e.g., wearable audio output device 602) and a second wearable audio output device (e.g., wearable audio output device 604). The first wearable audio output device includes (920) a first subset of the one or more input devices (e.g., input device(s) 328) and a first subset of the one or more audio output components (e.g., audio speakers 326). The second wearable audio output device includes (922) a second subset of the one or more input devices (e.g., input device(s) 328) and a second subset of the one or more audio output components (e.g., audio speakers 326). The swipe input is detected (924) at a first subset of the one or more input devices (e.g., the swipe is detected at wearable audio output device 604 as shown in FIG. 6B or is detected at wearable audio output device 602 as shown in FIG. 6L). In some embodiments, the plurality of wearable audio output devices are communicatively coupled and configured to respond to inputs detected at any one of the wearable audio output devices. For example, a swipe gesture detected at either a right earbud or a left earbud causes an output volume adjustment at both earbuds. The computer system detects (926) a second input (e.g., a tap input, a tap-and-hold input, a swipe input, or other type of input) via the second subset of one or more input devices (e.g., a swipe is detected at wearable audio output device 602 as shown in FIG. 6L or at wearable audio output device 604 as shown in FIG. 6B). In response to detecting the second input (928) and in accordance with a determination that the second input is the first type of input and in accordance with a determination that audio content of a respective type of audio content is being output by the one or more audio output components (e.g., user-selected audio content that is not based on environmental audio, where the user-selected audio content includes one or more of music, a podcast, a radio show, an audio book, a phone call, video chat audio, tv audio, movie audio, video audio, or the like), the computer system adjusts (930) an output volume of the audio content being output via the one or more audio output components (e.g., adjusting the output volume in accordance with movement, magnitude, location, and/or other attributes of the first input). In response to detecting the second input (928) and in accordance with a determination that the second input is the first type of input and in accordance with a determination that one or more noise management criteria are met, the computer system adjusts (932) one or more parameters of an active noise management function (e.g., adjusting a magnitude, a tuning, and/or other parameter of the active noise management function in accordance with movement, magnitude, location, and/or other attributes of the first input). The one or more noise management criteria include (934) a criterion that is met when the respective type of audio content is not being output by the one or more audio output components (e.g., the audio output components are not outputting content other than noise management audio effects such as active passthrough and/or active noise cancellation audio effects). Selectively adjusting the output volume of the audio content or adjusting one or more parameters of an active noise management function in response to inputs at either of a set of wearable audio output devices enables a user to perform the operation without requiring the user to perform the action at a particular wearable audio output device (e.g., without requiring the user to perform the action with a particular hand) thereby making the user interface more intuitive and convenient to use.

In some embodiments, the computer system includes two or more wearable audio output devices (e.g., earbuds, headphones, and/or other types of wearable audio output devices). In some embodiments, an input detected at a first wearable audio output device is communicated to a second wearable audio output device to cause the second wearable audio output device to perform a same function as the first wearable audio output device (e.g., changing the audio output volume or changing the parameter(s) of the noise management function). For example, a volume adjustment input detected at one device causes both devices to adjust the volume. In some embodiments, two or more wearable audio output devices are synchronized (e.g., using one or more wireless synchronization protocols and/or other types of synchronization) such that a change in response to an input is performed concurrently at both wearable audio output devices.

In some embodiments, communicatively coupling a first device and a second device comprises establishing a wired or wireless connection between the first device and the second device. In some embodiments, the first device and the second device are communicatively coupled via a direct connection, while in other embodiments, the first device and the second device are communicatively coupled via one or more communication networks (e.g., a public broadcast network). For example, communicatively coupling the first and second devices may include forming a wireless peer-to-peer connection (e.g., a direct Wi-Fi™ connection or a Bluetooth™ connection). In some embodiments, communicatively coupling the first device and the second device comprises pairing the first device and the second device (e.g., exchanging information between the first device and the second device that enable the first device and the second device to communicate with each other). In some embodiments, communicatively coupling the first device and the second device comprises forming an audio path between the first device and the second device. In some embodiments, communicatively coupling the first device and the second device comprises establishing one or more wireless connections and/or one or more wired connections between the first device and the second device. In some embodiments, the first and second devices are communicatively coupled using one or more communication protocols (e.g., a Wi-Fi protocol, a Bluetooth protocol, and/or other type of communication protocol). In some embodiments, the first and second devices are communicatively coupled using respective radio components (e.g., RF circuitry 108, FIG. 1A).

In some embodiments, adjusting the output volume of the audio content in accordance with the determination that the first input is the first type of input and in accordance with the determination that audio content of the respective type of audio content is being output by the one or more audio output components comprises (936) adjusting the output volume of the audio content at both the first wearable audio output device and the second wearable audio output device. For example, FIGS. 6A-6C illustrate the output volume increasing at both wearable audio output device 602 and 604 in response to input 612 at wearable audio output device 604. In some embodiments, adjusting the one or more parameters of the active noise management function in accordance with a determination that the second input is a first type of input and in accordance with a determination that the one or more noise management criteria are met comprises (938) adjusting the one or more parameters of the active noise management function for both the first audio output device and the second audio output device. In some embodiments, a first type of command (e.g., an audio content volume adjustment, an ambient noise adjustment, or other type of command) is executed at each wearable audio output device and a second type of command (e.g., an accessibility modification, a relative magnification adjustment, or other type of command) is executed only at the wearable audio output device that detected the input that triggered the command. Adjusting the volume at each of a set of wearable audio output devices in response to an input at a single wearable audio output device enables a user to perform the operation without requiring the user to perform the action at a particular wearable audio output device and without having to repeat the action at multiple wearable audio output devices.

In some embodiments, in response to detecting the first input and in accordance with a determination that the first input is a second type of input, the computer system changes (940) a playback state of the audio content. As an example, FIGS. 6C-6E illustrate music playback being paused in response to input 618 (e.g., a tap input). For example, the second type of input is, optionally, a tap input, a double tap input, a tap-and-hold input, or other type of input. Changing the playback state of the audio content optionally includes pausing or stopping audio content that was being played back (e.g., outputted by the one or more audio output components) prior to detecting the first input. Changing the playback state of the audio content optionally includes starting to play (e.g., resuming playing) audio content that was not being played back (e.g., was paused, stopped, or not yet initiated) prior to detecting the first input. Selectively changing a playback state of audio content and an output volume of the audio content based on a type of input reduces the number of inputs needed to change the playback state or adjust the output volume and enables the operations to be performed without displaying additional controls.

In some embodiments, after changing the playback state of the audio content, the computer system detects (942), via the one or more input devices, a third input (e.g., the input 656, FIG. 6N, or the input 648, FIG. 6L) of the first type (e.g., a tap input, a tap-and-hold input, a swipe input, a rotation of a rotatable input mechanism, or other type of input). In response to detecting the third input (944) and in accordance with a determination that audio content of the respective type of audio content is being output by the one or more audio output components, and that more than a first threshold amount of time (e.g., threshold amount of time 628) has elapsed since the playback state of the audio content was changed, the computer system adjusts (946) an output volume of the audio content being output via the one or more audio output components (e.g., adjusting the output volume in accordance with movement, magnitude, location, and/or other attributes of the first input). As an example, FIG. 6N illustrates input 656 being detected after amount of time 658 (greater than threshold amount of time 628) has elapsed since the playback state of the audio content was changed and FIG. 6O illustrates a corresponding change in output volume. In response to detecting the third input (944) and in accordance with a determination that audio content of the respective type of audio content is being output by the one or more audio output components, and that less than the first threshold amount of time has elapsed since the playback state of the audio content was changed, the computer system adjusts (948) one or more parameters of the active noise management function (e.g., adjusting a magnitude, a tuning, and/or other parameter of the active noise management function in accordance with movement, magnitude, location, and/or other attributes of the first input). As an example, FIG. 6L illustrates input 648 being detected after amount of time 650 (less than threshold amount of time 628) has elapsed since the playback state of the audio content was changed and FIG. 6M illustrates a corresponding change in the active noise management function. Selectively adjusting output volume and one or more parameters of the active noise management function with a same type of input based on whether or not certain criteria are met, reduces the number of inputs needed to perform these operations and enables these operations to be performed without displaying additional controls.

In some embodiments, after changing the playback of the audio content, the computer system detects (950) a fourth input (e.g., another instance of the third input or a different input similar to the third input) of the first type (e.g., a tap input, a tap-and-hold input, a swipe input, a rotation of a rotatable input mechanism, or other type of input). In response to detecting the fourth input (952) and in accordance with a determination that the one or more noise management criteria are met, and that more than a second threshold amount of time has elapsed since the playback state of the audio content was changed, the computer system adjusts (954) one or more parameters of the active noise management function (e.g., adjusting a magnitude, a tuning, and/or other parameter of the active noise management function in accordance with movement, magnitude, location, and/or other attributes of the input). As an example, FIG. 6H illustrates input 634 being detected after amount of time 636 (greater than threshold amount of time 628) and FIG. 6I illustrates a corresponding change in the active noise management function magnitude. In response to detecting the fourth input (952) and in accordance with a determination that the one or more noise management criteria are met, and that less than a threshold amount of time has elapsed since the playback state of the audio content was changed, the computer system forgoes (956) adjusting one or more parameters of the active noise management function (and, optionally, adjusting an output volume of the one or more audio output components, for example, adjusting the output volume in accordance with movement, magnitude, location, and/or other attributes of the first input, that will optionally take effect the next time audio of the respective type is being output by the one or more audio output components). As an example, FIG. 6F illustrates input 624 being detected after amount of time 626 (less than threshold amount of time 628) and FIG. 6G illustrates a corresponding change in output volume. Selectively adjusting the output volume or parameter(s) of the active noise management function based on certain criteria and a delay timer makes the man-machine interface more intuitive and reduces the execution of inadvertent and unintentional commands.

For example, the first threshold amount of time and/or the second threshold amount of time is, optionally, a period having a duration between 0.5 and 3 seconds, such as 1 second or 2 seconds, or other amounts of time. As an example, a swipe input detected during playback of audio content or detected when less than the first threshold amount of time has elapsed after ceasing playback of the audio content, causes an output volume of the audio content to be adjusted. In this example, a swipe input after more than the first threshold amount of time has elapsed since ceasing playback of the audio content causes one or more parameters of an active noise management function to be adjusted (e.g., instead causing the output volume adjustment). In this example, the swipe input detected less than the first threshold amount of time since ceasing playback of the audio content does not cause the one or more parameters of the active noise management function to be adjusted. In some embodiments, the duration of the first threshold amount of time and/or the second threshold amount of time is based on one or more explicit and/or implicit user preferences.

In some embodiments, while audio content is being played back (e.g., via the one or more output generation components) and after adjusting the output volume of the audio content, the computer system detects (958) a second input (e.g., input 618, FIG. 6D) via the one or more input devices (e.g., a tap input, a tap-and-hold input, a swipe input, a rotation of a rotatable input mechanism, or other type of input). In response to detecting the second input and in accordance with a determination that the second input is a second type of input that is different from the first type of input (e.g., a tap input, a double tap input, a tap-and-hold input, or other type of input), the computer system causes (960) the audio content to cease to be played back (e.g., via the one or more output generation components) (e.g., as illustrated by paused status 620 in FIG. 6E). After causing the audio content to cease to be played back, the computer system detects (962) a third input via the one or more input devices (e.g., a tap input, a tap-and-hold input, a swipe input, a rotation of a rotatable input mechanism, or other type of input). In response to detecting the third input and in accordance with a determination that the third input is the first type of input (and that more than a prescribed threshold amount of time has elapsed since the audio playback state was changed), the computer system adjusts (964) the one or more parameters of the active noise management function. For example, FIG. 6H shows input 634 being detected after amount of time 636, greater than threshold amount of time 628, since audio playback ceased, and FIG. 6I shows a corresponding change in magnitude of the active noise management function. In some embodiments, in response to detecting the second input and in accordance with a determination that the second input is not the second type of input, the computer system forgoes causing the audio content to cease to be played back at the computer system. In some embodiments, in response to detecting the third input and in accordance with a determination that the third input is not the first type of input, the computer system forgoes adjusting the one or more parameters of the active noise management function. In some embodiments, the second input is detected via a different input device (or different sets of input devices) than the third input (e.g., the second input and third input are detected at different wearable audio output devices). In some embodiments, the magnitude (e.g., amount) and/or direction (e.g., attenuation and/or amplification) of the adjustments of the one or more parameters of the active noise management function are based on the magnitude and/or direction of the input. Selectively adjusting the output volume or parameter(s) of the active noise management function based whether audio content is being played back makes the man-machine interface more intuitive and reduces the execution of inadvertent and unintentional commands.

In some embodiments, after adjusting the one or more parameters of the active noise management function, the computer system detects (966) a fourth input (e.g., input 642, FIG. 6J) via the one or more input devices (e.g., a tap input, a tap-and-hold input, a swipe input, a rotation of a rotatable input mechanism, or other type of input). In response to detecting the fourth input and in accordance with a determination that the fourth input is the second type of input, the computer system causes (968) the audio content to be played back at the computer system (e.g., as indicated by music playing indicator 644 in FIG. 6K). After causing the audio content to be played back, the computer system detects (970) a fifth input (e.g., input 656, FIG. 6N) via the one or more input devices (e.g., a tap input, a tap-and-hold input, a swipe input, a rotation of a rotatable input mechanism, or other type of input). In response to detecting the fifth input and in accordance with a determination that the fifth input is the first type of input (and optionally that more than a specified threshold amount of time has elapsed since the audio playback state was changed), the computer system adjusts (972) the output volume of the audio content. For example, FIG. 6N shows input 656 being detected after amount of time 658, greater than threshold amount of time 628, and FIG. 6O shows a corresponding change in output volume. In some embodiments, in response to detecting the fourth input and in accordance with a determination that the fourth input is not the second type of input, the computer system forgoes causing the audio content to be played back at the computer system. In some embodiments, in response to detecting the fifth input and in accordance with a determination that the fifth input is not the first type of input, the computer system forgoes adjusting the output volume of the audio content. In some embodiments, the fourth input is detected via a different input device (or different sets of input devices) than the fifth input (e.g., the fourth input and fifth input are detected at different wearable audio output devices). In some embodiments, the fourth input is detected at a different input device than the second input. Selectively adjusting the output volume or parameter(s) of the active noise management function based whether audio content is being played back makes the man-machine interface more intuitive and reduces the execution of inadvertent and unintentional commands.

In some embodiments, in response to detecting the first input (904) and in accordance with a determination that the first input is a first type of input and audio content of the respective type of audio content is being output by the one or more audio output components, the computer system causes (976) first audio feedback (e.g., feedback 616, FIG. 6C) to be output by the one or more audio output components that is indicative of the adjustment in output volume, in conjunction with (e.g., concurrently with, before, or after) adjusting the output volume of the audio content. In response to detecting the first input (904) and in accordance with a determination that the first input is the first type of input and that one or more noise management criteria are met, the computer system causes (978) second audio feedback (e.g., feedback 640, FIG. 6I) to be output by the one or more audio output components that is indicative of the adjustment of the one or more parameters of the active noise management function, in conjunction with (e.g., concurrently with, before, or after) adjusting the one or more parameters of the active noise management function. In some embodiments, the first audio feedback is separate from the audio content. In some embodiments, the first audio feedback is separate from the output of the active noise management function. In some embodiments, the first audio feedback that is indicative of the change in output volume is different from the second audio feedback that is indicative of the adjustment of the one or more parameters of the active noise management function. For example, a tone, a frequency, an amplitude and/or other audio property is different between the first audio feedback and the second audio feedback. In some embodiments, the first audio feedback is output at one or more wearable audio output devices (e.g., earbuds) of the computer system. In some embodiments, the first audio feedback is output only at the wearable audio output device at which the first input is detected. In some embodiments, in accordance with the determination that the first input is the first type of input and audio content of the respective type of audio content is being output by the one or more audio output components, the computer system causes first haptic feedback to be output by the computer system (e.g., in addition to, or alternatively to, the first audio feedback). In some embodiments, in accordance with a determination that the first input is the first type of input and that one or more noise management criteria are met, the computer system causes second haptic feedback to be output by the computer system (e.g., in addition to, or alternatively to, the second audio feedback). In some embodiments, one or more audio properties of the first audio feedback are based on a magnitude of the change of the output volume. In some embodiments, one or more audio properties of the second audio feedback are based on a magnitude of the adjustment of the one or more parameters of the active noise management function (and/or which parameters are adjusted). Providing feedback in conjunction with adjusting output volume and parameter(s) of the active noise management function provides feedback about a state of the computer system.

In some embodiments, in response to detecting the first input and in accordance with a determination that the first input is a third type of input (e.g., a tap input, a double tap input, a tap-and-hold input, or other type of input) that is different from the first type of input, the computer system switches (980) a mode of the active noise management function. As an example, FIG. 6P shows input 664 being detected at wearable audio output device 604 and FIG. 6Q shows a corresponding change in the noise management mode (e.g., from transparency in FIG. 6O to noise cancellation in FIG. 6Q). For example, switching the mode of the active noise management function may comprise switching from an active transparency mode to an active noise cancellation mode, or vice versa. In some embodiments, the mode of the active noise management function changes between an active transparency mode, an active noise cancellation mode, and an off mode in response to inputs of the third type of input. In some embodiments, the third type of input switches the mode of the active noise management function to a particular mode (e.g., the third type of input is mapped to the particular mode). In some embodiments, a fourth type of input causes the mode of the active noise management function to change to a next mode in a list of selectable modes for the active noise management function. In some embodiments, switching the mode of the active noise management function includes switching the hearing assistance mode of the computer system. For example, the mode of the hearing assistance function optionally includes different amounts of amplification and/or attenuation of ambient sound (e.g., −6 decibels, −4 decibels, −2 decibels, 0 decibels, +2 decibels, +4 decibels, +6 decibels). Performing different actions (e.g., adjusting output volume, adjusting parameter(s) of the active noise management function, and switching modes of the active noise management functions) in response to different types of inputs reduces the number of inputs needed to execute the operations and enables the operations to be performed without displaying additional controls.

In some embodiments, the one or more audio output components of the computer system comprise (982) a first audio output component and a second audio output component, and the third type of input comprises concurrent inputs detected at the first audio output component and the second audio output component. As an example, FIG. 6T shows concurrent inputs 672 and 674 and FIG. 6U shows the noise management mode changing from adaptive mode (in FIG. 6R) to transparency mode in response to the inputs. For example, the concurrent inputs are concurrent tap inputs, touch inputs, swipe inputs, or other types of inputs. In some embodiments, the third type of input comprises simultaneous inputs or inputs that at least partially overlap in time at the first audio component device and the second audio output component. In some embodiments, the third type of input comprises a first type of input at the first audio output component and a second type of input at the second audio output component. Switching modes of an active noise management function in response to concurrent inputs at different audio output components provides an intuitive man-machine interface and enables the mode switch operation to be performed without displaying additional controls.

In some embodiments, switching the mode of the active noise management function comprises (984) switching from a first mode (e.g., transparency mode 610, FIG. 6O) to a second mode (e.g., noise cancellation mode 666, FIG. 6Q). After switching the mode of the active noise management function to the second mode, the computer system detects (986) a sixth input (e.g., a squeeze input, an example of which is input 668) via the one or more input devices (e.g., a tap input, a double tap input, a tap-and-hold input, or other type of input). In response to detecting the sixth input and in accordance with a determination that the sixth input is the third type of input (e.g., a squeeze type of input), the computer system switches (988) the mode of the active noise management function from the second mode to the first mode. In some embodiments, the list of selectable modes for the active noise management function includes only the first mode and the second mode, e.g., and the third input, such as input 668 in FIG. 6R, causes the active noise management function to switch from the second mode (e.g., noise cancellation mode 666) to the first mode (e.g., transparency mode 610) rather than a third mode (e.g., adaptive mode 670). In some embodiments, sixth input is the third type of input (e.g., the third type of input corresponds to a mode toggle command). In some embodiments, the sixth input a fourth type of input, different than the third type of input. For example, the third type of input may enable an active transparency mode and the fourth type of input may enable an active noise cancellation mode. As another example, the third type of input may cycle through active noise management modes in a first order and the fourth type of input may cycle through the active noise management modes in a second order (e.g., reverse of the first order). Repeatedly switching modes of an active noise management function in response to successive inputs provides an intuitive man-machine interface and enables the mode switch operations to be performed without displaying additional controls.

In some embodiments, the first input is (989) detected at a location corresponding to the first audio output component (e.g., wearable audio output device 604) of the computer system. The sixth input is (990) detected at a location corresponding to a second audio output component (e.g., wearable audio output device 602) of the computer system. In some embodiments, the first audio output component is a component of a first wearable audio output device of the computer system (e.g., a first earbud) and the second audio output component is a component of a second wearable audio output device of the computer system (e.g., a second earbud). In some embodiments, the first input and the sixth input are detected via a same input device of the one or more input devices. In some embodiments, the first input and the sixth input are detected via different input devices of the one or more input devices. For example, a first input device is arranged on a first wearable audio output device of the computer system and a second input device is arranged on a second wearable audio output device of the computer system. As another example, the computer system is, optionally, a headset and a first input device is arranged on a first audio output component (e.g., a first earcup) of the headset and a second input device is arranged on a second audio output component (e.g., a second earcup) of the headset. Switching modes of an active noise management function in response to inputs at different audio output components enables a user to perform the operation without requiring the user to perform the action at a particular audio output component (e.g., without requiring the user to perform the action with a particular hand) thereby making the man-machine interface more intuitive and convenient to use.

In some embodiments, the first input is (991) detected while the computer system is configured with a first setting (e.g., the context dependent control element 682 shown in FIG. 6X) for inputs of the first type (e.g., a swipe input as indicated in FIG. 6W). While the computer system is configured with a second setting (e.g., adjust volume level control element 684, FIG. 6X) for inputs of the first type (992), the computer system detects (993) a seventh input via the one or more input devices (e.g., a tap input, a double tap input, a tap-and-hold input, or other type of input). In response to detecting the seventh input, the computer system adjusts (994) an output volume of the audio content being output via the one or more audio output components without regard to whether or not audio content of a respective type of audio content is being output by the one or more audio output components. For example, the input mapping setting is, optionally, set to adjust output volume of audio content only while audio content is being output, or is, alternatively, set to adjust the output volume of audio content regardless of whether audio content is being output. In some embodiments, a different type of input is mapped to adjusting the one or more parameters of the active noise management function. For example, a swipe input is, optionally, mapped to an audio content output volume adjustment function and a double tap input is, optionally, mapped to an active noise management function parameter adjustment function. Providing a setting to adjust a mapping between inputs and functions enables the user to have a more intuitive man-machine interface thereby reducing a number of erroneous operations due to incorrect inputs.

In some embodiments, in response to a determination that an environment of the computer system has potentially excessive noise, the computer system causes (995) a notification (e.g., notification 1522 or notification 1524) to be provided to a user of the computer system, the notification indicating the potentially excessive noise and a recommendation to use the computer system to reduce noise from the environment. In some embodiments, the notification comprises an audio notification output at the one or more audio output components and/or a visual notification at the computer system and/or a companion device connected to the computer system. In some embodiments, in accordance with the determination that the environment of the computer system has potentially excessive noise, the computer system automatically (e.g., without further user input) adjusts a noise management function to reduce noise from the environment. In some embodiments, whether the computer system causes the notification to be provided or automatically adjusts the noise management function depends one or more implicit and/or explicit user preferences. In some embodiments, the computer system automatically adjusts the noise management function and causes a notification to be provided to the user to indicate the automatic adjustment. In some embodiments, the computer system selectively causes the notification to be provided based on whether an active noise management function is enabled. For example, if an active transparency mode is enabled, the computer system may cause the notification to be provided, and if an active noise cancellation mode is enabled, the computer system may forgo causing the notification to be provided. Providing a notification regarding potentially excessive noise improves safety for the user by protecting user hearing.

In some embodiments, the determination that the environment of the computer system has potentially excessive noise is (996) based on a location of the computer system. For example, the computer system determines that the computer system is at a location likely to have excessive noise such as an airport, a concert venue, a train station, a construction site, or other type of location (e.g., by comparing the location of the computer system with map information that correlates geolocations of venues with excessive noise). In some embodiments, the computer system obtains information about the location from a different electronic device (e.g., a companion device, a remote server, or other type of electronic device). For example, the computer system obtains information about a location based on a known wireless connection, beacon, or other device associated with that location. In another example, the computer system obtains information about the location based on known acoustic properties of that location. Determining whether an environment has potentially excessive noise based on location improves safety for the user by protecting user hearing.

In some embodiments, the determination that the environment of the computer system has potentially excessive noise is (997) based (e.g., at least in part) on scheduling information of the user. For example, the scheduling information may include calendar information for the user, ticketing information for the user, event information, electronic communications (e.g., e-mails, text messages, or other types of communications) about a schedule of the user, and/or other types of information. Determining whether an environment has potentially excessive noise based on scheduling information improves safety for the user by protecting user hearing.

In some embodiments, the determination that the environment of the computer system has potentially excessive noise is (998) based on a detected audio level of the environment (e.g., the 90 decibels indicated in notification 1522). For example, the computer system optionally includes one or more microphones and determines an audio level of the environment based on audio signals captured at the one or more microphones. The audio level of the environment is, optionally, based on the audio signals captured over a period of time or signals captured over more than one period of time (e.g., 5 seconds, 10 seconds, 15 seconds, 30 seconds, 1 minute, 2 minutes, 5 minutes, or other time intervals). Determining whether an environment has potentially excessive noise based on a detected audio level of the environment improves safety for the user by protecting user hearing.

It should be understood that the particular order in which the operations in FIGS. 9A-9I have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800 and 1000) are also applicable in an analogous manner to method 900 described above with respect to FIGS. 9A-9I. For example, the inputs, controls, and user interfaces described above with reference to method 900 optionally have one or more of the characteristics of the inputs, controls, and user interfaces described herein with reference to other methods described herein (e.g., methods 800 and 1000). For brevity, these details are not repeated here.

FIGS. 10A-10F are flow diagrams of method 1000 for adjusting output of audio data in accordance with some embodiments. Method 1000 is performed at a first computer system (e.g., including device 300, FIG. 3A, portable multifunction device 100, FIG. 1A, and/or wearable audio output device 301, FIG. 3I) includes, or is communicatively coupled with, one or more audio output devices (e.g., an earbud, a headset, a headphone, a speaker device, or other type of audio output device), one or more output generation components, and one or more microphones (e.g., microphone 113 and/or microphones 322). In some embodiments, the one or more output generation components include a display, such as a touch-screen display. In some embodiments, the one or more input devices comprises a touch-sensitive surface that is on or integrated with the display. In some embodiments, the display is separate from the touch-sensitive surface. Some operations in method 1000 are, optionally, combined and/or the order of some operations is, optionally, changed.

As described below, method 1000 includes maintaining multiple communication sessions and automatically causing audio data to cease to be transmitted and/or output in response to detecting occurrence of an event, thereby providing audio routing and output control for the user, performing operations automatically when a set of conditions has been met without requiring further user input, providing improved feedback to the user, and reducing the number of inputs needed to perform the operations.

While a first communication session is active between the first computer system (e.g., computer system 1584, computer system 502, wearable audio output device 602, and/or wearable audio output device 604) and one or more other devices participating in the first communication session (1002), the first computer system causes (1004) first audio data (e.g., incoming communication 718-2, FIG. 7A) provided by (e.g., recorded by or obtained by) the one or more other devices participating in the first communication session to be output by the one or more audio output devices (e.g., as indicated by control element 714, labeled “Volume: 50%”, in FIG. 7A). The first computer system causes (1006) second audio data (e.g., outgoing communication 718-1, FIG. 7A) recorded by (e.g., captured) the one or more microphones (e.g., one or more microphones of the one or more audio output devices and/or one or more microphones of the computer system that are separate from the audio output devices) to be made available to the one or more other devices participating in the first communication session (e.g., as indicated by control element 710, labeled “Mic: On”, in FIG. 7A). The first computer system causes (1008) visual data (e.g., video data 704, 706, and/or 708 in FIG. 7A) corresponding to the first communication session to be displayed via the one or more output generation components (e.g., as indicated by control element 712, labeled “Video: On”, in FIG. 7A).

While a first communication session is active between the first computer system and one or more other devices participating in the first communication session (1002), the first computer system detects (1010) an occurrence of an event (e.g., the incoming call on computer system 502 in FIG. 7B) corresponding to a request to establish a second communication session between the one or more audio output devices and a second computer system, different than the first computer system (e.g., from a mobile phone associated with a person denoted as Gabby. P in FIG. 7B).

In some embodiments, the occurrence of the event comprises (1012) a user request (e.g., corresponding to input 728 on accept element 719) to establish the second communication session between the one or more audio output devices and the second computer system. In some embodiments, the user request comprises an input detected by one or more input devices (e.g., of the first computer system or the one or more audio output devices). For example, the user request is, optionally, a request to answer or initiate a telephone call with the second computer system. As another example, the user request is optionally, a request to initiate a voice chat with the second computer system. In some embodiments, the user request comprises a user selection on or directed to an affordance configured to initiate a communication session with the second computer system (e.g., selection of a call button). In some embodiments, the user request comprises a request submitted to a digital assistant. In some embodiments, the user request is received at the first computer system. Maintaining a first communication session in response to a user request to establish a second communication session causes the first computer system to automatically adjust audio routing and audio outputs (e.g., without dropping the first communication session), thereby providing a more intuitive man-machine interface.

In some embodiments, the occurrence of the event comprises (1014) detecting an incoming communication (e.g., an incoming call, as indicated in FIG. 7B, an incoming video call, or other type of incoming communication) from the second computer system. For example, the occurrence of the event optionally includes receiving an incoming telephone call, voice communication request, or video conference invitation from the second computer system. In some embodiments, the incoming communication comprises a request to establish an audio path to the second computer system. In some embodiments, the incoming communication is received at the first computer system. In some embodiments, the incoming communication is received at the one or more audio output devices. Maintaining a first communication session in response to an incoming communication causes the first computer system to automatically adjust audio routing and audio outputs (e.g., without dropping the first communication session), thereby providing a more intuitive man-machine interface.

In some embodiments, the occurrence of the event comprises (1016) initiation (e.g., initiation of a phone call, represented by bidirectional communication 730, in response to detection of input 728, as illustrated in FIGS. 7B and 7C) of the second communication session between the one or more audio output devices and the second computer system. In some embodiments, the initiation of the second communication session is in response to a user acceptance of a request from the second computer system to establish a communication session. In some embodiments, the user acceptance is detected at the first computer system. In some embodiments, the user acceptance is detected at the one or more audio output devices. In some embodiments, the initiation of the second communication session is in response to receiving an acceptance from the second computer system of a request to establish a communication session (e.g., sent from the first computer system). Maintaining a first communication session in response to initiation of a second communication session causes the first computer system to automatically adjust audio routing and audio outputs (e.g., without dropping the first communication session), thereby providing a more intuitive man-machine interface.

In response to detecting the occurrence of the event (1018), the first computer system maintains (1020) the first communication session, including causing (1022) at least a portion of the visual data corresponding to the first communication session to continue to be displayed via the one or more output generation components (e.g., video data 704 and 706, FIG. 7C), ceasing (1024) to cause the first audio data (e.g., as indicated by control element 714, labeled “Volume: 0%”, in FIG. 7C) provided by (e.g., recorded by or obtained by) the one or more other devices participating in the first communication session to be output by the one or more audio output devices (e.g., muting the output audio being provided to the computer system from the first communication session), and ceasing (1026) to cause the second audio data (e.g., as indicated by control element 710, labeled “Mic: Off”, in FIG. 7C) recorded by the one or more microphones to be made available to the one or more other devices participating in the first communication session (e.g., muting the input audio being provided by the computer system for the first communication session). In some embodiments, outgoing visual data (e.g., video data 708) ceases to be transmitted in response to detecting the occurrence of the event.

The first computer system forgoes (1028) causing the first audio data (e.g., represented by incoming communication 718-2 in FIG. 7A) provided by (e.g., recorded by or obtained by) the one or more other devices participating in the first communication session to be output by the one or more audio output devices and forgoes causing the second audio data (e.g., represented by outgoing communication 718-1 in FIG. 7A) recorded by the one or more microphones to be made available to other devices participating in the first communication session while third audio data corresponding to the second communication session is being transferred between the second computer system and the one or more audio output devices.

In some embodiments, a method is performed at a set of (e.g., one or more) wearable audio output devices (e.g., wearable audio output devices 301) with one or more audio output components, one or more microphones, and one or more input devices. The method includes, while a first audio path (e.g., represented by communications 718) is active between the set of wearable audio output devices and a first remote device path (e.g., via a first communications application, such as a telephony application, a video conference application, a video call application, or other type of communications application), where the first audio path being active includes transferring audio data captured by the one or more microphones (e.g., represented by outgoing communication 718-1 in FIG. 7A) to the first remote device and transferring audio data from the first remote device (e.g., represented by incoming communication 718-2 in FIG. 7A) to the set of wearable audio output devices (e.g., to be outputted by the one or more audio output components), detecting an occurrence of an event (e.g., the incoming call illustrated in FIG. 7B) corresponding to a request to establish an audio path between the set of wearable audio output devices and a second remote device, different than the first remote device. The method further includes, in response to detecting the occurrence of the event: while maintaining the first audio path, establishing a second audio path (e.g., via a second communications application) between the set of wearable audio output devices and the second remote device (e.g., indicated by bidirectional communication 730 in FIG. 7C), including transferring audio data captured by the one or more microphones to the second remote device and transferring audio data from the second remote device to the set of wearable audio output devices.

In some embodiments, maintaining the first audio path as an active audio path includes continuing to receive (and optionally output) audio data from the first remote device. In some embodiments, maintaining the first audio path as an active audio path comprises maintaining a user of the set of wearable audio output devices as an active participant in the communications corresponding to the first audio path. For example, the user of the set of wearable audio output devices is kept as an active participant in a call, meeting, and/or conference corresponding to the first audio path. In some embodiments, the set of wearable audio output devices is coupled to the first remote device via a companion device (e.g., a portable multifunction device) that is coupled (e.g., wirelessly or wired) to the set of wearable audio output devices. In some embodiments, the first audio path is an audiovisual path and maintaining the first audio path comprises continuing to transfer visual data between the set of wearable audio output devices (or a companion device coupled to the set of wearable audio output devices) and the first remote device.

In some embodiments, ceasing to cause the first audio data to be output by the one or more audio output devices comprises (1030) enabling a mute state for the first audio data (e.g., as indicated by control element 714 label “Volume: 0%” in FIG. 7C). For example, the mute state is enabled for incoming audio corresponding to the first communication session. In some embodiments, the mute state is enabled at the first computer system. In some embodiments, the mute state is enabled at the one or more audio output devices. In some embodiments, the mute state is enabled via an application corresponding to the first communication session. Furthermore, in some embodiments (e.g., where the first communication session and the second communication session are managed by a same application), the mute state for the first audio data is a session level mute state. Enabling a mute state of audio data in response to an occurrence of an event corresponding to a request to establish a second communication session causes the first computer system to automatically adjust the mute state, thereby providing a more intuitive and efficient man-machine interface.

In some embodiments, ceasing to cause the second audio data to be made available to other devices participating in the first communication session comprises (1032) enabling a mute state of the one or more microphones (e.g., as indicated by control element 710 label “Mic: Off” in FIG. 7C and by control element 716 having a slash through the microphone icon in FIG. 7C). In some embodiments, the one or more microphones are components of the first computer system. In some embodiments, the one or more microphones are components of the one or more audio output devices. Enabling a mute state of the microphone(s) in response to an occurrence of an event corresponding to a request to establish a second communication session causes the first computer system to automatically adjust the mute state, thereby providing a more intuitive and efficient man-machine interface.

In some embodiments, the mute state of the one or more microphones is (1034) enabled at a system level of the first computer system (e.g., as indicated by control element 716 in FIGS. 7A-7C). For example, audio from the one or more microphones is muted for all purposes at the first computer system. In some embodiments, muting the one or more microphones at the system level comprises discarding and/or forgoing processing audio captured by the one or more microphones. Enabling the mute state at a system level in response to an occurrence of an event corresponding to a request to establish a second communication session causes the first computer system to automatically adjust the mute state, thereby providing a more intuitive and efficient man-machine interface.

In some embodiments, the mute state of the one or more microphones is (1036) enabled for an application (e.g., a telephony application, a video conference application, a voice communication application, or other type of application) corresponding to the first communication session (e.g., as indicated by control element 710 in FIGS. 7A-7C). For example, audio from the one or more microphones is not available to the application and/or is not processed by the application. In some embodiments, the application has a mute setting that is different than a system mute setting (e.g., the application mute setting affects only audio corresponding to the application). In some embodiments, the mute state is applicable only to the first communication session. Enabling the mute state for an application corresponding to the first communication session in response to an occurrence of an event corresponding to a request to establish a second communication session causes the first computer system to automatically adjust the mute state, thereby providing a more intuitive and efficient man-machine interface.

In some embodiments, the first computer system causes (1038) display, via the one or more output generation components, of a user interface element (e.g., control element 710 or control element 716, FIGS. 7A-7C) that indicates the mute state of the one or more microphones. For example, ceasing to cause the first audio data to be output by the one or more audio output devices further comprises causing display of the user interface element that indicates the mute state. In some embodiments, the user interface element comprises an icon (e.g., a microphone icon with an indication of the mute state). Causing display of user interface element that indicates the mute state provides feedback about a state of the first computer system.

In some embodiments, the user interface element is (1040) a system-level indicator (e.g., control element 716, FIGS. 7A-7C). In some embodiments, the user interface element is displayed in a system user interface (e.g., a home screen, an operating system window, or other type of system user interface). In some embodiments, the mute state is a system-level mute state, and the user interface element is a system-level indicator. Causing display of a system-level user interface element that indicates the mute state provides feedback about a state of the first computer system (e.g., in an intuitive and convenient location).

In some embodiments, the user interface element is (1042) an application-level indicator (e.g., control element 710, FIGS. 7A-7C) for an application (e.g., a video conference application) corresponding to the first communication session. In some embodiments, the user interface element is displayed in an application interface. In some embodiments, the mute state is an application-level mute state, and the user interface element is an application-level indicator. In some embodiments, the user interface element is displayed in a same user interface as the visual data corresponding to the first communications session. In some embodiments, a user interface element that is a system-level indicator and a user interface element that is an application-level indicator is displayed concurrently. In some embodiments, the user interface element includes both a system-level indicator and an application-level indicator. For example, the computer system concurrently displays a system-level indicator and an application-level indicator when the computer system and the application is in a mute state. Causing display of an application-level user interface element that indicates the mute state provides improved feedback about a state of the first computer system (e.g., indicating the corresponding application).

In some embodiments, in response to detecting the occurrence of the event, the first computer system causes (1044) the second communication session to be established (e.g., as indicated by bidirectional communication 730, FIG. 7C). After causing the second communication session to be established, the first computer system detects (1046) an occurrence of a second event corresponding to a request to activate an audio path corresponding to the first communication session (e.g., an event corresponding to input 742 on end-call element 722). In response to detecting the occurrence of the second event, the first computer system activates (1048) the audio path corresponding to the first communication session (e.g., as indicated by communications 718 and video conference audio 720 in FIG. 7E). In some embodiments, causing the second communication to be established comprises causing an audio path to be established between the one or more audio output devices and the second computer system. In some embodiments, the second event comprises a user request to activate the audio path. For example, a notification at the first computer system includes an affordance to reestablish the audio path between the one or more audio output devices and the first computer system for the first communication session, and in response to a user selection of the affordance (via a touch-sensitive surface, touch-sensitive display, or other input device of the first computer system), the audio path between the one or more audio output devices and the first computer system is reestablished for the first communication session. In another example, a notification at the second computer system includes an affordance to pause and/or cease the second communication session, and in response, the audio path between the one or more audio output devices and the first computer system is reestablished for the first communication session. In some embodiments, activating the audio path comprises unmuting at least a portion of the audio corresponding to the first communication session. In some embodiments, the occurrence of the second event is detected while the second communication session is active. Activating an audio path for the first communication session in response to detecting the occurrence of the second event causes the first computer system to automatically perform audio routing and adjust audio outputs.

In some embodiments, the second communication session is established between the one or more audio output devices and the second computer system via an electronic device (e.g., a portable multifunction device) that is different than the first computer system. For example, an audio path for the first communication session includes transferring audio between the one or more audio output devices and the one or more other devices via the first computer system, and an audio path for the second communication session includes transferring audio between the one or more audio output devices and the second computer system via an electronic device.

In some embodiments, while the second communication session is active, the first computer system causes (1050) the second audio data to be made available to the second computer system (e.g., outgoing audio in bidirectional communication 730, FIG. 7C). In response to detecting the occurrence of the second event, the first computer system ceases (1052) to cause the second audio data to be made available to the second computer system. For example, FIGS. 7D and 7E show bidirectional communication 730 ceasing in response to input 742 on end-call element 722. In some embodiments, causing the second audio data to be made available to the second computer system comprises maintaining an audio path between the one or more audio output devices and the second computer system. In some embodiments, ceasing to cause the second audio data to be made available to the second computer system comprises deactivating the second communication session. In some embodiments, ceasing to cause the second audio data to be made available to the second computer system comprises muting audio for the second communication session. Ceasing to cause the second audio data to be made available to the second computer system in response to detecting the occurrence of the second event causes the first computer system to automatically perform the ceasing operation, thereby reducing the number of inputs needed.

In some embodiments, while the second communication session is active, the first computer system causes (1054) fourth audio data provided by the second computer system to be output by the one or more audio output devices (e.g., incoming audio in bidirectional communication 730, FIG. 7C). In response to detecting the occurrence of the second event, the first computer system ceases (1056) to cause the fourth audio data to be output by the one or more audio output devices (e.g., muting audio data from the one or more audio output devices). For example, FIGS. 7D and 7E show bidirectional communication 730 ceasing in response to input 742 on end-call element 722. In some embodiments, causing fourth audio data provided by the second computer system to be output by the one or more audio output devices comprises maintaining an audio path between the one or more audio output devices and the second computer system. In some embodiments, ceasing to cause the fourth audio data to be output by the one or more audio output devices comprises deactivating the second communication session. In some embodiments, ceasing to cause the fourth audio data to be output by the one or more audio output devices comprises muting audio for the second communication session. In some embodiments, the second communication session corresponds to a second application and ceasing to cause the fourth audio data to be output by the one or more audio output devices comprises muting audio associated with the second application. Ceasing to cause the fourth audio data to be output in response to detecting the occurrence of the second event causes the first computer system to automatically perform the ceasing operation, thereby reducing the number of inputs needed.

In some embodiments, activating the audio path corresponding to the first communication session comprises causing (1060) the first audio data to resume being output by the one or more audio output devices. For example, FIGS. 7D and 7E show incoming communication 718-2 resuming in response to input 742 on end-call element 722. In some embodiments, causing the first audio data to resume being output by the one or more audio output devices comprising disabling a mute state for the first audio data (e.g., as indicated by control elements 710 and 716 in FIG. 7E). For example, a mute state corresponding to the first communication session is set to unmuted. Causing the first audio data to resume being output in response to detecting the occurrence of the second event causes the first computer system to automatically perform the output operation, thereby reducing the number of inputs needed.

In some embodiments, activating the audio path corresponding to the first communication session comprises, in accordance with a determination that one or more criteria are met causing (1062) the first audio data to resume being output by the one or more audio output devices. In some embodiments, activating the audio path corresponding to the first communication session comprises, in accordance with a determination that the one or more criteria are not met, forgoing (1064) causing the first audio data to resume being output by the one or more audio output devices (e.g., maintaining the mute state corresponding to the first communication session). As examples, FIGS. 7D-7E illustrate incoming communication 718-2 resuming (e.g., at 50% volume as indicated by control element 714) in response to input 742 on end-call element 722, while FIGS. 7K-7L illustrate incoming communication 718-2 not resuming (e.g., remaining at 0% volume as indicated by control element 714) in response to input 766 on end-call element 722. For example, the first audio data is caused to resume in accordance with other communication sessions ending or being muted. In some embodiments, the one or more criteria include a time-based criterion (e.g., a time threshold of 10 seconds, 30 seconds, 1 minute, or other amount of time before the first audio data resumes being output). In some embodiments, the one or more criteria are based on a context of the user (e.g., based on the user's active devices, active applications, the user's location, the user's setting, and/or other context information). Conditionally causing the first audio data to resume being output in response to detecting the occurrence of the second event based on whether certain criteria are met causes the first computer system to automatically perform the operation and provides an intuitive and efficient man-machine interface.

In some embodiments, activating the audio path corresponding to the first communication session comprises maintaining (1066) a mute state of the first audio data. As an example, FIGS. 7K and 7L illustrate the mute state of incoming communication 718-2 remaining active (e.g., as indicated by control element 714) in accordance with reactivating the audio path corresponding to communications 718. For example, the first audio data provided by one or more other devices participating in the first communication session remains muted until the user requests that the first audio data be unmuted. Maintaining the mute state of the first audio data in response to detecting the occurrence of the second event causes the first computer system to automatically perform the maintaining operation.

In some embodiments, activating the audio path corresponding to the first communication session comprises maintaining (1068) a mute state of the one or more microphones with respect to the first communication. As an example, FIGS. 7K and 7L illustrate the mute state of outgoing communication 718-1 remaining active (e.g., as indicated by control elements 710 and 716) in accordance with reactivating the audio path corresponding to communications 718. For example, the second audio data recorded by the one or more microphones associated with the first computer system is not made available to the one or more other devices participating in the first communication session until the user requests that the second audio data be unmuted. In some embodiments, the mute state of the microphones with respect to the first communication session and the second communication session is the same (e.g., both unmuted or both muted). Maintaining the mute state of the one or more microphones in response to detecting the occurrence of the second event causes the first computer system to automatically perform the maintaining operation.

In some embodiments, the occurrence of the second event comprises (1070) detecting an end of the second communication session (e.g., ending the call with Kenny Y. in response to input 766 in FIG. 7K). For example, the second event comprises the second communication session terminating. In some embodiments, in response to the second communication session terminating, the first communication session is reactivated. Activating an audio path for the first communication session in response to detecting the end of the second event causes the first computer system to automatically perform audio routing and adjust audio outputs.

In some embodiments, the occurrence of the second event comprises (1072) a user request to switch to the first communication session (e.g., switching from the call with Kenny Y. to the video conference in response to input 758 as illustrated in FIGS. 7I-7J). For example, the user request corresponds to the user giving focus to the first communication session (e.g., selecting the first communication session). As another example, the user request corresponds to the user selecting an affordance for the first communication session via an input device of the first device. In yet another example, the user request corresponds to a user selecting (e.g., via a tap input at an input device of the first computer system and/or the second computer system) an affordance for the first communication session (displayed on the first computer system and/or the second computer system). Activating an audio path for the first communication session in response to a user request to switch to the first communication session causes the first computer system to automatically perform audio routing and adjust audio outputs.

In some embodiments, the first communication session comprises (1074) a first type of communication session (e.g., a video conference as indicated by the label “Video Conference” on application window 702, FIG. 7A). In some embodiments, the second communication session comprises (1076) a second type of communication session (e.g., a phone call as indicated in FIG. 7B), the second type of communication session having priority over the first type of communication session. In some embodiments, the first type of communication session comprises a video conference session. In some embodiments, the second type of communication session comprises a telephony session. For example, the first communication session corresponds to a video conference application and the second communication session corresponds to a telephony application. Maintaining multiple communication sessions of different types and automatically causing audio data to cease to be transmitted and/or output in response to detecting occurrence of an event performs operations automatically when a set of conditions has been met without requiring further user input, thereby reducing the number of inputs needed to perform the operations.

It should be understood that the particular order in which the operations in FIGS. 10A-10F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800 and 900) are also applicable in an analogous manner to method 1000 described above with respect to FIGS. 10A-10F. For example, the audio data and user interface elements described above with reference to method 1000 optionally have one or more of the characteristics of the audio data and user interface elements described herein with reference to other methods described herein (e.g., methods 800 and 900). For brevity, these details are not repeated here.

The operations described above with reference to FIGS. 8A-8D, 9A-9I, and 10A-10F are, optionally, implemented by components depicted in FIGS. 1A-1B. For example, display causation operation 802, detection operation 812, detection operation 802, adjustment operation 906, output causation operation 1004, and detection operation 1010 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1-20. (canceled)

21. A method, comprising:
at a computer system with one or more input devices and one or more audio output components:
detecting a first input via the one or more input devices; and
in response to detecting the first input:
in accordance with a determination that the first input is a first type of input and audio content of a respective type of audio content is being output by the one or more audio output components, adjusting an output volume of the audio content being output via the one or more audio output components; and
in accordance with a determination that the first input is the first type of input and that one or more noise management criteria are met, adjusting one or more parameters of an active noise management function, wherein the one or more noise management criteria include a criterion that is met when the respective type of audio content is not being output by the one or more audio output components.

22. The method of claim 21, wherein the first input comprises a swipe input on a portion of the computer system.

23. The method of claim 22, wherein:
the computer system comprises a plurality of wearable audio output devices, including a first wearable audio output device and a second wearable audio output device;
the first wearable audio output device includes a first subset of the one or more input devices and a first subset of the one or more audio output components;
the second wearable audio output device includes a second subset of the one or more input devices and a second subset of the one or more audio output components; and
the swipe input is detected at a first subset of the one or more input devices; and
the method includes:
detecting a second input via the second subset of the one or more input devices; and
in response to detecting the second input:
in accordance with a determination that the second input is the first type of input and in accordance with a determination that audio content of the respective type of audio content is being output by the one or more audio output components, adjusting the output volume of the audio content being output via the one or more audio output components; and
in accordance with a determination that the second input is the first type of input and in accordance with a determination that the one or more noise management criteria are met, adjusting the one or more parameters of the active noise management function, wherein the one or more noise management criteria include the criterion that is met when the respective type of audio content is not being output by the one or more audio output components.

24. The method of claim 23, wherein:
adjusting the output volume of the audio content in accordance with the determination that the first input is the first type of input and in accordance with the determination that audio content of the respective type of audio content is being output by the one or more audio output components comprises adjusting the output volume of the audio content at both the first wearable audio output device and the second wearable audio output device; and
adjusting the one or more parameters of the active noise management function in accordance with a determination that the second input is the first type of input and in accordance with a determination that the one or more noise management criteria are met comprises adjusting the one or more parameters of the active noise management function for both the first wearable audio output device and the second wearable audio output device.

25. The method of claim 21, wherein adjusting the one or more parameters of the active noise management function comprises adjusting a degree of active transparency.

26. The method of claim 21, wherein adjusting the one or more parameters of the active noise management function comprises adjusting a degree of active noise cancellation.

27. The method of claim 21, further comprising, in response to detecting the first input and in accordance with a determination that the first input is a second type of input, changing a playback state of the audio content.

28. The method of claim 27, further comprising:
after changing the playback state of the audio content, detecting, via the one or more input devices, a third input of the first type; and
in response to detecting the third input:
in accordance with a determination that audio content of the respective type of audio content is being output by the one or more audio output components, and that more than a first threshold amount of time has elapsed since the playback state of the audio content was changed, adjusting the output volume of the audio content being output via the one or more audio output components; and
in accordance with a determination that audio content of the respective type of audio content is being output by the one or more audio output components, and that less than the first threshold amount of time has elapsed since the playback state of the audio content was changed, adjusting the one or more parameters of the active noise management function.

29. The method of claim 27, including:
after changing the playback state of the audio content, detecting a fourth input of the first type; and
in response to detecting the fourth input:
in accordance with a determination that the one or more noise management criteria are met, and that more than a second threshold amount of time has elapsed since the playback state of the audio content was changed, adjusting the one or more parameters of the active noise management function; and
in accordance with a determination that the one or more noise management criteria are met, and that less than a threshold amount of time has elapsed since the playback state of the audio content was changed, forgoing adjusting the one or more parameters of the active noise management function.

30. The method of claim 21, further comprising:
while audio content is being played back and after adjusting the output volume of the audio content, detecting a second input via the one or more input devices;
in response to detecting the second input and in accordance with a determination that the second input is a second type of input that is different from the first type of input, causing the audio content to cease to be played back;
after causing the audio content to cease to be played back, detecting a third input via the one or more input devices; and
in response to detecting the third input and in accordance with a determination that the third input is the first type of input, adjusting the one or more parameters of the active noise management function.

31. The method of claim 30, further comprising:
after adjusting the one or more parameters of the active noise management function, detecting a fourth input via the one or more input devices;
in response to detecting the fourth input and in accordance with a determination that the fourth input is the second type of input, causing the audio content to be played back at the computer system;
after causing the audio content to be played back, detecting a fifth input via the one or more input devices; and
in response to detecting the fifth input and in accordance with a determination that the fifth input is the first type of input, adjusting the output volume of the audio content.

32. The method of claim 21, further comprising:
in response to detecting the first input:
in accordance with a determination that the first input is the first type of input and audio content of the respective type of audio content is being output by the one or more audio output components, causing first audio feedback to be output by the one or more audio output components that is indicative of the adjustment in the output volume, in conjunction with adjusting the output volume of the audio content; and
in accordance with a determination that the first input is the first type of input and that the one or more noise management criteria are met, causing second audio feedback to be output by the one or more audio output components that is indicative of the adjustment of the one or more parameters of the active noise management function, in conjunction with adjusting the one or more parameters of the active noise management function.

33. The method of claim 21, further comprising, in response to detecting the first input and in accordance with a determination that the first input is a third type of input that is different from the first type of input, switching a mode of the active noise management function.

34. The method of claim 33, wherein the one or more audio output components of the computer system comprise a first audio output component and a second audio output component, and wherein the third type of input comprises concurrent inputs detected at the first audio output component and the second audio output component.

35. The method of claim 34, wherein switching the mode of the active noise management function comprises switching from a first mode to a second mode; and
the method further comprises:
after switching the mode of the active noise management function to the second mode, detecting a sixth input via the one or more input devices; and
in response to detecting the sixth input and in accordance with a determination that the sixth input is the third type of input, switching the mode of the active noise management function from the second mode to the first mode.

36. The method of claim 35, wherein the first input is detected at a location corresponding to the first audio output component of the computer system, and wherein the sixth input is detected at a location corresponding to the second audio output component of the computer system.

37. The method of claim 21, wherein:
the first input is detected while the computer system is configured with a first setting for inputs of the first type; and
the method includes, while the computer system is configured with a second setting for inputs of the first type:
detecting a seventh input via the one or more input devices; and
in response to detecting the seventh input, adjusting the output volume of the audio content being output via the one or more audio output components without regard to whether or not audio content of the respective type of audio content is being output by the one or more audio output components.

38. The method of claim 21, further comprising:
in response to a determination that an environment of the computer system has potentially excessive noise, causing a notification to be provided to a user of the computer system, the notification indicating the potentially excessive noise and a recommendation to use the computer system to reduce noise from the environment.

39. The method of claim 38, wherein the determination that the environment of the computer system has potentially excessive noise is based on a location of the computer system.

40. The method of claim 38, wherein the determination that the environment of the computer system has potentially excessive noise is based on scheduling information of the user.

41. The method of claim 38, wherein the determination that the environment of the computer system has potentially excessive noise is based on a detected audio level of the environment.

42. A computer system, comprising:
one or more input devices;
one or more audio output devices;
one or more processors; and
memory storing one or more programs, wherein the one or more programs are configured to be executed by the one or more processors, the one or more programs including instructions for:
detecting a first input via the one or more input devices; and
in response to detecting the first input:
in accordance with a determination that the first input is a first type of input and audio content of a respective type of audio content is being output by one or more audio output components, adjusting an output volume of the audio content being output via the one or more audio output components; and
in accordance with a determination that the first input is the first type of input and that one or more noise management criteria are met, adjusting one or more parameters of an active noise management function, wherein the one or more noise management criteria include a criterion that is met when the respective type of audio content is not being output by the one or more audio output components.

43. A computer readable storage medium storing one or more programs, the one or more programs comprising instructions that, when executed by a computer system that includes one or more input devices and one or more audio output components, cause the computer system to:
detect a first input via the one or more input devices; and
in response to detecting the first input:
in accordance with a determination that the first input is a first type of input and audio content of a respective type of audio content is being output by one or more audio output components, adjust an output volume of the audio content being output via the one or more audio output components; and
in accordance with a determination that the first input is the first type of input and that one or more noise management criteria are met, adjust one or more parameters of an active noise management function, wherein the one or more noise management criteria include a criterion that is met when the respective type of audio content is not being output by the one or more audio output components.
